(19) United States
(12) Patent Application Publication
(10) Pub. No.: US 2024/0273550 A1
(43) Pub. Date: Aug. 15, 2024

(54) SYSTEMS AND METHODS FOR EMISSIONS DATA MANAGEMENT

(71) Applicant: U.S. Venture, Inc., Appleton, WI (US)

(72) Inventors: Jeffrey Paul Lang, Menasha, WI (US); Lisa Ann Knuth, Minocqua, WI (US); Garner Jacob Kohrell, Saint Paul, MN (US)

(21) Appl. No.: 18/439,325

(22) Filed: Feb. 12, 2024

Related U.S. Application Data
(60) Provisional application No. 63/445,196, filed on Feb. 13, 2023.

(51) Int. Cl. G06Q 30/018

(52) U.S. Cl. CPC G06Q 30/018

(57) ABSTRACT

A system includes one or more processors and one or more memory devices storing instructions thereon that, when executed by the one or more processors, cause one or more processors to receive high-level sustainability data associated with an entity; generate a plurality of sustainability indicators for a plurality of categories for the entity based on the high-level sustainability data and one or more modeling assumptions associated with the entity; aggregate the plurality of sustainability indicators into a single sustainability indicator; generate a graphical user interface including the single sustainability indicator; and cause one or more devices to perform an action to improve the single sustainability indicator.

### CROSS-REFERENCE TO RELATED APPLICATION

This application claims the benefit of and priority to U.S. Provisional Patent Application No. 63/445,196, filed Feb. 13, 2023, which is incorporated herein by reference in its entirety.

### BACKGROUND

The present disclosure relates generally to data management. More specifically, the present disclosure relates to managing emissions data.

### SUMMARY

One implementation of the present disclosure is a system. The system includes one or more processors and one or more memory devices storing instructions thereon that, when executed by the one or more processors, cause the one or more processors to receive high-level sustainability data associated with an entity. The instructions further cause the one or more processors to generate a plurality of sustainability indicators for a plurality of categories for the entity based on the high-level sustainability data and one or more modeling assumptions associated with the entity. The instructions further cause the one or more processors to aggregate the plurality of sustainability indicators into a single sustainability indicator. The instructions further cause the one or more processors to generate a graphical user interface including the single sustainability indicator. The instructions further cause the one or more processors to cause one or more devices to perform an action to improve the single sustainability indicator.

Another implementation of the present disclosure is a method. The method includes receiving, by one or more processing circuits, high-level sustainability data associated with an entity. The method further includes generating, by one or more processing circuits, a plurality of sustainability indicators for a plurality of categories for the entity based on the high-level sustainability data and one or more modeling assumptions associated with the entity. The method further includes aggregating, by the one or more processing circuits, the plurality of sustainability indicators into a single sustainability indicator. The method further includes generating, by the one or more processing circuits, a graphical user interface including the single sustainability indicator. The method further includes causing, by the one or more processing circuits, one or more devices to perform an action to improve the single sustainability indicator.

Another implementation of the present disclosure is one or more memory devices storing instructions thereon, when executed by one or more processors, cause the one or more processors to select one or more modeling assumptions for modeling low-level sustainability data based on high-level sustainability data of multiple entities. The instructions further cause the one or more processors to receive high-level sustainability data associated with an entity. The instructions further cause the one or more processors to generate a plurality of sustainability indicators for a plurality of categories for the entity based on the high-level sustainability data and the one or more modeling assumptions. The instructions further cause the one or more processors to aggregate the sustainability indicators into a single sustainability indicator. The instructions further cause the one or more processors to generate a graphical user interface including the single sustainability indicator. The instructions further cause the one or more processors to cause one or more devices to perform an action to improve the sustainability data.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of an emissions system of tracking and reducing emissions of a user or company, according to an exemplary embodiment.

FIG. 2 is a block diagram of the emissions system generating emissions indicators from high-level data based on modeling assumptions, according to an exemplary embodiment.

FIG. 3 is a flow diagram of a process of generating the emissions indicators from the high-level data based on the modeling assumptions, according to an exemplary embodiment.

FIGS. 4-7 are user interfaces of various roles, e.g., a vice president, a CEO, and a sales department representative, according to an exemplary embodiment.

FIG. 8 is a user interface of an emissions tracking dashboard, according to an exemplary embodiment.

FIG. 9 is an emissions trend of emissions indicators, according to an exemplary embodiment.

FIG. 10 is the emissions trend of FIG. 9 drilled down to a commuting transportation category, according to an exemplary embodiment.

FIG. 11 is the emissions trend of FIG. 9 drilled down to a business transportation category, according to an exemplary embodiment.

FIG. 12 is the emissions trend of FIG. 9 drilled down to a household category, according to an exemplary embodiment.

FIG. 13 is the emissions trend of FIG. 9 drilled down to a food category, according to an exemplary embodiment.

FIG. 14 is the emissions trend of FIG. 9 drilled down to a shopping category, according to an exemplary embodiment.

FIG. 15 is a user interface of an emissions tracking dashboard, according to an exemplary embodiment.

FIG. 16 is the user interface of FIG. 15 including a renewable natural gas offset, according to an exemplary embodiment.

FIG. 17 is the user interface of FIG. 15 including a solar energy offset, according to an exemplary embodiment.

FIG. 18 is a user interface including emissions indicators for a sales team, according to an exemplary embodiment.

FIG. 19 is a user interface indicating an average emissions footprint for employees, according to an exemplary embodiment.

FIG. 20 is a user interface indicating budget allocations and carbon offset allocations, according to an exemplary embodiment.

FIG. 21 is a user interface for viewing carbon offsets, according to an exemplary embodiment.

FIG. 22 is a user interface indicating emissions indicators for a user, according to an exemplary embodiment.

FIG. 23 is a user interface indicating enrollment and engagement of users, according to an exemplary embodiment.

FIG. 24 is a user interface of a marketplace interface where offsets and projects can be reviewed by a user for reducing emissions production, according to an exemplary embodiment.

FIG. 25A is user interface indicating a featured project for the marketplace interface of FIG. 24, according to an exemplary embodiment.

FIGS. 25B-25C are user interfaces for allocating offsets, according to an exemplary embodiment.

FIG. 25D is a user interface including emissions indicators for a company, according to an exemplary embodiment.

FIG. 26 is a schematic diagram of a wearable device displaying an emissions tracking interface, according to an exemplary embodiment.

FIG. 27 is a flow diagram of a process of collecting high-level data for multiple categories for a corpus or group of entities, according to an exemplary embodiment.

FIG. 28 is a user interface prompting a user to select a transportation method, according to an exemplary embodiment.

FIG. 29 is a user interface prompting a user to select a diet, according to an exemplary embodiment.

FIG. 30 is a user interface prompting a user to select a type of shopping that the user engages in, according to an exemplary embodiment.

FIG. 31 is a user interface prompting a user to select a size of their home, according to an exemplary embodiment.

FIG. 32 is a flow diagram of a process of collecting high-level data for a shopping category for a corpus or group of entities, according to an exemplary embodiment.

FIG. 33 is a flow diagram of a process of collecting high-level data for a home category for a corpus or group of entities, according to an exemplary embodiment.

FIG. 34 is a user interface prompting a user to select a number of people that live in their home, according to an exemplary embodiment.

FIG. 35 is a user interface prompting a user to select a primary heating source of their home, according to an exemplary embodiment.

FIGS. 36-38 is a flow diagram of a process of collecting high-level data for a transportation category for a corpus or group of entities, according to an exemplary embodiment.

FIG. 39 is a user interface prompting a user to select a size of their vehicle, according to an exemplary embodiment.

FIG. 40 is a user interface prompting a user to enter the number of days the user drives to work in a week, according to an exemplary embodiment.

FIG. 41 is a user interface prompting a user to enter the number of miles that the user drives per day to work, according to an exemplary embodiment.

FIG. 42 is a user interface prompting a user to select the fuel type for their vehicle, according to an exemplary embodiment.

FIG. 43 is a user interface providing a user with their carbon footprint, according to an exemplary embodiment.

FIG. 44 is another user interface providing a user with their carbon footprint, according to an exemplary embodiment.

FIG. 45 is a user interface prompting a user to provide input for a habit, according to an exemplary embodiment.

FIG. 46 is a user interface prompting a user to add a description of a trip, according to an exemplary embodiment.

FIG. 47 is a user interface prompting a user to select a transportation method for their trip, according to an exemplary embodiment.

FIG. 48 is a user interface of a summary of a trip, according to an exemplary embodiment.

FIG. 49 is a user interface including a trip log of trips taken by the user, according to an exemplary embodiment.

FIG. 50 is a user interface providing topics of interest and a lifestyle of a user, according to an exemplary embodiment.

FIG. 51 is a user interface prompting a user to select topics of interest, according to an exemplary embodiment.

FIG. 52 is a user interface including emissions indicators and a trend of a carbon footprint of a user, according to an exemplary embodiment.

FIG. 53 is a user interface including an emissions indicator broken down into multiple categories for a user, according to an exemplary embodiment.

FIG. 54 is a user interface including a trend of an emissions indicator for a user, according to an exemplary embodiment.

FIG. 55 is a user interface prompting a user to enter a target goal for an emissions indicator, according to an exemplary embodiment.

FIG. 56 is a user interface providing a summary of the target goal, according to an exemplary embodiment.

FIG. 57 is a user interface including articles that a user can select from, according to an exemplary embodiment.

FIG. 58 is a user interface including habits that a user can select from, according to an exemplary embodiment.

FIG. 59 is a user interface including a button for a user to add a habit, according to an exemplary embodiment.

FIG. 60 is a user interface including a trend of points earned by a user, according to an exemplary embodiment.

FIG. 61 is a user interface indicating badges earned by a user, according to an exemplary embodiment.

FIG. 62 is a user interface indicating challenges that a user can select and participate in, according to an exemplary embodiment.

FIG. 63 is a user interface allowing a user to purchase and allocate offsets, according to an exemplary embodiment.

FIG. 64 is a block diagram of an sustainability system of tracking and reducing emissions, water usage, and plastics usage, of a user or company, according to an exemplary embodiment.

FIG. 65 is a block diagram of the sustainability system generating sustainability indicators from high-level data based on modeling assumptions, according to an exemplary embodiment.

FIG. 66 is a flow diagram of a process of generating the sustainability indicators from the high-level data based on the modeling assumptions, according to an exemplary embodiment.

### DETAILED DESCRIPTION

Referring generally to the FIGURES, systems and methods for emissions data management is shown, according to various exemplary embodiments. The system and methods described herein can manage emissions related data for emissions tracking and reduction. An emissions system can, in some embodiments, collect activity data of a corpus or group of entities (e.g., of a user or group of users, a family, a company, a city, a state, a country, etc.). The activity data can be used to identify emissions production resulting from the activities of the activity data. The emissions production information can be used by the emissions system to establish an emissions footprint, e.g., carbon footprint, indicating emissions associated with a particular user or group of users. The data collected can be high-level data. For example, the data can represent general activities, behaviors, or preferences of the entities of the corpus or group of entities.

An emissions system that collects granular low-level data for every entity of a corpus or group of entities and determines emissions indicators for multiple emissions categories based on the granular low-level data may encounter various problems. The granular low-level data may directly describe consumption (e.g., energy consumption, fuel consumption, food consumption, water consumption, etc.). For example, the corpus or group of entities may be very large, e.g., hundreds, thousands, millions, or even billions of entities. Furthermore, the granular data points or data features that could be collected for each entity of the corpus or group of entities to determine emissions indicators may be even larger. These granular data points can indicate real-time or historical activities of users, specific granular descriptions of commuting routes of the users, granular descriptions of vehicle engine types or fuel efficiencies, etc. The amount of data storage needed to store the granular data points for the corpus or group of entities may be very large. Furthermore, processing and managing this large volume of data can require significant amounts of computational resources (e.g., processor and memory resources) and require significantly long processing times. These long processing times can cause computational resources to be in an operational state causing significant amounts of power to be drawn from a power source. Furthermore, entities of the corpus or group of entities may not wish to provide granular data to the emissions system for security reasons and therefore collecting the granular data from entities may have challenges.

To solve these, and other technical challenges, the systems and methods discussed herein can manage the large volume of data for the corpus or group of entities in a manner that reduces data storage resources used, reduce processor and memory resources used, reduce an amount of power consumption needed by the computing systems that implement the systems and methods, and allow for emissions indicators to be generated faster than conventional methods. For example, the emissions system can collect high-level data for the corpus or group of entities instead of, or in addition to, low-level data. The high-level data can indicate general behaviors, habits, or activities of the corpus or group of entities. The emissions system can generate emissions indicators based on the high-level data. However, because the high-level data is less granular, without correction or accounting of this lack of granularity, an accuracy of the emissions indicators could be reduced. To address the lack of granularity (e.g., to retain accuracy notwithstanding the lack of granularity of the high-level data), the emissions system described herein implements modeling assumptions that model low-level data based on the collected high-level data. This allows the emissions system described herein to quickly and efficiently determine emissions indicators while maintaining a high accuracy for the emissions indicators.

The emissions system further solves technical challenges in the display of emissions indicators for a large corpus or group of entities. Displaying the causes of emissions production for a corpus or group of entities may be difficult to summarize since there are a significant amount of possible emissions causes. To solve these, and other technical problems, the emissions system described herein is capable of generating emissions indicators based on the collected high-level data and modeling assumptions in multiple categories. The emissions system can generate, based on the modeling assumptions and the high-level data for each entity of the corpus or group of entities, an emissions indicator for each entity in each category. The emissions system can sort the emissions indicators into buckets of data such that the emissions data is organized by category. The emissions system can aggregate the emissions indicators of each bucket into a single emissions indicator for each category. The emissions indicators can, in some embodiments, be a timeseries of emissions indicators, e.g., emissions indicators for multiple points in time. In this regard, the emissions system can generate a set of emissions indicators for each point in time for a set of points in time for each category. The emissions system can generate a total emissions indicator for the corpus or group. The total emissions indicator can be an aggregate for emissions indicators of each category.

The emissions system can generate a user interface that displays the total emissions indicator for the corpus or group of entities. The user interface could be a trend or bar graph. The emissions system can cause the user interface to include a selectable element that allows a user to select between the categories. The user interface can update based on a selection of the user and drill down from the total emissions indicator to category level emissions indicators down to entity level emissions indicators. This user interface can allow a user to grasp, within a single interface, the breakdown of emissions indicators for the large corpus or group of entities which would normally require multiple different types of presentation formats.

Furthermore, the emissions system can aid a user or group of users to reduce their emissions footprint and track the performance of emissions reduction. The emissions system can help a user set carbon footprint goals, e.g., zero emissions goals or near zero emissions goals (e.g., net zero emissions goals, including offsets/investments). The emissions system can provide projects or carbon offsets that allow the user or group of users to reduce their carbon footprint and meet the carbon footprint goals that they have set.

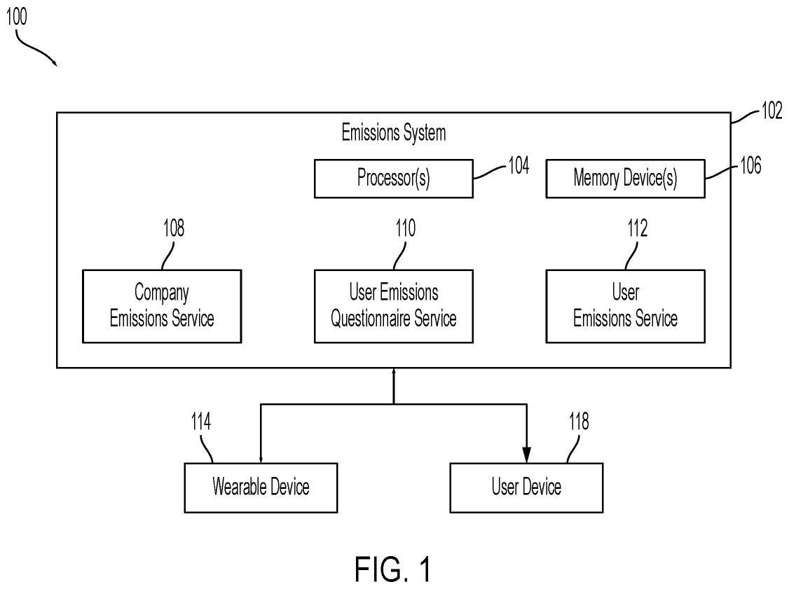

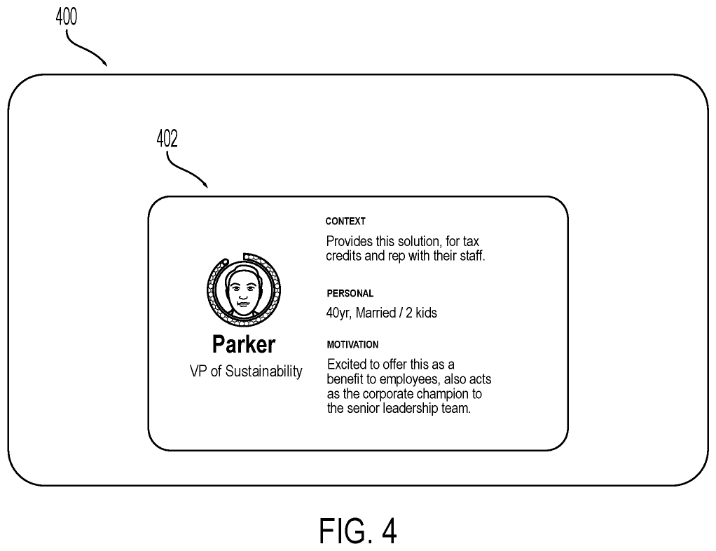

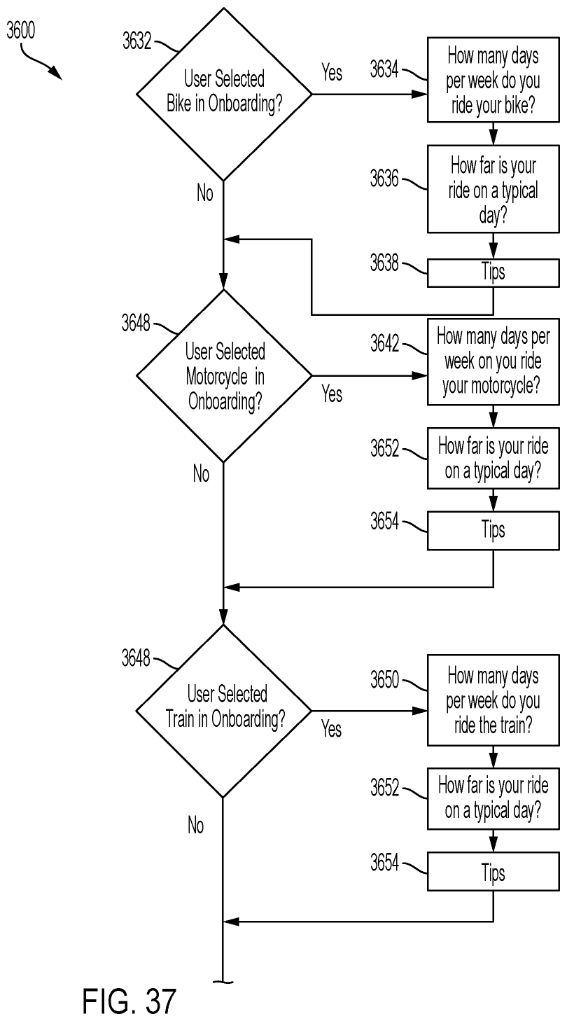

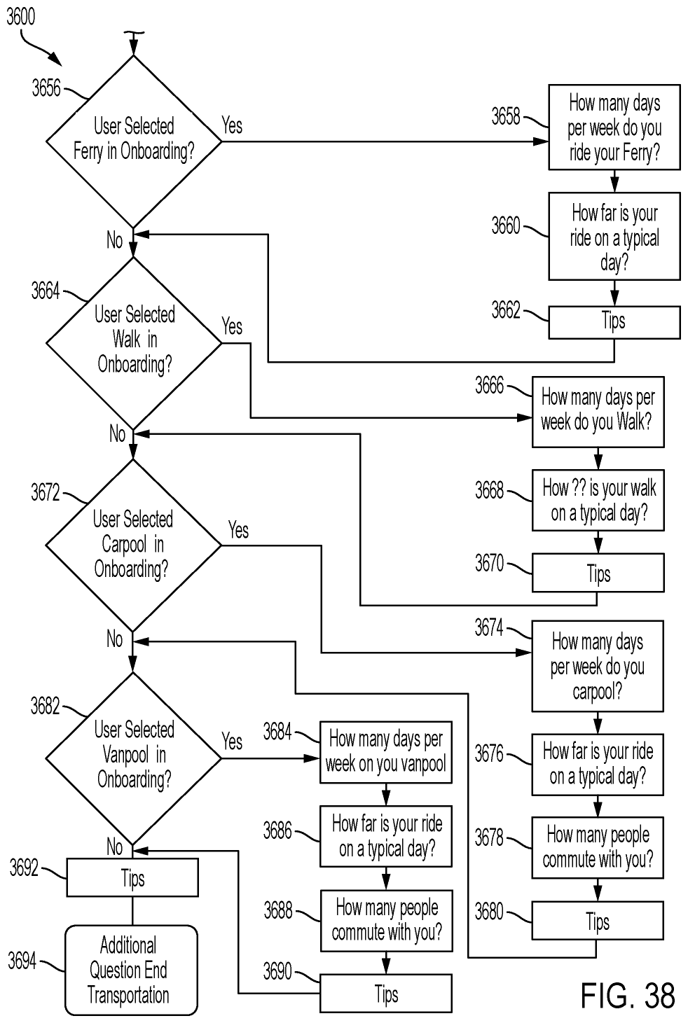

Referring now to FIG. 1, a block diagram of a system 100 including an emissions system 102 tracking and reducing emissions of a user or company is shown, according to an exemplary embodiment. The emissions system 102 can be a computer system (e.g., desktop computer, database system, server system, a cloud computing platform, etc.) that is configured to communicate with the wearable device 114 and/or user device 118. The user interfaces and interface elements of FIGS. 4-63 can be generated by the emissions system 102 and displayed on the wearable device 114 and/or the user device 118. Furthermore, the emissions system 102 can receive user input from the user interfaces of FIGS. 4-63 via the wearable device 114 and/or the user device 118.

The wearable device 114 can be a smartwatch, a smart ring, smart glasses, a smart necklace, a pacemaker, etc. The wearable device 114 can collect data associated with travel, heart rate, blood pressure, etc. The user device 118 can be a smartphone, a tablet, a laptop, a desktop computer, a mobile device, etc. The user device 118 can include a display device for displaying user interfaces to a user (e.g., a LED screen, an OLED screen, etc.). The user device 118 can include input devices for receiving user input. For example, a touch screen, a mouse, a keyboard, etc. The wearable device 114 can include a similar display device and/or an input device.

A network can be used by the emissions system 102 to communicate with the wearable device 114 and/or the user device 118. The network can be a Local Area Network (LAN), a Wide Area Network (WAN), the Internet, a cellular network (e.g., 3G, 4G, 5G), a Bluetooth connection, a Wi-Fi network, and any other type of wired or wireless form of communication. The emissions system 102 can include one or more processors 104 and one or more memory devices 106.

The processor(s) 104 can be a general purpose or specific purpose processor, an application specific integrated circuit (ASIC), one or more field programmable gate arrays (FPGAs), a group of processing components, or other suitable processing components. The processor(s) 104 may be configured to execute computer code and/or instructions stored in the memories or received from other computer readable media (e.g., CDROM, network storage, a remote server, etc.).

The memory device(s) 106 can include one or more devices (e.g., memory units, memory devices, storage devices, etc.) for storing data and/or computer code for completing and/or facilitating the various processes described in the present disclosure. The memory device(s) 106 can include random access memory (RAM), read-only memory (ROM), hard drive storage, temporary storage, non-volatile memory, flash memory, optical memory, or any other suitable memory for storing software objects and/or computer instructions. The memory device(s) 106 can include database components, object code components, script components, or any other type of information structure for supporting the various activities and information structures described in the present disclosure. The memory device(s) 106 can be communicably connected to the processor(s) 104 and can include computer code for executing (e.g., by the processors) one or more processes described herein.

The emissions system 102 includes a company emissions service 108, a user emissions questionnaire service 110, and a user emissions service 112. The services 108-112 can be stored as instructions on the memory devices 106 and run by the processors 104. The services 108-112 can provide information to the wearable device 114 and/or the user device 118. Similarly, the services 108-112 can receive information recorded and/or input by users of the wearable device 114 and/or the user device 118.

The company emissions service 108 can be configured to record emissions information of a company, generate emissions indicators, and generate user interfaces including the emissions indicators for the company. In some embodiments, the company emissions service 108 can generate user interfaces for any other type of group of individuals, e.g., a company, a school, a college, a university, a family, a state, a city, a country, etc.

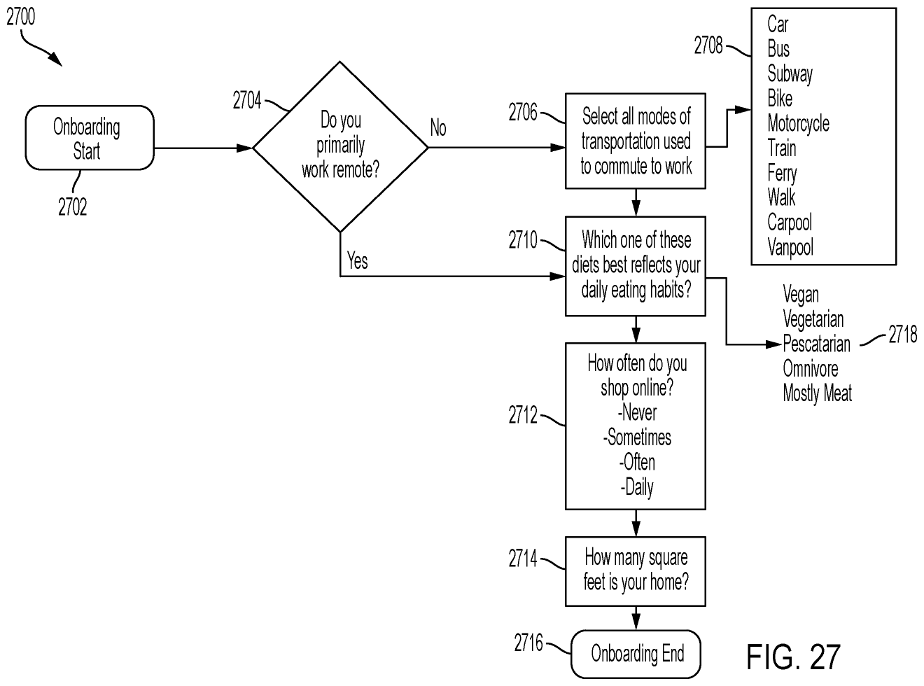

The user emissions questionnaire service 110 can be configured to provide a user with a series of questions to determine a carbon footprint of a user, e.g., via the wearable device 114 and/or the user device 118. The emissions questionnaire service 110 can generate the carbon footprint based on the responses received from the user. The user emissions questionnaire service 110 can generate the user interfaces of FIGS. 27-42. The user interfaces of FIGS. 27-42 can be displayed on the wearable device 114 and/or the user device 118. The user emissions service 112 can be configured to record emission information specific to a user and generate emissions user interfaces for the user. The user emissions service 112 can receive tracking data (e.g., global positioning system data) and/or user input from the wearable device 114 and/or the user device 118 and generate the emissions user interfaces based on the recorded data. The emissions system 102, or various components of the emissions system 102, can generate data that causes the wearable device 114 or the user device 118 to display the interfaces described with references at FIGS. 4-63.

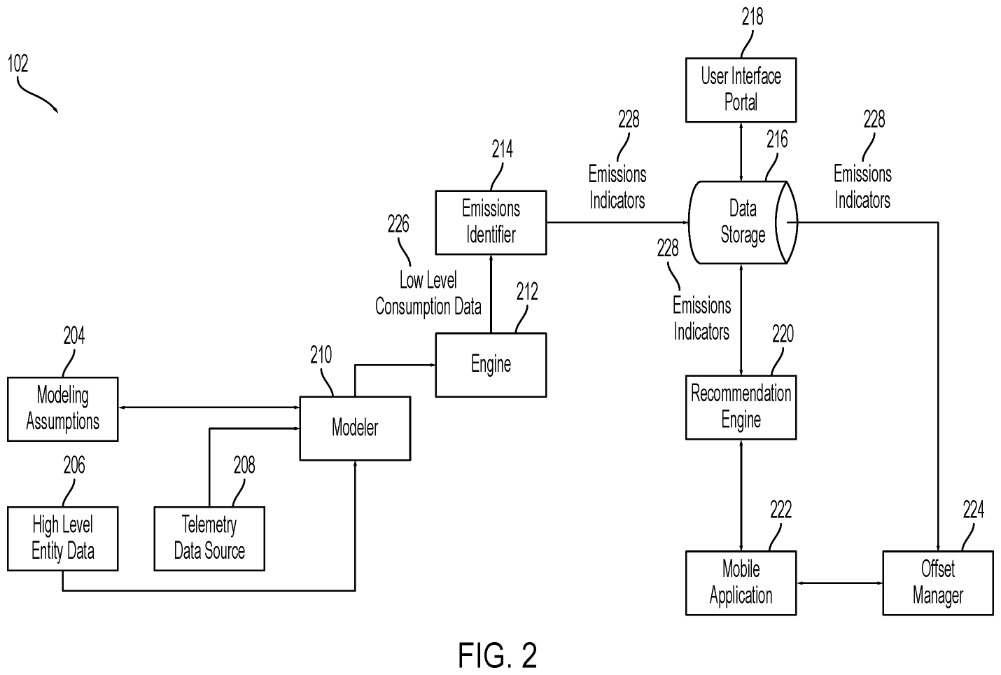

Referring now to FIG. 2, the emissions system 102 generating emissions indicators 228 from high-level entity data 206 based on modeling assumptions 204 is shown, according to an exemplary embodiment. The emissions system 102 includes a modeler 210. The modeler 210 can model high-level entity data 206 with modeling assumptions 204 to generate low-level consumption data 226 via an engine 212. The modeling assumptions 204 can indicate low-level consumption data 226 that results from certain high-level entity data 206. The modeling assumptions 204 can be global modeling assumptions or customer specific assumptions. For example, the high-level entity data 206 could describe general characteristics or behaviors of a an entity (e.g., a user, a group of users, a family, etc.), for example, commuting characteristics, residential heating, cooling, or electrical consumption, eating tendencies, etc. In some embodiments, one or more of the characteristics or behaviors of an entity can have a first characteristic corresponding to working from home, and a second characteristic corresponding to not working from home (e.g., commuting to an office). For example, the commuting characteristics, residential heating, cooling, electrical consumption, eating tendencies, etc., can have a first a work from home commuting characteristic may be different than a non-work from home commuting characteristic. The high-level entity data 206 can be non-specific, e.g., the high-level entity data 206 could indicate an eating preference (e.g., meat, vegan, vegetarian, pescatarian, etc.). Similarly, the high-level entity data 206 could indicate characteristics of a vehicle of the user or commute of the user, e.g., a size (e.g., small, medium, or large) of the vehicle and a fuel type of the vehicle (e.g., gas, electric, hydrogen, etc.).

The modeling assumptions 204 can model the low-level consumption data 226 with the high-level entity data 206. For example, the modeling assumptions 204 can indicate expected consumption levels of a vehicle of a particular size (e.g., small, medium, or large). The modeling assumptions 204 can indicate expected food consumption levels of particular eating habits (e.g., meat, vegan, vegetarian, pescatarian, etc.). The modeling assumptions 204 can indicate expected low-level consumption data 226 of shopping habits, e.g., amount of merchandise purchased that result from in-person shopping, online shopping, etc. The modeling assumptions 204 can indicate expected low-level consumption data 226 that results from certain types of HVAC equipment for certain sizes of a home, e.g., certain run times, energy consumptions, fuel consumptions, etc. The modeling assumptions 204 can be region specific, in some embodiments. For example, different geographic regions may have different weather patterns and residential homes in different geographic regions can consume various amounts of energy based on their location, e.g., extreme hot or cold climates can cause HVAC equipment to consume more energy than mild or temperate climates. In some embodiments, the modeling assumptions 204 can indicate low-level consumption data 226 of a work from home setup. For example, the modeling assumptions 204 may indicate an expected low-level consumption data 226, based on an indication regarding the frequency of working from home (e.g., days/week, days/month, etc.), a work from home duration (e.g., hours/day, etc.), the number of computers (e.g., desktop computers, laptop computers) utilized while working from home, the number of external monitors (e.g., external displays, screens, graphical display devices) utilized while working from home, and other remote work quantifiers. In some embodiments, the modeling assumptions 204 may indicate an expected low-level consumption data 226 of additional home heating and cooling emissions, workstation electronics that are added onto existing residential footprint, etc. In some embodiments, the modeling assumptions 204 may be based on temporary or lasting statuses of societal or regional health emergencies and/or government orders (e.g., stay-at-home orders). For example, different geographic regions may have different restrictions on commuting and social engagements, which can cause the amount of energy consumed due to working from home or by a building to vary. For example, additional heating and cooling emissions may be based on increases or decreases in residential energy consumption. For example, the modeling assumptions 204 may produce low-level consumption data 226 based on data associated with pre-pandemic circumstances, ongoing-pandemic circumstances, or post-pandemic circumstances.

The modeler 210 can receive telemetry data from a telemetry data source 208. The telemetry data source 208 can be data storage element (e.g., a database) that collects data of devices. The devices could be a vehicle telematics system, airline flight data, a wearable, a smart thermostat, etc. The telemetry data source 208 could be an Internet of Things (IoT) event hub. The telemetry data source 208 could establish a communication connection with an edge device and collect telemetry data from the edge device via the communication connection. The communication connection could be established via a network, e.g., the Internet, a cellular network, MQ Telemetry Transport (MQTT), etc. The network could be the network described with reference to FIG. 1. The devices could be smartphones (e.g., the user device 118), vehicle systems, health tracking devices (e.g., the wearable device 114), etc. In addition to the high-level entity data 206, the modeler 210 can model the low-level consumption data 226 based on the telemetry data of the telemetry data source 208. While the high-level entity data 206 might indicate that a user commutes on average five times a week in a compact vehicle, the telemetry data could be telemetry data received from a telematics system of the vehicle that indicates specific fuel efficiencies, distances traveled, etc.

In some embodiments, a user can provide low-level consumption data 226 to the emissions system 102 via the user device 118 via a questionnaire. The questionnaire can collect one, tens, or hundreds of attributes that describe a consumption profile of the user. Via the modeling assumptions 204, the modeler 210 and the engine 212 can generate the low-level consumption data 226 for the user based on the profile built for the user. The modeler 210 can identify attribute values that are appropriate for each user. The attribute values can be modeling assumptions 204. The modeler 210 can analyze the profile built for an individual and select the modeling assumptions 204 most appropriate for the individual. For example, if the individual rides the bus to work and cats meat, the modeler 210 can select modeling assumptions 204 that model consumption for riding the bus for a commuting category and eating meat for an eating category.

In some embodiments, the modeling assumptions 204 can be modified for individual entities of a corpus or group of entities. For example, if a user knows the average annual temperature, the average summer temperature, or the average winter temperature for their geographic region, the user could provide this information to the emissions system 102 via the user device 118. The emissions system 102 could set the modeling assumptions 204 for energy consumption to heat or cool the home of the user based on the average temperatures provided by the user. These specific details entered by one user could be used by the modeler 210 for another user. For example, if a first user provides temperature data for a geographic region of the user, the modeler 210 could identify that a second user is in the same geographic region. The modeler 210 could select the modeling assumptions 204 for the second user to be the same as the modeling assumptions 204 determined to be used for the first user based on the temperature data provided by the first user for the geographic region. Similarly, the user could provide an average monthly bill for energy for their home to the emissions system 102.

In some embodiments, for a corpus or group of entities, the telemetry data source 208 can sort and organize telemetry data for various entities of the corpus or group of entities. For example, the telemetry data source 208 can store an indication of each entity of the corpus or group of entities and store relationships between each entity and the telemetry devices of each entity. In this regard, the telemetry data source 208 can sort, filter, or tag data based on the relationships between the entities and the edge devices.

The modeler 210 can, in some embodiments, execute machine learning and/or an artificial intelligence algorithm to tune the modeling assumptions 204. For example, because the telemetry data of the telemetry data source 208 is granular and specific to the activities of an entity, the low-level consumption data 226 that is generated from the telemetry data can be highly accurate. The modeler 210 can execute the machine learning and/or artificial intelligence algorithm based on the telemetry data to learn modeling assumptions 204. This allows the emissions system 102 to collect a small amount of telemetry data for a small portion of entities of the corpus or group of entities and utilize the learned modeling assumptions 204 to make accurate determinations of the low-level consumption data 226 for entities of the corpus or group of entities that do not have telemetry data. In this regard, data storage reductions, processing resource reductions, processing speed improvements can be realized. For example, instead of storing and processing telemetry data for an entire corpus or group of entities, the emissions system 102 may only store and process telemetry data for a small portion of the corpus or group of entities. Instead of storing telemetry data for the other entities of the corpus or group of entities (which would require a large amount of storage resources) or perform a lengthy and resource intensive processing of the telemetry for the other entities, the modeler 210 can model the low-level consumption data 226 with the high-level entity data 206 and the learned modeling assumptions 204.

The engine 212 can generate the low-level consumption data 226 based on the output of the modeler 210. The low-level consumption data 226 can be consumption values in one or multiple categories. The categories could be commuting to work, commuting home from work, residential heating, residential cooling, residential electric consumption, food consumption, additional residential energy consumption attributable to working remotely (e.g., computing devices energy consumption, communications network system energy consumption, desktop computer energy consumption, computer monitor energy consumption, heating, ventilating and air conditioning energy consumption, lighting energy consumption, etc.). The low-level consumption data 226 could be generated by the engine 212 for one or multiple times. For example, the low-level consumption data 226 could be generated to indicate the consumption value of each entity of a corpus or group of entities in each category on a daily, weekly, bi-weekly, monthly, or yearly basis. The low-level consumption data 226 could indicate an amount of fuel consumed to commute to work on a particular day, a number of bus rides taken, a number of train rides taken, a length of time that a vehicle charged, an amount of energy consumed to heat or cool a building, an amount of meat, fish, vegetables, or grains consumed, etc.

The emissions identifier 214 can generate the emissions indicator 228 based on the low-level consumption data 226. The emissions identifier 214 can generate the emissions indicator 228 by determining an amount of emissions, e.g., carbon dioxide (CO2) or carbon dioxide equivalent (CO2e) that results from each particular consumption value of the low-level consumption data 226. The emissions identifier 228 can generate an emissions indicator 228 for each entity of a corpus or group of entities. The emissions identifier 228 can sort the emissions indicators 228 into buckets based on the category of the emissions indicators 228. For example, a commuting related emissions indicators 228 for the corpus or group of entities could be sorted into a commuting bucket. All shopping related emission indicators 228 can be sorted into a shopping bucket.

The emissions identifier 214 can further aggregate the emissions indicators 228 in each of the buckets to generate an emissions indicator for each category. For example, for a corpus or group of entities, the emissions identifier 214 could aggregate (e.g., sum, average, weight, etc.) the emissions indicators of each category into a single category emissions indicator 228. Furthermore, the emissions identifier 214 can aggregate (e.g., sum, average, weight, etc.) the emissions indicators 228 of each category into a total emissions indicator 228 for the corpus or group of entities. The individual emissions indicators 228 for each category, the category level emissions indicators 228, and the total emissions indicator can be time correlated data (e.g., timeseries data). For example, each emissions indicator 228 could be a series of emissions values for points in time, e.g., for days, weeks, months, years. The emissions identifier 214 can store trends of the emissions indicators 228 and update each trend as new emissions indicators 228 are generated.

The emissions identifier 214 can determine lifecycle emissions, in some embodiments. The emissions indicators 228 can include lifecycle emissions indicators. Lifecycle emissions can attribute carbon emissions back to the source of the original energy that is being consumed in a downstream activity. For example, the emissions identifier 214 can determine carbon emission from the generation of electric power at a plant flowing into a residential home. If the power plant sources energy from 50% nuclear and 50% coal, the emissions identifier 214 can determine emissions indicators that accurately reflect not only the emission from the use of appliances in a home, but the emission associated with the actual generation of power via coal and nuclear production.

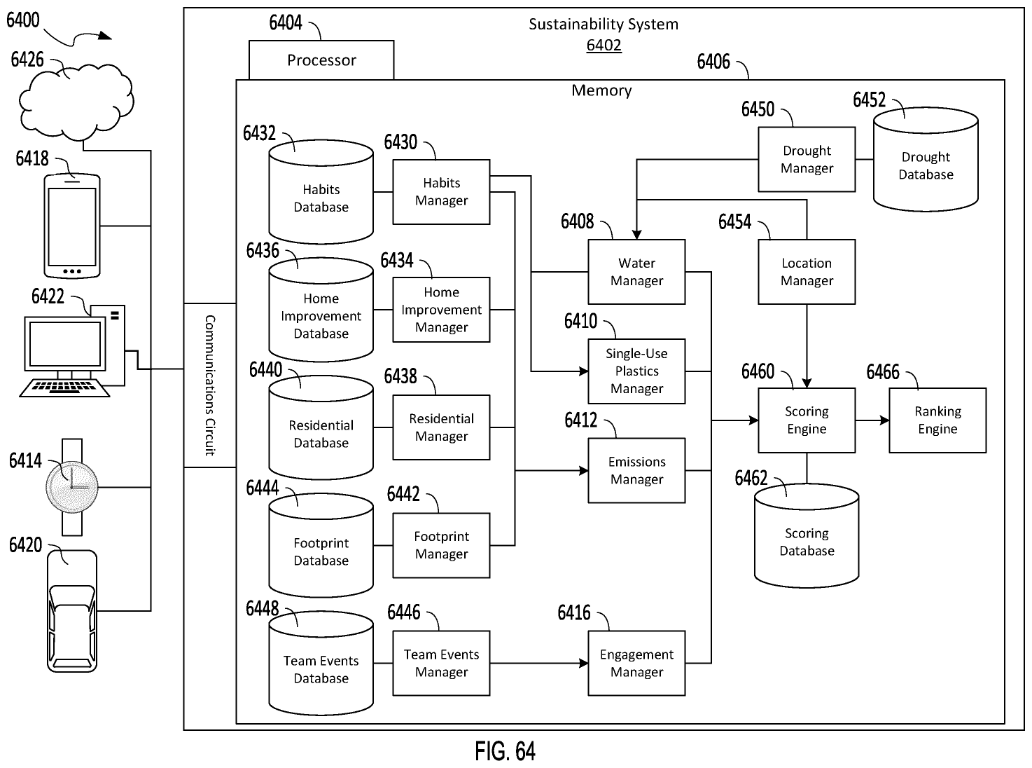

A user interface portal 218 can allow a user to access and view the emission indicators 228. The user interface portal 218 can generate user interfaces, e.g., the user interfaces of FIGS. 4-64. The user interface portal 218 can populate various user interface elements of the user interfaces of FIGS. 4-64 based on the emissions indicators 228 stored in the data storage 216. Furthermore, recommendations generated by the recommendation engine 220 can be displayed in the user interfaces of the FIGS. 4-64. The user interface portal 218 can retrieve the recommendations from the data storage 216 stored in the data storage 216 via the recommendation engine 220. The user interface portal 218 can populate user interface elements (e.g., the user interfaces of FIGS. 4-64) with the recommendations.

The emissions system 102 can include a recommendation engine 220. The recommendation engine 220 can generate recommendations for improving the emissions indicators 228. For example, the recommendation engine 220 can generate recommendations on a company level. The recommendation engine 220 can generate the recommendations on the company level based on category level emissions indicators 228 or total emissions indicators 228 for the corpus or group of entities. The recommendation engine 220 can generate recommendations for individual entities of the corpus or group of entities. For example, the recommendation engine 220 can generate a recommendation for a particular user based on the emissions indicators 228 for each user. The recommendation engine 220 can generate category based recommendations for the entire corpus or group of entities e.g., based on category level emissions indicators 228. The recommendation engine 220 can generate category based recommendations for particular entities based on the emissions indicators 228 for the particular entities in particular categories.

The recommendations can be recommendations to adjust commuting, e.g., a suggestion to take a bus more frequently, invest in a more fuel efficient vehicle, work from home more frequently, etc. The recommendations could be recommendations to change water usage, e.g., take shorter showers. The recommendations could be recommendations to change eating habits, e.g., cat less meat, cat more vegetables, etc.

The emissions system 102 includes an offset manager 224. The offset manager 224 can acquire carbon offsets that offset the emissions indicators 228. The offset manager 224 can receive a section, by a user, to acquire a particular offset and communicate with an external system that manages the offset to acquire the offset. In some embodiments, the offset manager 224 receives votes or indications of interest of various types of offsets from a user via a mobile application 222. The offset manager 224 can aggregate the votes or indications of interest to determine which offsets have the most votes or indications of interest. The offset manager 224 could identify which categories have a number of votes or indications of interest greater than a particular amount. The offset manager 224 can acquire an offset responsive to determining that the offset has the most votes or indications of interest. The offset manager 224 can acquire the offset responsive to determining that the offset has a number of votes or indications of interest greater than a particular amount.

The mobile application 222 can be a mobile application run on a user device such as the user device 118 or the wearable device 114. The mobile application can include user interfaces, for example, the user interfaces of FIGS. 4-63. The mobile application 222 can generate user interfaces, e.g., the user interfaces of FIGS. 4-63. The mobile application 222 can populate various user interface elements of the user interfaces of FIGS. 4-63 based on the emissions indicators 228 stored in the data storage 216. Furthermore, recommendations generated by the recommendation engine 220 can be displayed in the user interfaces of the FIGS. 4-63. The mobile application 222 can retrieve the recommendations from the data storage 216 stored in the data storage 216 via the recommendation engine 220. The mobile application 222 can populate the user interface elements of FIGS. 4-63 with the recommendations.

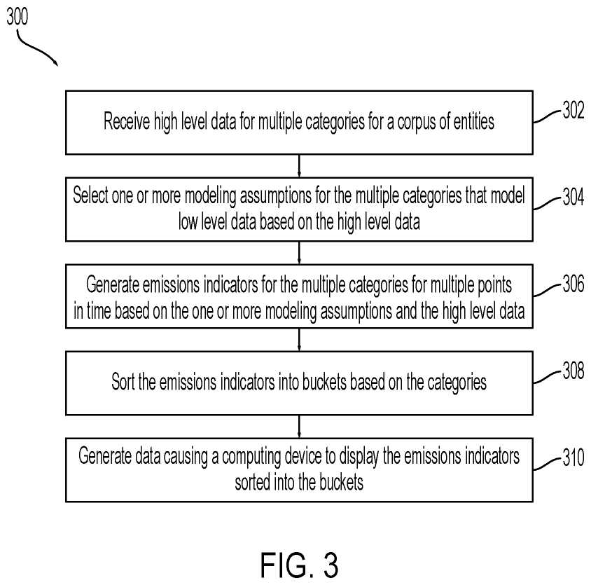

Referring now to FIG. 3, a process 300 of generating the emissions indicators from the high-level data based on the modeling assumptions is shown, according to an exemplary embodiment. The emissions system 102 can be configured to perform the process 300. For example, the process 300 can be performed by components of the emissions system 102. For example, the modeler 210, the engine 212, the emissions identifier 214, etc. of the emissions system 102 can be configured to perform the process 300. Furthermore, any computing system described herein can be configured to perform the process 300.

In step 302, the process 300 can include receiving, by one or more processing circuits, high-level data for multiple categories for a corpus or group of entities. For example, the emissions system 102 can receive the high-level entity data 206 for the corpus or group of entities. The corpus or group of entities could be users of a group, e.g., employees of a company, members of a family, citizens of a city, state, or country, occupants of a building, etc. The high-level data can indicate high-level behaviors, characteristics, preferences, or a profile of consumption for the entities of the corpus or group of entities in various categories (e.g., commuting, food, shopping, business travel, additional consumption from remote work, remote work behaviors, work from home setups, work from home frequency, work from home durations, etc.). For example, the high-level data could indicate typical commute distance, typical commute day per week, average size of a vehicle driven, utilization of busses, trains, shopping habits, food habits, etc. As another example, the high-level data could indicate typical work from home frequency (e.g., days per week, days per month, days per year, work from home occurrences per unit time, etc.), work from home duration (e.g., hours per day, hours per week, hours per month, etc.), work from home hardware and energy consumption (e.g., energy consumptions attributed to desktop computer use, laptop computer use, external monitor use, home office lighting usage, home office air conditioning usage, home office internet usage, etc.).

In step 304, the process 300 can include selecting, by one or more processing circuits, one or more modeling assumptions for the multiple categories that model low-level data based on the high-level data. The high-level data can be the high-level data received in the step 302. The emissions system 102 can select one or multiple of the modeling assumptions 204. The modeling assumptions 204 can model the low-level consumption data 226 based on the high-level entity data 206. For example, the modeling assumptions 204 could indicate energy consumption for heating or cooling a building for certain ranges of square feet, geographic locations, equipment types, etc. The high-level entity data 206 could indicate an approximate residence size, geographic location of the residence (e.g., state, city, region, etc.), and/or an indication of a type of equipment (e.g., air conditioning unit and furnace, heat pump system, etc.). Furthermore, the modeling assumptions 204 could indicate the amount of meat, vegetables, or dairy products consumed based on different food consumption behaviors (e.g., meat cater, vegan, vegetarian, pescatarian, etc.) of an entity indicated by the high-level entity data 206.

In step 306, the process 300 can include generating, by one or more processing circuits, emissions indicators for the multiple categories for multiple points in time based on the one or more modeling assumptions and the high-level data. The engine 212 can generate the low-level consumption data 226 based on the modeling assumptions 204 and the high-level entity data 206. The engine 212 can further generate the low-level consumption data 226 based on telemetry data of the telemetry data source 208. The engine 212 can provide the low-level consumption data 226 to the emissions identifier 214 and the emissions identifier 214 can generate the emissions indicators 228 based on the low-level consumption data 226.

In step 308, the process 300 can include sorting the emissions indicators into buckets based on the categories. For example, the emissions identifier 214 can generate an emissions indicator 228 for each entity for a corpus or group of entities in each category. The emissions identifier 214 can sort the emissions indicators 228 into buckets. The buckets can be data groupings or regions of the data storage 216 for storing emissions indicators 228 of each category. The emissions identifier 214 can sort the emissions indicators based on category such that each bucket includes all of the emissions indicators of the corpus or group of entities for each category. The emissions identifier 214 can store the sorted data in the data storage 216.

In step 310, the process 300 can include generating data causing a computing device to display the emissions indicators sorted into the buckets. The emissions system 102 can generate data that causes user interfaces to be displayed on computing devices such as the wearable device 114 or the user device 118. The user interfaces can be the user interfaces of FIGS. 4-63.

Referring now to FIG. 4-7, user interfaces 400-700 for various roles, e.g., a vice president, a CEO, and a sales department representative are shown, according to an exemplary embodiment. The emissions system 102 can be user-specific based on a role of an individual that is logged into the user interfaces 400-700, e.g., CEOs, vice presidents, sales representatives, etc. The emissions information displayed in various user interfaces described herein can be tailored based on the role of the logged in user. In some embodiments, a user can view the emissions tracking data of the user and the individuals of the user's team or employees.

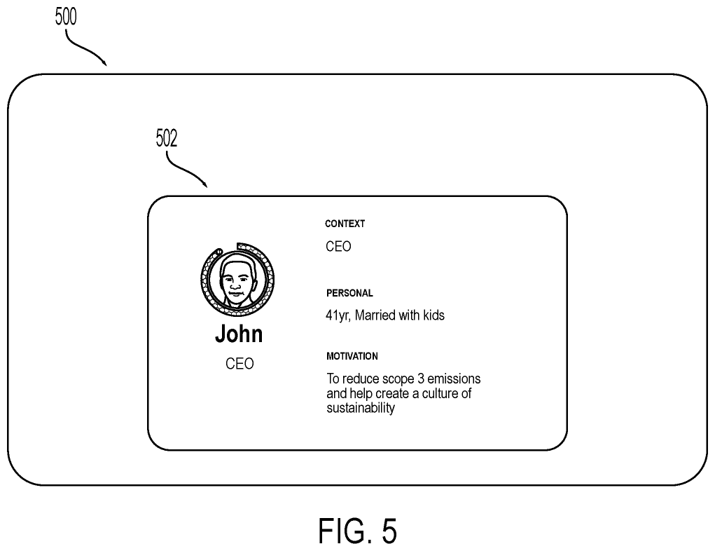

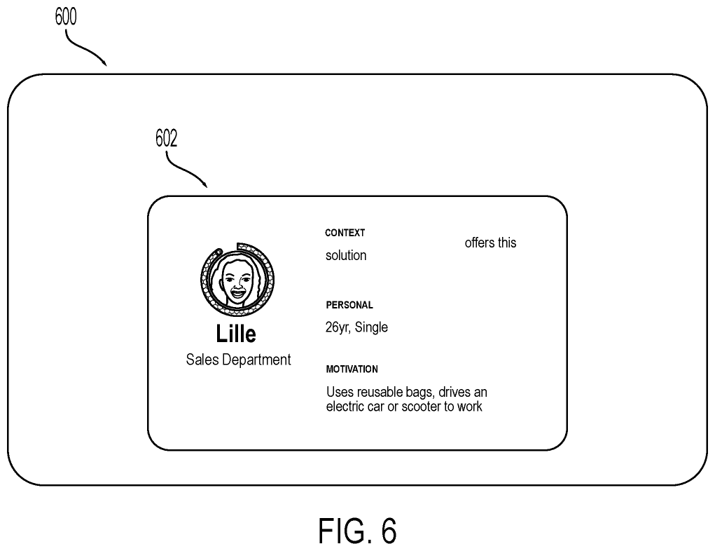

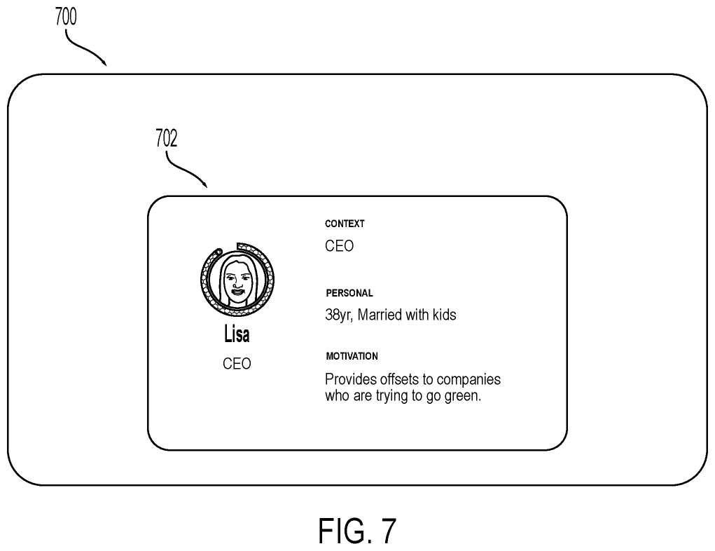

FIG. 4 is a user interface 400 with an element 202 for a user Parker. Parker may be a vice president of sustainability at a company. FIG. 5 is a user interface 500 that includes an element 502 for a user John. John may be a CEO of a particular company. FIG. 6 is a user interface 600 that includes an element 602 for a user Lille. Lille may be a sales department representative or team leader. FIG. 7 is a user interface 700 that includes an element 702 for a user Lisa. Lisa may be a CEO of a particular company. The information displayed in the various following interfaces can be tailored based on the role of the user logged in, e.g., a user may view carbon information associated with their employees, e.g., a CEO may view all emission data of a company while a department leader may view emissions data associated with their department.

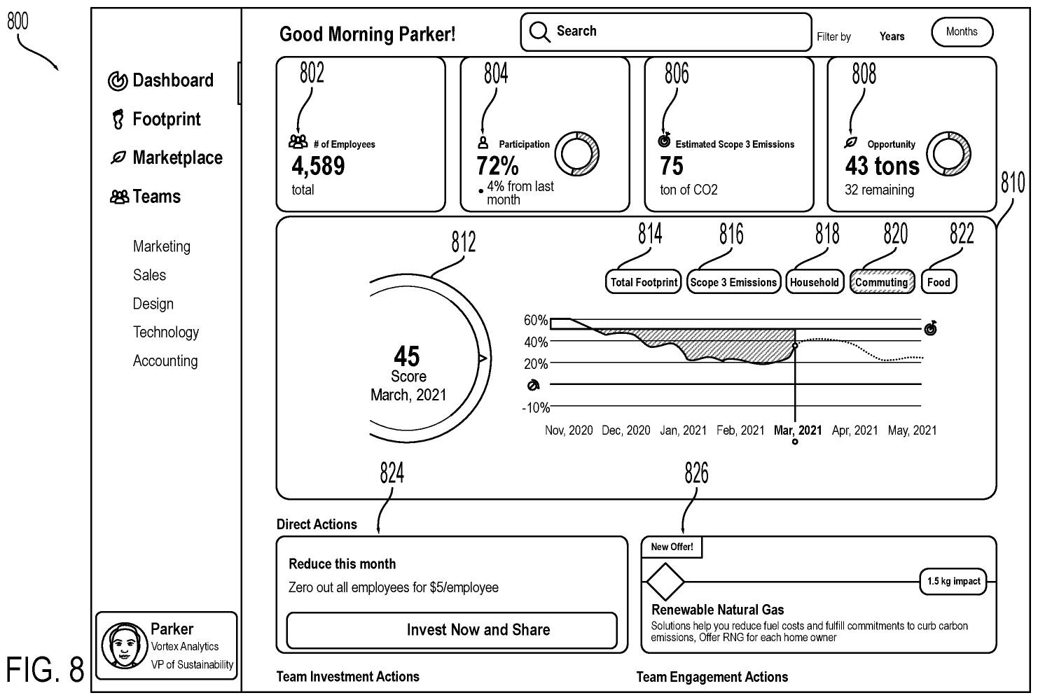

Referring now to FIG. 8, user interface 800 of an emissions tracking dashboard is shown, according to an exemplary embodiment. In FIG. 8, a user interface 800 includes elements 802-808. The element 802 includes an indication of a total number of employees for a particular company that the emissions system 102 generates the interface 600 for. The element 804 includes an indication of percentage of employees that are participating in the emissions tracking and reduction of the emissions system 102. The element 804 further includes an indication of a percentage increase since a previous month. The element 806 provides an estimated scope of emissions at tons of carbon dioxide (CO2). The element 808 provides an opportunity indication, a number of opportunities to reduce carbon and a number of tons of carbon that could be reduced.

The user interface 800 includes an element 810 that provides a carbon footprint score in an element 812 for a company, team, and/or individual. The score can be provided along with a trend of the carbon footprint score over time. The trend can further include a goal set by the company and/or a user for reducing carbon emissions to. The score and the trend can be filtered by various parameters, e.g., based on total footprint 814, scope three emissions 816, household 818, commuting 820, food 822, etc.

The user interface 800 can further include elements 824 and 826 that describe actions for reducing the carbon footprint, e.g., to get the carbon footprint closer to zero and/or below the threshold set for the company. The element 824 can describe an investment, e.g., $5 per employee investment, that purchases carbon offsets or other carbon reducing financial derivatives that “zero out” employees for the company, e.g., reduce carbon scores below a threshold or make a carbon footprint zero. The element 626 can describe a renewable natural gas (RNG) reduction where utilizing RNG for the company would result in a specific carbon footprint reduction. The investments can be made by an employee or a company.

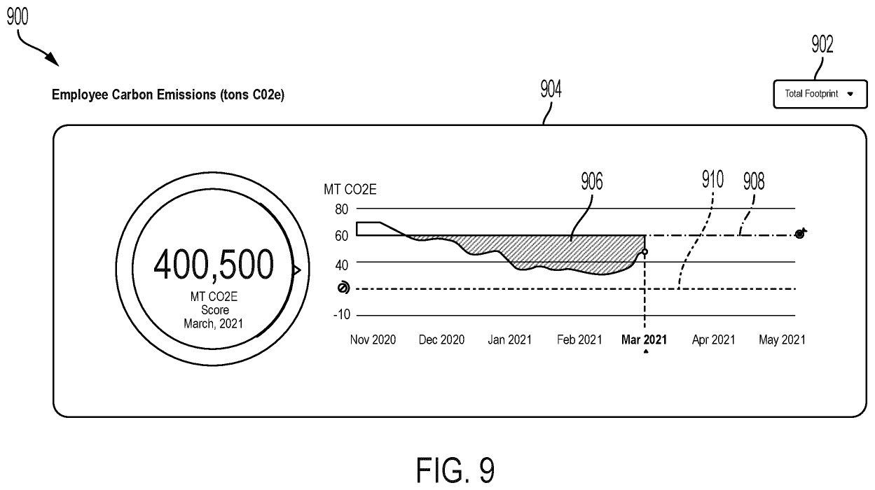

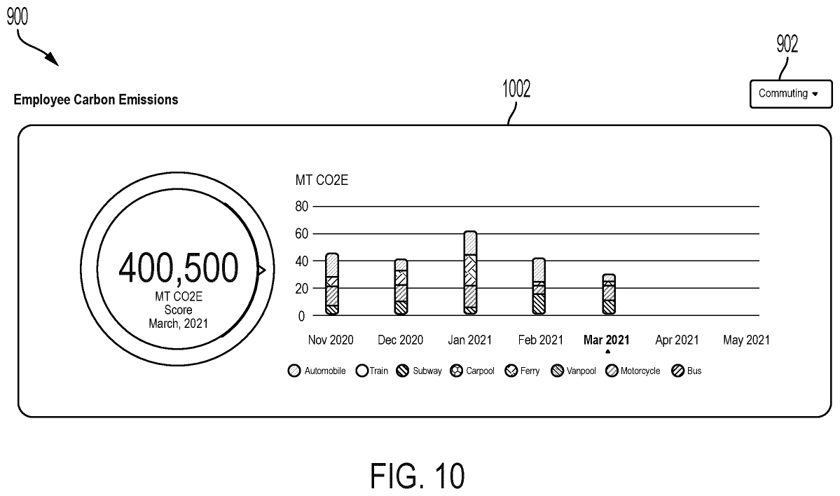

Referring now to FIG. 9, an emissions trend 900 of emissions indicators is shown, according to an exemplary embodiment. Element 904 includes a trend line 906 indicating the emissions indicators 228. The element 904 can indicate the emissions indicators 228 for various points in time, e.g., days, months, years, decades, etc. The emission indicators 228 can be carbon dioxide or carbon dioxide equivalent. The emissions trend 900 includes a target 908. The target 908 can be set by a user via the user device 118. The target 908 could be a group goal, e.g., the goal for a company, family, city, state, or country. The trend 900 includes a target 908 indicating zero emissions. The emissions trend 900 can include a zero emissions line 910. A user can interact, via the user device 118, with the element 902 to switch between a total footprint, e.g., as shown in FIG. 9, to other categories, e.g., as shown in FIGS. 10-14.

Referring now to FIG. 10, the emissions trend 900 of FIG. 10 drilled down to a commuting transportation category is shown, according to an exemplary embodiment. The element 1002 indicates emissions indicators 228 for months broken down into commuting categories. The element 1002 can indicate the emissions indicators 228 for various points in time, e.g., days, months, years, decades, etc. The categories can be automobile, train, subway, carpool, ferry, vanpool, motorcycle, bus, or any other method of commuting. Each bar of the element 1002 can include sub-components that indicate the amount of emissions attributed to each category.

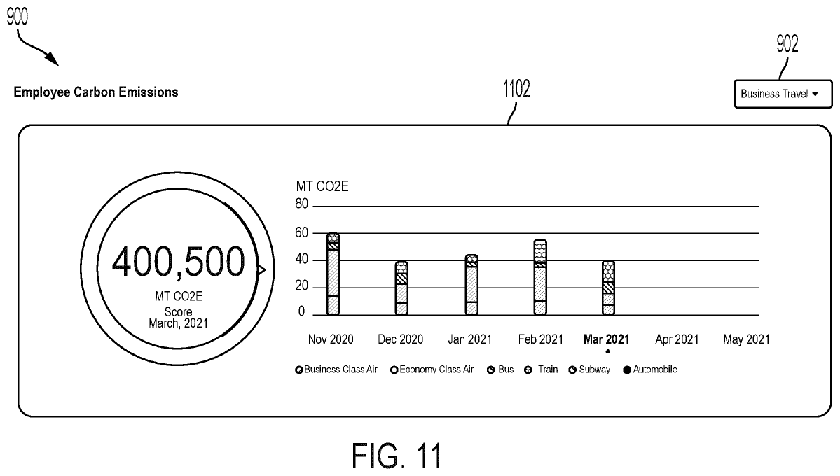

Referring now to FIG. 11, the emissions trend 900 drilled down to a business transportation category is shown, according to an exemplary embodiment. The element 1102 indicates emissions indicators 228 broken down into business travel categories. The element 1102 can indicate the emissions indicators 228 for various points in time, e.g., days, months, years, decades, etc. The categories can be business class air, economy class air, bus, train, subway, automobile or any other business travel. Each bar of the element 1102 can include sub-components that indicate the amount of emissions attributed to each category.

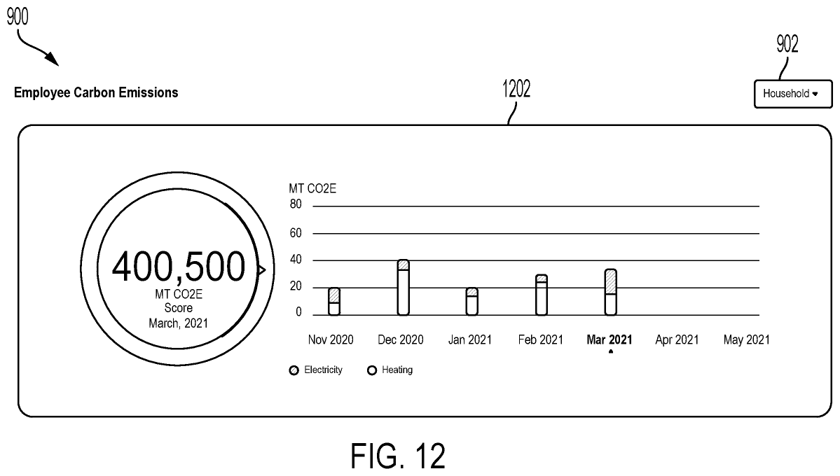

Referring now to FIG. 12, the emissions trend 900 drilled down to a household category is shown, according to an exemplary embodiment. The element 1202 indicates emissions indicators 228 broken down into household categories. The element 1202 can indicate the emissions indicators 228 for various points in time, e.g., days, months, years, decades, etc. The categories can be electricity, heating, cooling, ventilation, or any other category associated with households. Each bar of the element 1202 can include sub-components that indicate the amount of emissions attributed to each category.

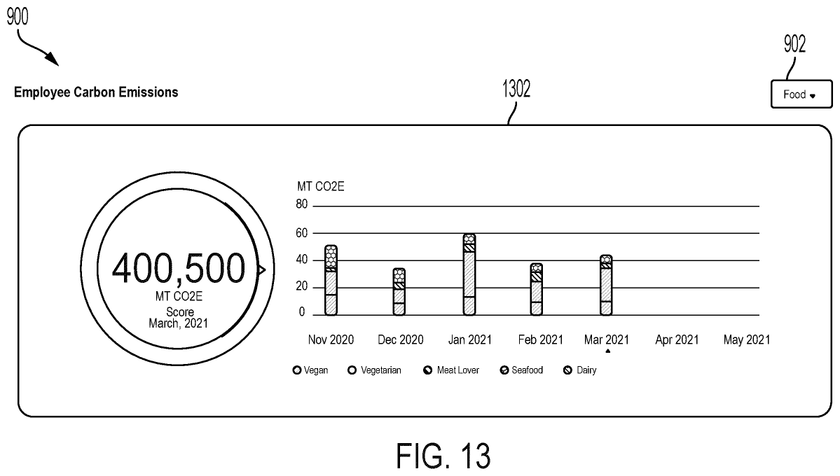

Referring now to FIG. 13, the emissions trend 900 drilled down to a food category is shown, according to an exemplary embodiment. The element 1302 indicates emissions indicators 228 broken down into food categories. The element 1302 can indicate the emissions indicators 228 for various points in time, e.g., days, months, years, decades, etc. The categories can be vegan, vegetarian, meat lover, seafood, dairy, or any other category associated with households. Each bar of the element 1302 can include sub-components that indicate the amount of emissions attributed to each category.

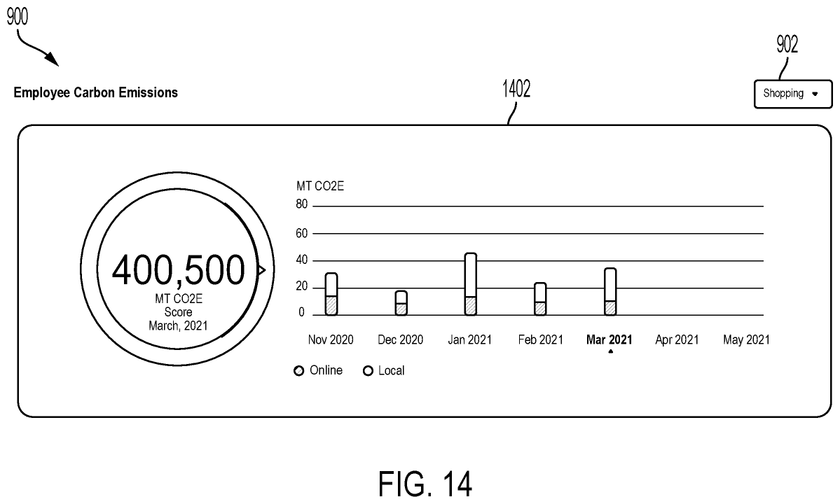

Referring now to FIG. 14, the emissions trend 900 drilled down to a shopping category is shown, according to an exemplary embodiment. The element 1402 indicates emissions indicators broken down into shopping categories. The element 1402 can indicate the emissions indicators 228 for various points in time, e.g., days, months, years, decades, etc. The categories can be online, local, in-person, big business, small business, or any other category associated with shopping. Each bar of the element 1402 can include sub-components that indicate the amount of emissions attributed to each category. For example, the element 1402 can include a sub-component or multiple sub-components that indicate the amount of emissions attributed to working from home. For example, the element 1402 can indicate a rate, total, difference, etc., of energy use attributed to workstation electronics of a home setup, energy use attributed to heating, cooling, ventilating, or air conditioning, and/or additional energy use attributed to lighting during working from home. The element 1402 can indicate a change in emissions over a first period of time and a change in emissions over a second period of time, or compare emissions from the first period of time to the emissions of the second period of time. For example, the element 1402 may indicate the change in emissions between working from home and not working from home. For example, an entity that has no work from home may have zero emissions attributed to working from home, but if the entity begins or increases the quantity of work from home, the emissions attributed to working from home may be non-zero and the element 1402 may indicate the change(s) via one or more sub-components of the element 1402.

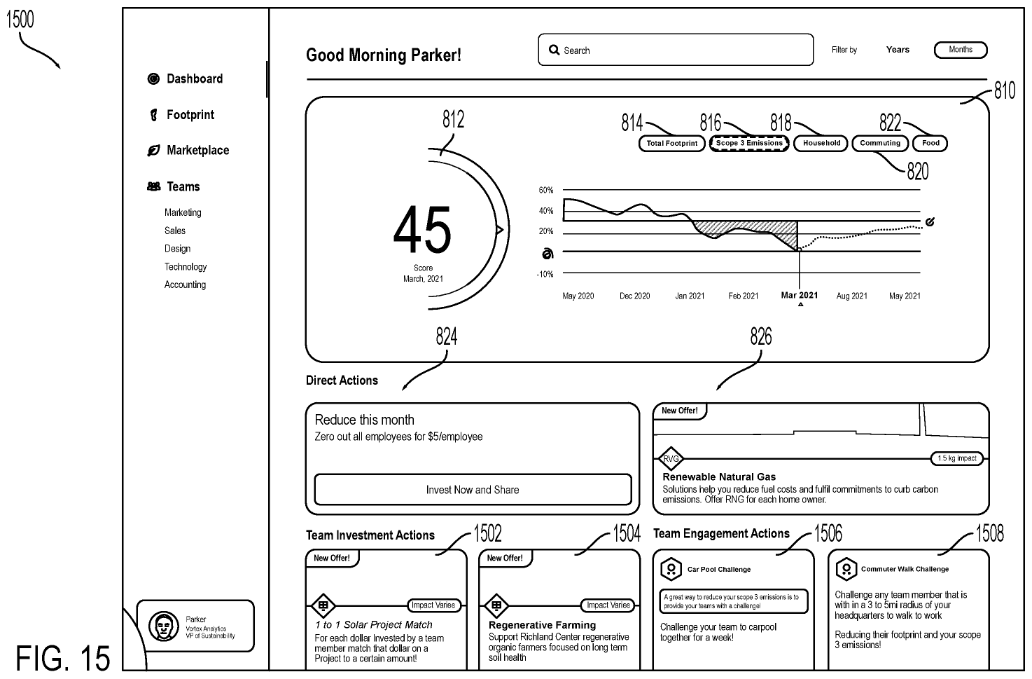

Referring now to FIG. 15, a user interface 1500 of an emissions tracking dashboard is shown, according to an exemplary embodiment. The user interface 1500 includes elements 1502-1508 providing team investment actions for improving carbon emissions for the company. The element 1502 provides a solar project match while the element 1504 provides a regenerative farming improvement. The element 1506 provides a car pool challenge where users of the company can car pool to work to reduce their carbon footprint. The element 1508 provides a commuter walk challenge where a user can walk to work to reduce carbon emissions resulting from motor vehicle transportation.

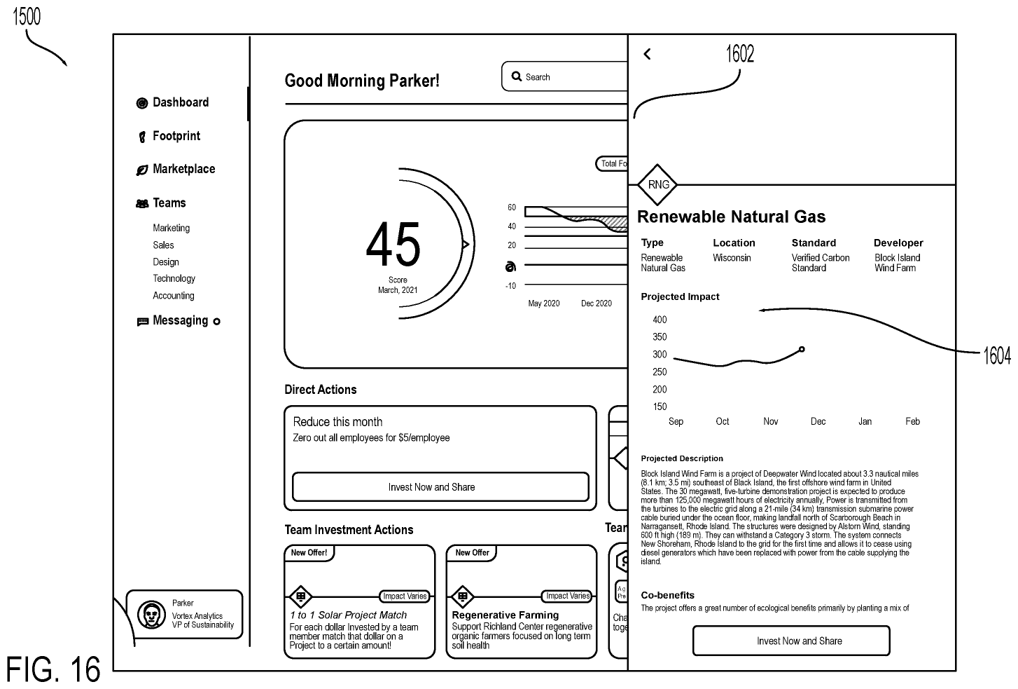

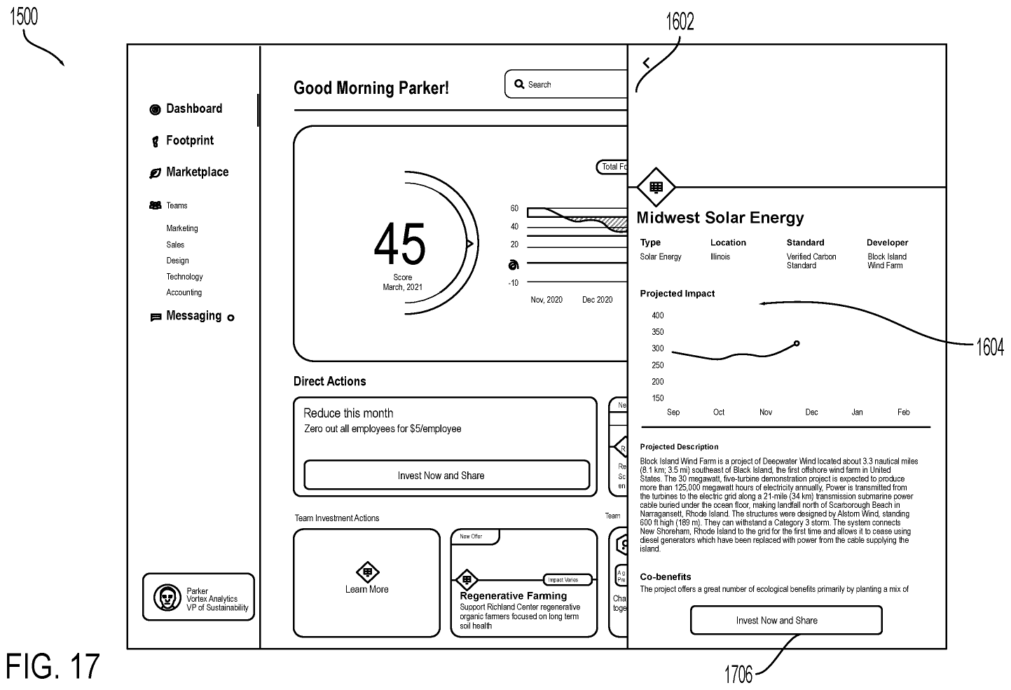

Referring now to FIG. 16, the user interface 1500 including a renewable natural gas offset element 1602 is shown, according to an exemplary embodiment. The element 1602 includes a projected impact 1604 describing the impact on carbon production that will result from the renewable natural gas investment. The element 1602 allows a user to accept and begin investing in the renewable natural gas program. FIG. 17 illustrates the interface 1500 including an element 1702 describing a solar energy program. The element 1702 includes a projected impact 1704 indicating a projected impact from investing in the solar energy program. The element 1706 allows a user to accept and begin investing in the solar energy program.

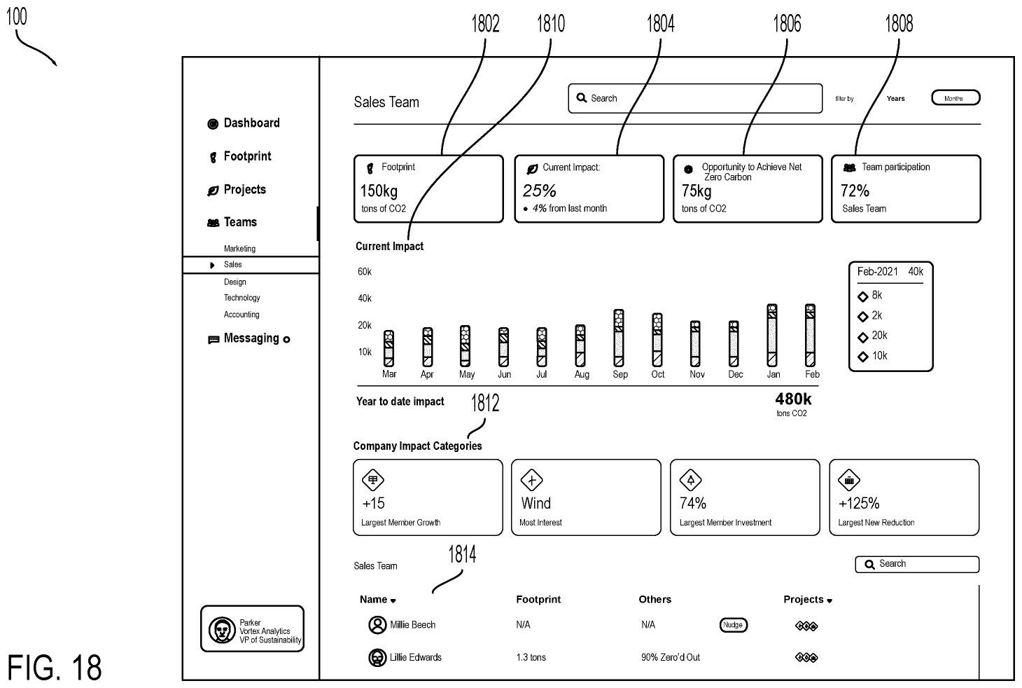

Referring now to FIG. 18, a user interface 1800 including emissions indicators for a sales team is shown, according to an exemplary embodiment. Element 1802 indicates a carbon footprint for the sales team. The element 1804 indicates a current impact for the sales team. Element 1806 indicates a carbon reduction opportunity for the sales team. Element 1808 indicates a participation rate for the sales team. Element 1810 indicates a monthly carbon impact for the team in various categories. Element 1812 indicates impact categories while element 1814 indicates team members of the sales team.

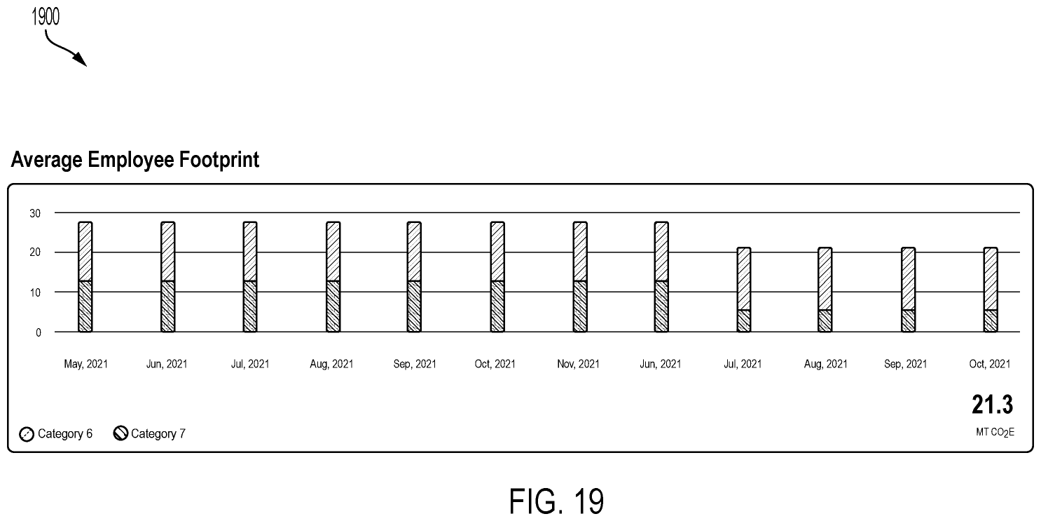

Referring now to FIG. 19, a user interface 1900 indicating an average emissions footprint for employees is shown, according to an exemplary embodiment. The element 1302 can indicate the emissions indicators 228 for various points in time, e.g., days, months, years, decades, etc. for employees of a particular company. The user interface 1900 indicates two categories of emissions, category 6 and category 7. Category 6 emissions relate to business travel while category 7 emissions relates to transportation of employees to and from work. However, any type of emissions category could be displayed in the user interface 1900. The user interface 1900 includes a bar element for each point in time. The bar element can be broken into sub-components that represent the emissions attributed to category 6 and category 7 respectively.

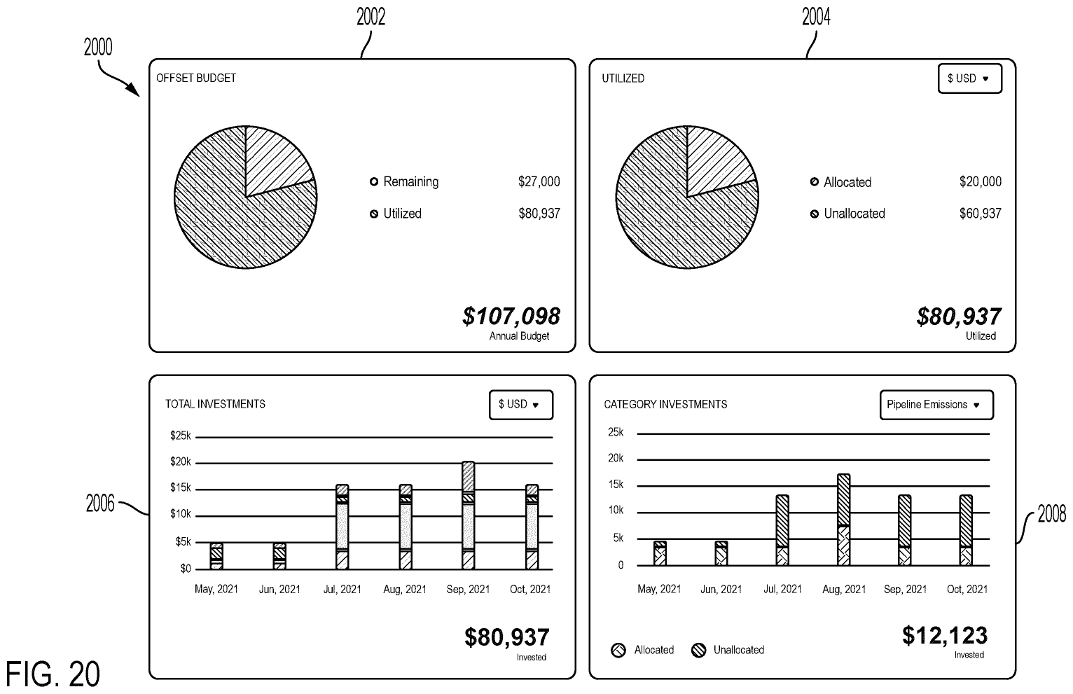

Referring now to FIG. 20, a user interface 2000 indicating budget allocations and carbon offset allocations is shown, according to an exemplary embodiment. The user interface 2000 includes an element 2002 indicating an annual budget. The element 2002 includes a pie chart representing the portion of the budget utilized for offsets and the remaining portion of the budget that has not yet been utilized. Of the utilized portion of the budget, the element 2004 of the user interface 2000 can indicate the portion of the utilized budget that is allocated (e.g., offsets that have been deployed to offset emissions of employees) and the portion of the utilized budget that is unallocated (e.g., the portion of offsets that are in a holding inventor). The element 2004 can be filtered based on currency or metric tons of carbon. The user interface 2000 includes an element 2006 indicating total investments for points in time, e.g., days, months, years, decades, etc. The investments can be shown year-to-date in the element 2006 based on a fiscal year of a company. The points in time include bars that indicate the total investment in various types of offsets. The element 2006 can be filtered based on currency or metric tons of carbon. The user interface 2000 includes an element 2008 indicating category investments indicating, for various points in time, a portion of the utilized budget that is allocated and the portion of the utilized budget that is unallocated. The element 2008 can display investments by category.

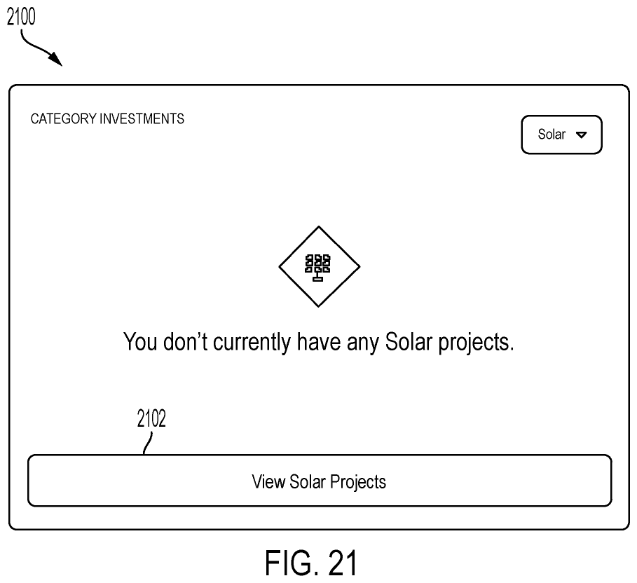

Referring now to FIG. 21, a user interface 2100 for viewing solar carbon offsets is shown, according to an exemplary embodiment. A user can be prompted with the user interface 2100 responsive to a user requesting to view category investments for solar. If there are no solar related projects, the user interface 2100 can be displayed. A user can interact with the element 2102, via the user device 118. Responsive to interacting with the element 2102, various available solar projects may be displayed via a user interface where a user can browse and/or purchase offsets.

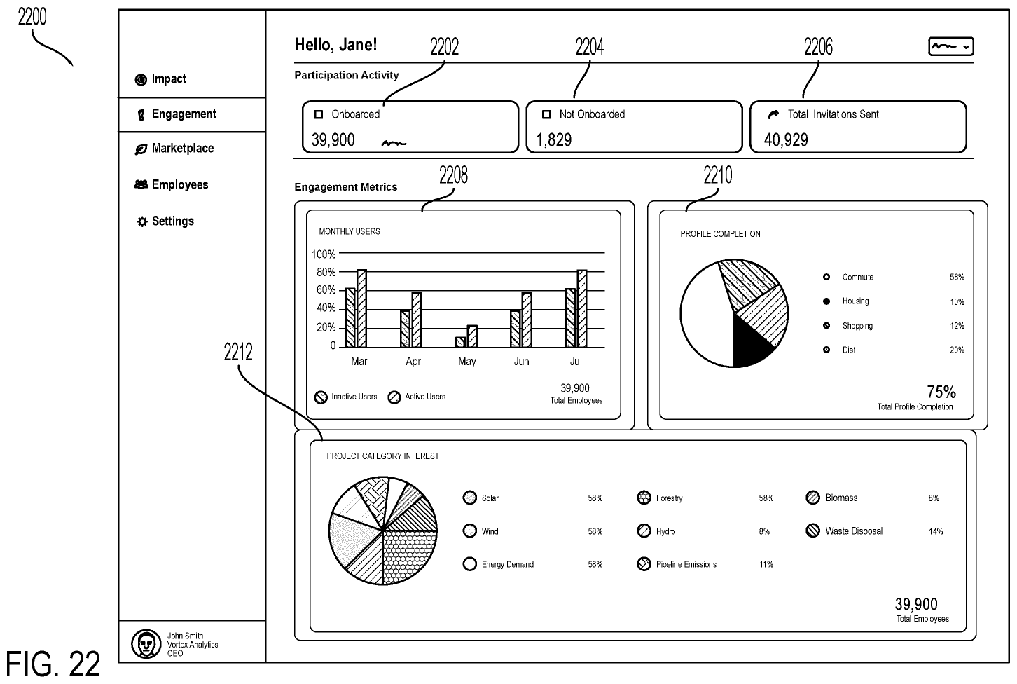

Referring now to FIG. 22, a user interface 2200 indicating emissions indicators for a user is shown, according to an exemplary embodiment. The user interface 2200 includes an element 2202 indicating a number of employees that have completed an onboarding process for the emissions system 102. The user interface 2200 includes an element 2204 indicating a number of employees that have not completed the onboarding. The user interface 2200 includes an element 2206 indicating a total number of onboarding invitations sent to employees of the company. The user interface 2200 includes an element 2208 indicating engagement metrics for monthly users. The engagement metrics indicate the number of active and inactive users for various months. The user interface 2200 includes an element 2210 that indicates levels of profile completion for the employees. The element 2210 breaks down the profile into categories, e.g. commuting, housing, shopping diet, and indicates a percentage level that the employees have completed each category. The element 2212 indicates the interest that the employees have expressed in different categories of carbon offset. The categories can include solar, wind, energy demand, forestry, hydro, pipeline emissions, biomass, and waste disposal.

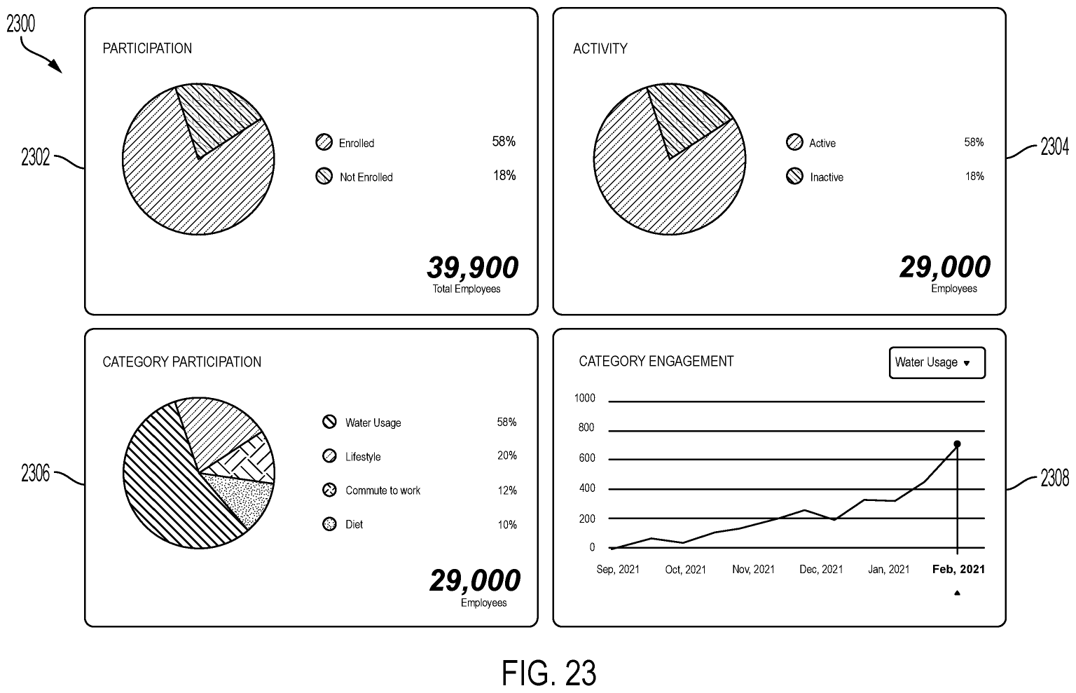

Referring now to FIG. 23, a user interface 2300 indicating enrollment and engagement of users is shown, according to an exemplary embodiment. The user interface 2300 includes an element 2302 indicating the number of employees of a company that are enrolled in the emissions system 102. The user interface 2300 includes an element 2304 that indicates percentages of employees that are active and inactive. The user interface 2300 includes an element 2306 that indicates category participation. The user interface 2300 includes an element 2308 that indicates a trend of category engagement over time for a user selected category.

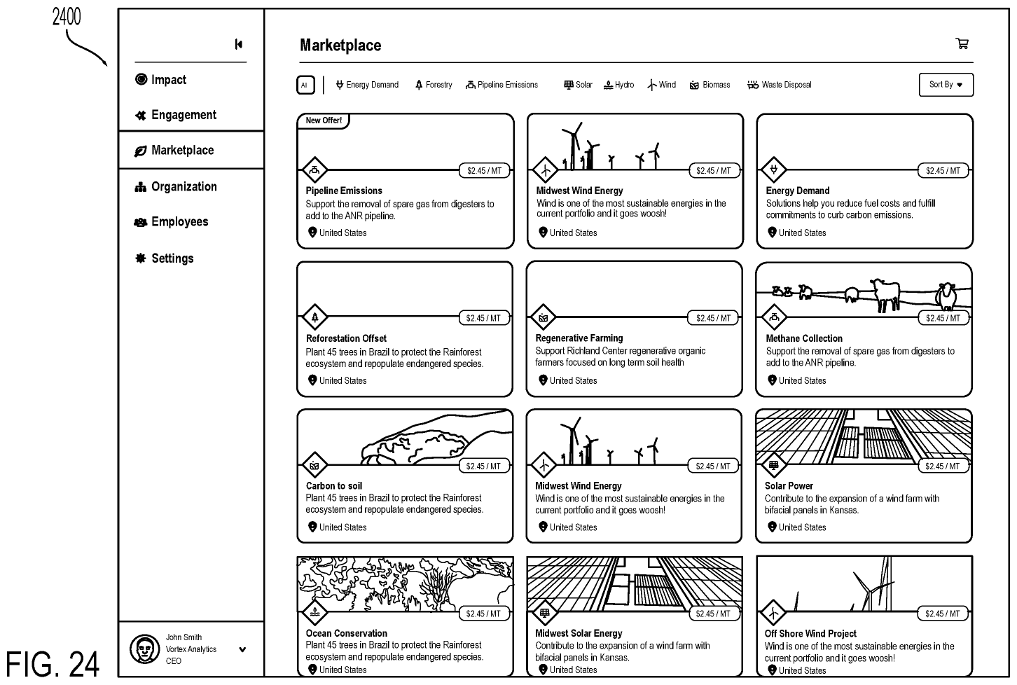

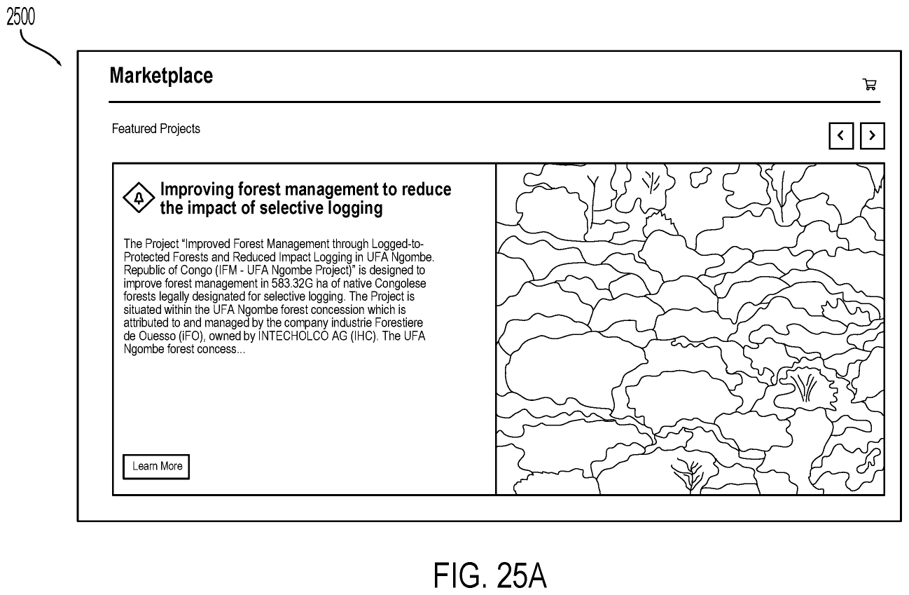

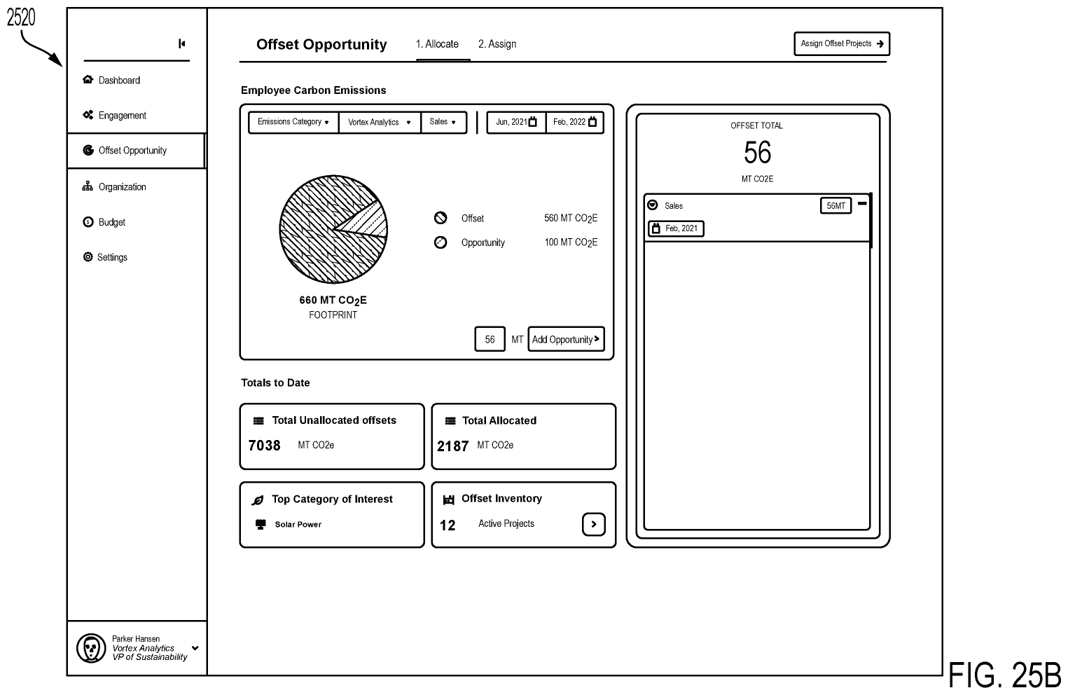

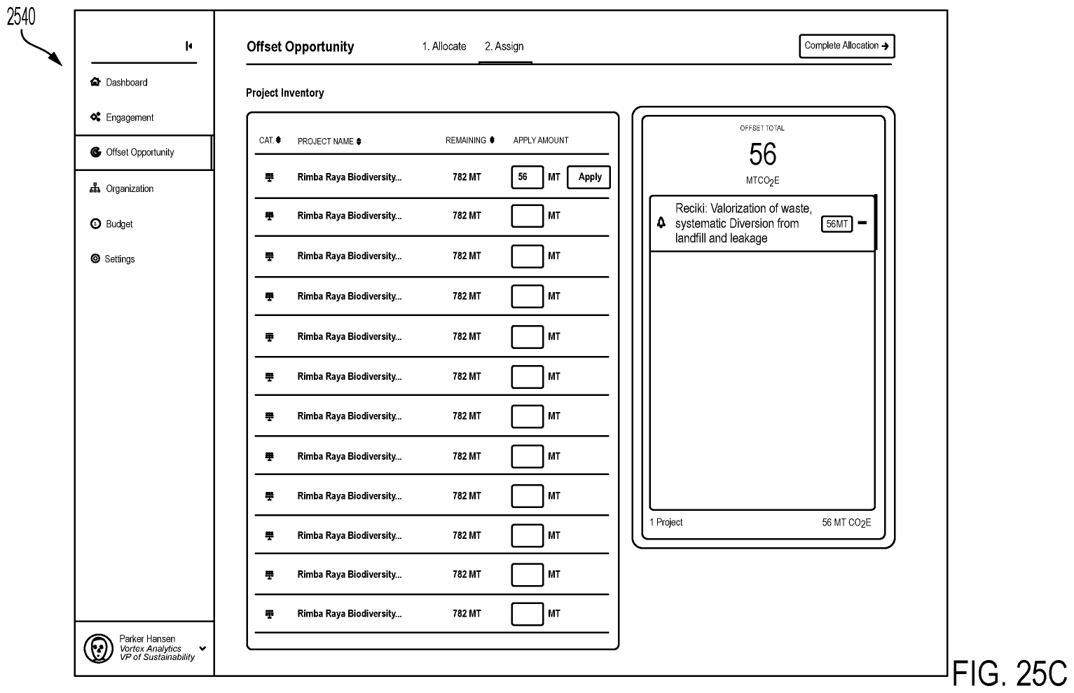

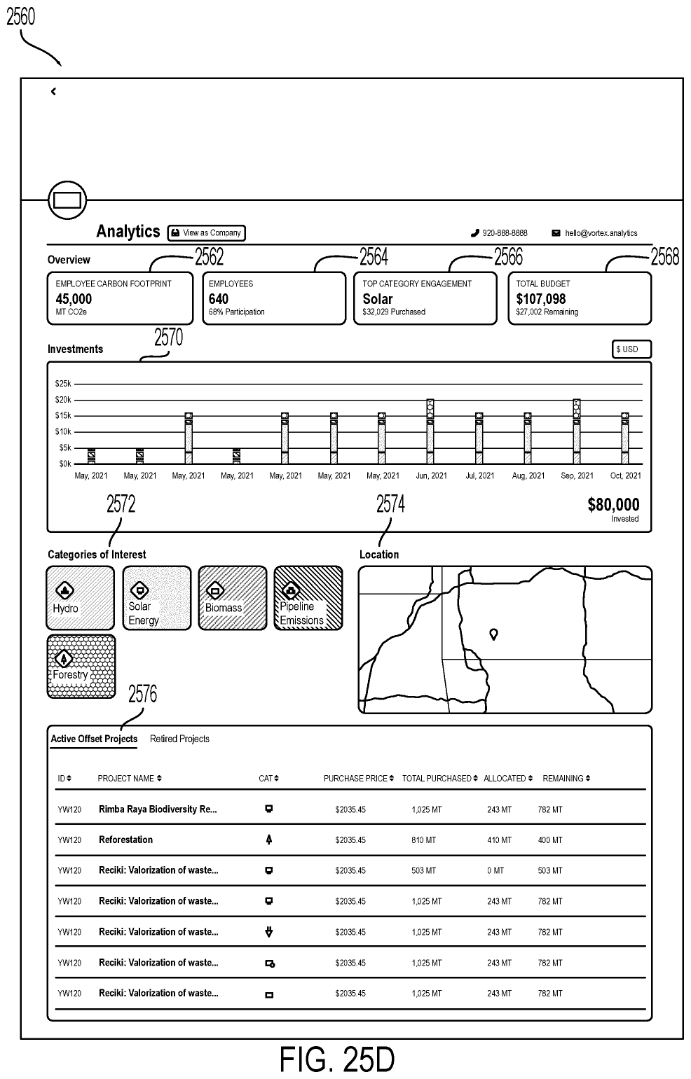

Referring now to FIG. 24, a user interface 2400 of a marketplace interface where offsets and projects can be reviewed for reducing emissions production is shown, according to an exemplary embodiment. The user interface 2400 includes lists of all projects that the company could participate in. The interface 2400 includes projects such as methane collection, wind energy, renewable natural gas, reforestation offset, regenerative farming, solar energy, off shore wind, etc. The user interface 2400 could include the user interface 2500 of FIG. 25A. The user interface 2500 can indicate a featured project for the interface 2400. In some embodiments, the interface 2500 is a featured project scroll in another user interface that highlights new projects available. In some embodiments, a user can toggle to view some of all categories of offsets available.

Referring now to FIGS. 25B-25C, user interfaces 2520-2540 are shown for allocating offsets, according to an exemplary embodiment. Via the user interfaces 2520-2540, a user can purchase offsets through and then allocate those offsets to specific carbon emissions. For example, the offsets could be allocated to offset their business travel expenses for a particular month, offset the footprint of one or more employees for the past year, etc. The user can select the carbon emission from a source, (e.g. business travel, commuting, personal travel, residential heating, etc.), the timeframe in which the emission was generated (e.g. month, quarter, year) and then either a numeric value or % of the total for that time period can be offset using the inventory of offsets that have been purchased.

Referring now to FIG. 25D, a user interface 2560 including emissions indicators for a company is shown, according to an exemplary embodiment. The user interface 2560 includes an element 2562 indicating employee carbon footprint for the company. The element 2564 indicates a total number of employees for the company. The user interface 2560 indicates a top category of engagement in element 2566. A total budget of the company for purchasing carbon offsets is shown in element 2568. The user interface 2560 includes an element 2570 indicating investments of the company for various months plotted over time. The user interface 2500 includes an element 2572 indicating categories of interest. The categories of interest can be categories that the employees of the company are interested in purchasing carbon offsets in. The user interface 2500 includes an element 2574 including a geographic map and a location of a building of the company on the map. The user interface 2500 further includes a list of active offset projects in element 2576. A user can further view retired projects in the user interface 2500, e.g., offset projects that the company was previously participating in.

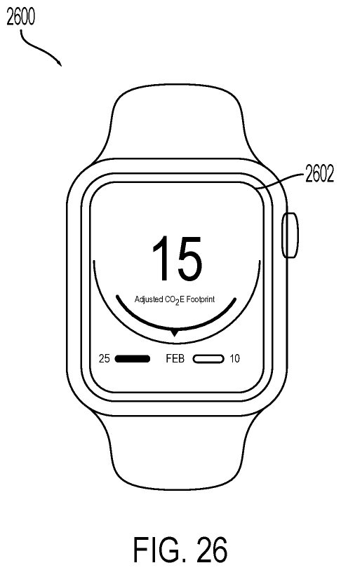

Referring now to FIG. 26, a schematic diagram of a wearable device 2600 displaying an emissions tracking interface is shown, according to an exemplary embodiment. The wearable 2600 may, in some embodiments, be the wearable device 114 of FIG. 1. In FIG. 11, the device 1100 displays an interface 2602. The interface 2602 can display a carbon footprint for a wearer of the wearable device 1100 for a particular day and/or time period. In this regard, as the user makes decisions, e.g., drives a car, orders meat, etc. and the decisions are provided to the emissions system 102, the score of the wearable device 2600 can update.

Referring now to FIG. 27, a flow diagram of a process 2700 of collecting high-level entity data 206 for multiple categories for a corpus or group of entities is shown, according to an exemplary embodiment. The emissions system 102 can be configured to perform the process 2700. For example, the process 2700 can be performed by components of the emissions system 102. For example, user emissions questionnaire service 110 of the emissions system 102 can be configured to perform the process 300. Furthermore, any computing system described herein can be configured to perform the process 300.

In step 2702, the process 2700 can include beginning onboarding for a user. The service 110 can receive a command to start the onboarding from the user device 118. A user, via the user device 118, could open an application on the user device 118 for a first time causing the process 2700 to be executed. The user could select a start element displayed on the user device 118 to start the process 2700.

In step 2704, the process 2700 can include generating data that causes the user device 118 to display an element asking the user if they work primarily remotely. Responsive to the user selecting yes, the indication of the user working primarily remotely can be saved as the high-level entity data 206 for the user and the process can proceed to step 2710. Responsive to the user responding no via the user device 118, the process can proceed to step 2706.

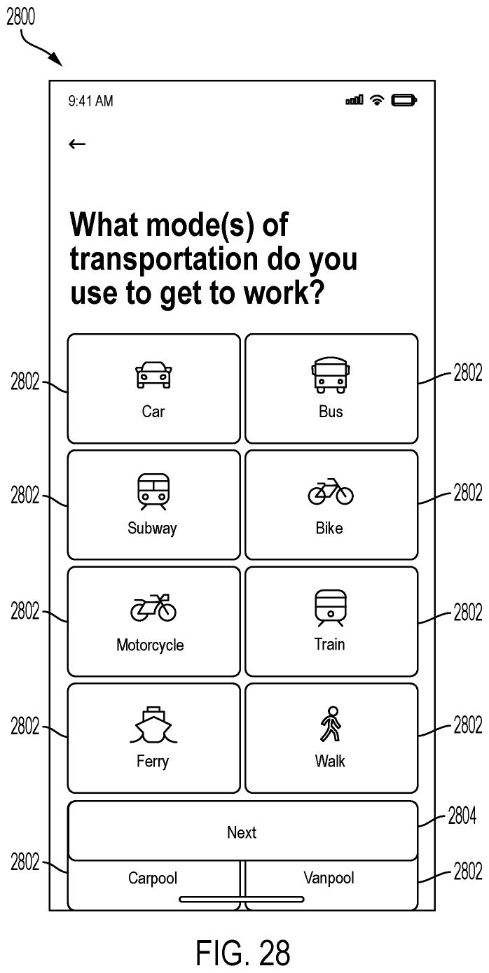

In step 2706, the process 2700 can include generating data that causes the user device 118 to display an element prompting a user to select the modes of transportation that the user uses to commute to work. The user may be presented with options 2708 on the user device 118. The options 2708 can include a car, bus, subway, bike, motorcycle, train, ferry, walk, carpool, vanpool, etc. The service 110 can save the selections of modes of transportation as the high-level entity data 206 for the user. In some embodiments, the service 110 can cause the user device 118 to display the user interface 2800 of FIG. 28. The user interface 2800 includes elements 2802 that allow a user to select one or multiple modes of transportation of the options 2708. A user can interact with element 2804 of the user interface 2800 to confirm the selection made by the user.

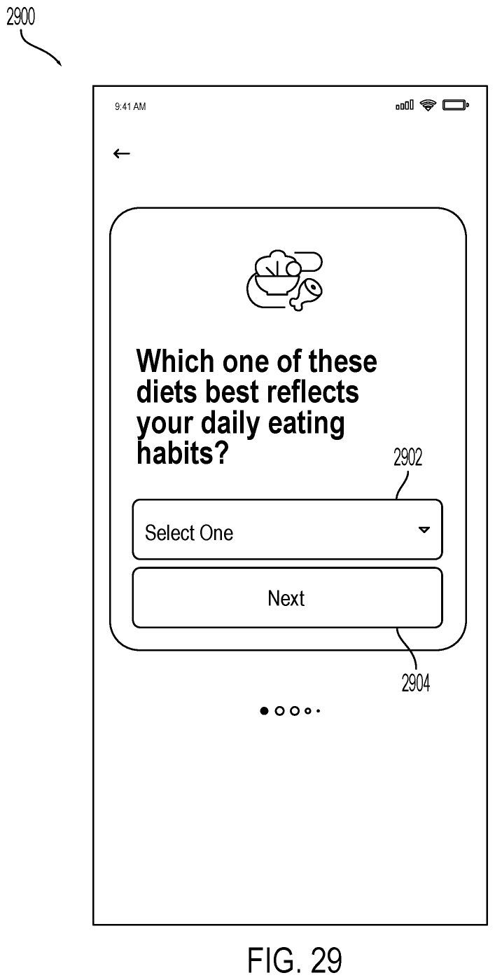

In step 2710, the process 2700 can include generating data that causes the user device 118 to display an element prompting a user to select a diet that best reflects the daily eating habits of the user. The user may be presented with options 2718 on the user device 118. The options 2718 can include a vegan diet, a vegetarian diet, a pescatarian diet, an omnivore diet, and mostly meat diet, etc. In some embodiments, the service 110 can cause the user device 118 to display the user interface 2900 of FIG. 29. The user interface 2900 can include an element 2902 allowing a user to select between the options 2718.

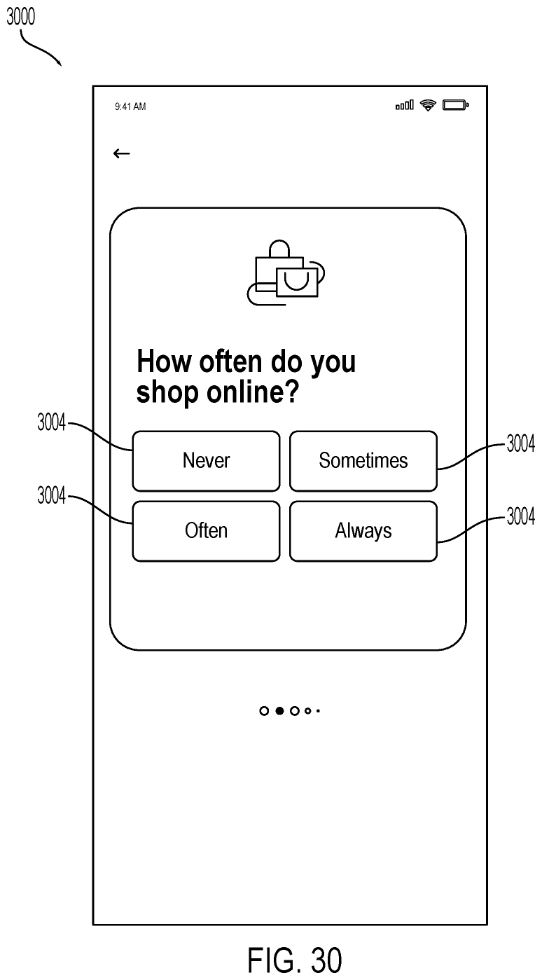

In step 2712, the process 2700 can include generating data that causes the user device 118 to display an element prompting a user to select an indication of how frequently they shop online. The user can be presented with options on the user device 118 to indicate their shopping habits. The shopping habits could indicate that the user never shops online, sometimes shops online, often shops online, or always shops online. In some embodiments, the service 110 can cause the user device 118 to display the user interface 3000 of FIG. 30. The user interface 3000 can include elements 3004 allowing a user to select between the various shopping habits.

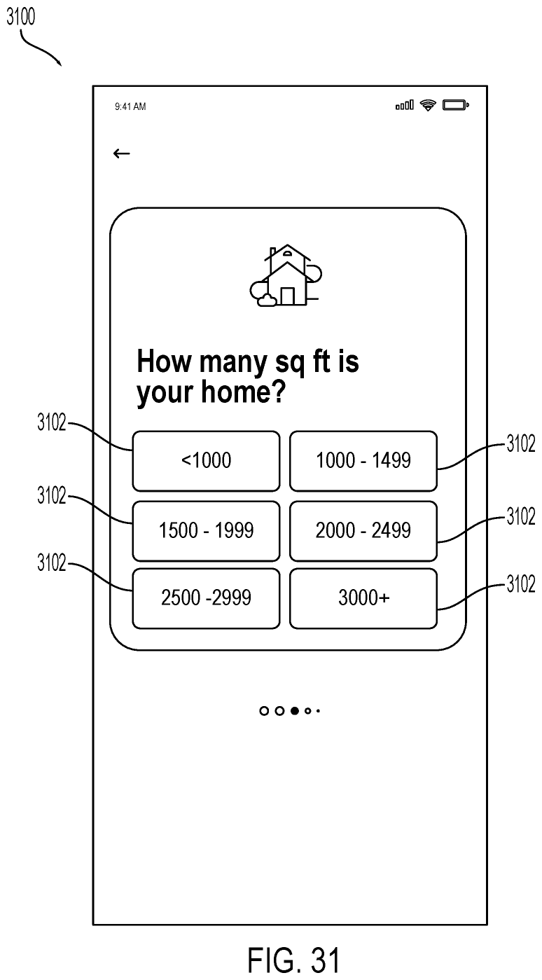

In step 2714, the process 2700 can include generating data that causes the user device 118 to display an element prompting a user to indicate how many square feet their home is. The user can be presented with options on the user device 118 to select the square footage of their home. For example, the user device can display the user interface 3100 of FIG. 31 which includes elements 3102 indicating various ranges of square footages. The ranges could be less than 1,000 square feet, 1,000-1,499 square feet, 1,500-1,999 square feet, 2,000-2,499 square feet, 2,500-2,999 square feet, 3,000 or more square feet.

In some embodiments, the user can be presented with options on the user device 118 to select or provide an input regarding one or more of the following prompts: “how many days per week do you typically work from home?”, “how many hours do you work on a typical work from home day?”, “how many desktop computers do you use?”, “how many laptops do you use?”, and/or “how many external monitors do you use?”. In some embodiments, a user may provide a numerical input, select a numerical input, or otherwise provide a quantity, quantifier, and/or qualifier regarding one or more of the aforementioned example prompts. For example, energy consumption for at-home workers may be calculated by determining the total kWh consumed by, for example, workstation electronic appliances, additional lighting usage, and additional home heating and cooling. The user can be presented with options to select or provide an input regarding measures relating to energy consumption for at-home workers may be calculated by determining the total kWh consumed by, for example, workstation electronic appliances, additional lighting usage, and additional home heating and cooling.

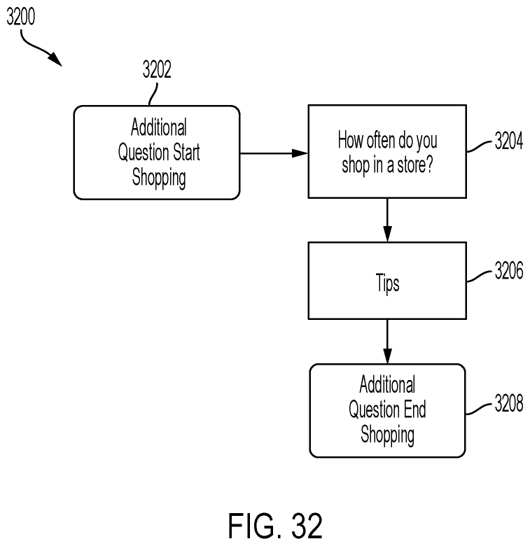

Referring now to FIG. 32, a process 3200 of collecting high-level data for a shopping category for a corpus or group of entities is shown, according to an exemplary embodiment. The emissions system 102 can be configured to perform the process 3200. For example, the process 3200 can be performed by components of the emissions system 102. For example, user emissions questionnaire service 110 of the emissions system 102 can be configured to perform the process 3200. Furthermore, any computing system described herein can be configured to perform the process 3200.

In step 3202, the process 3200 can include beginning a questionnaire for shopping. The service 110 can receive a command to start the questions from the user device 118. A user, via the user device 118, could open an application on the user device 118 for a first time causing the process 3200 to be executed. The user could select a start element displayed on the user device 118 to start the process 3200.

In step 3204, the process 3200 can include generating data that causes the user device 118 to display an element prompting a user to indicate how often they shop at a store. A user, via the user device 118, can indicate a frequency at which they shop at a store, e.g., never, regularly, all the time, etc. In step 3206, the process 3200 can include generating data the causes the user device 118 to display tips for reducing their carbon emissions from shopping. In step 3208, the process 3200 can end.

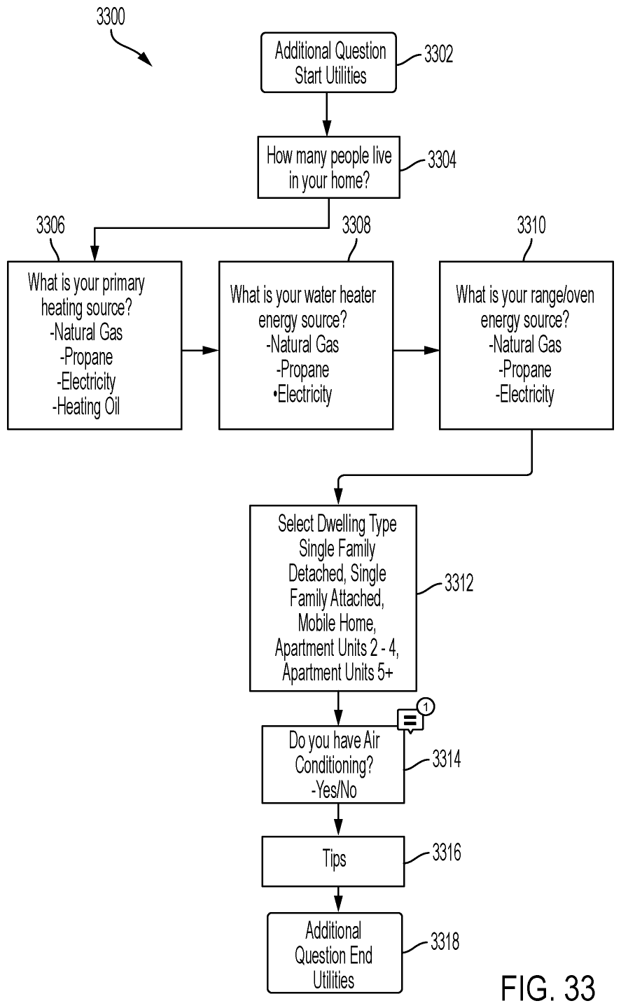

Referring now to FIG. 33, a process 3300 of collecting high-level data for a home category for a corpus or group of entities is shown, according to an exemplary embodiment. The emissions system 102 can be configured to perform the process 3300. For example, the process 3300 can be performed by components of the emissions system 102. For example, user emissions questionnaire service 110 of the emissions system 102 can be configured to perform the process 3300. Furthermore, any computing system described herein can be configured to perform the process 3300.

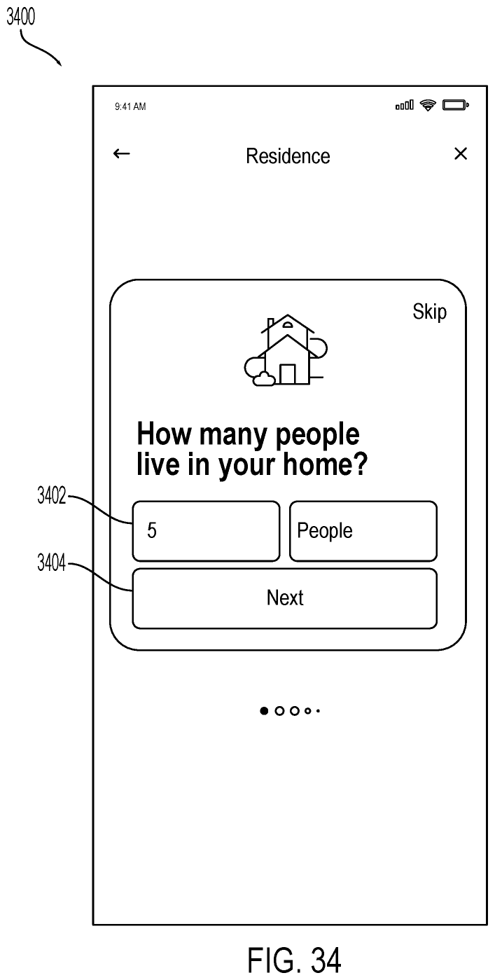

In step 3302, the process 3300 can include beginning a questionnaire regarding utilities of a residence. In step 3304, the process 3300 can include generating data that causes the user device 118 to display an element prompting a user to indicate how many people live in their home. For example, the data could cause the user device 118 to display the user interface 3400 of FIG. 34. The user interface 3400 includes an element 3402 allowing a user to enter the number of people that live at the residence. The user interface 3400 includes an element 3404 to confirm the number entered in the element 3402.

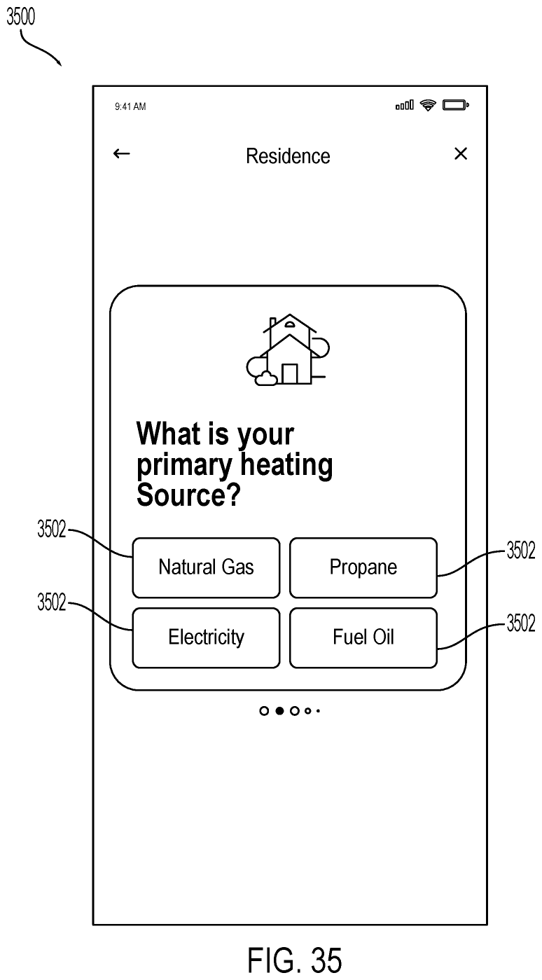

In step 3306, the process 3300 can include generating data that causes the user device 118 to display an element prompting a user to indicate a primary heating source for their home. For example, the data could cause the user device 118 to display the user interface 3500 of FIG. 35. The user interface 3500 includes elements 3502 that allow a user to indicate the heating source for their home. A user can select between a natural gas option, a propane option, an electricity option, a fuel oil option, etc. via the user interface 3500.

In step 3308, the process 3300 can include generating data that causes the user device 118 to display an element prompting a user to indicate a water heater energy source for the home of the user. The element can include various selectable options that a user can select from via the user device 118. The options could be natural gas, propane, electricity or various other types of fuel sources. In step 3310, the process 3300 can include generating data that causes the user device 118 to display an element prompting a user to indicate an energy source for their range or oven for the home of the user. The element can include various selectable options that a user can select from via the user device 118. The options could be natural gas, propane, electricity or various other types of fuel sources.

In step 3312, the process 3300 can include generating data that causes the user device 118 to display an element prompting a user to indicate a dwelling type for their home. The element can include various selectable options that a user can select via the user device 118. The options could be single family with a detached garage, single family an attached garage, a mobile home, an apartment of various room numbers, etc.

In step 3314, the process 3300 can include generating data that causes the user device 118 to display an element prompting a user to indicate whether their home includes air conditioning. In some embodiments, the user device 118 can display an interface with elements allowing a user to confirm whether or not that residence of the user includes air conditioning.

In step 3316, the process 3300 can include generating data that causes the user device 118 to display an element providing tips for reducing carbon emissions. The tips can be recommendations for reducing the energy consumption for heating, cooling, or otherwise expending energy in the home of the user. The tips could be recommended heating or cooling setpoints that conserve energy and reduce carbon emissions. The recommendations could be suggestions to open windows or doors on hot days instead of running air conditioning. The recommendations could be suggestions to keep lights off in unused rooms or areas of a home to reduce electricity consumption. In step 3318, the process 3300 can include ending the questionnaire. For example, a conclusion or summary could be displayed on the user device 118 summarizing the answers provided by the user in the process 3300 or summarizing predicted carbon emissions associated with the user based on the answers provided by the user.

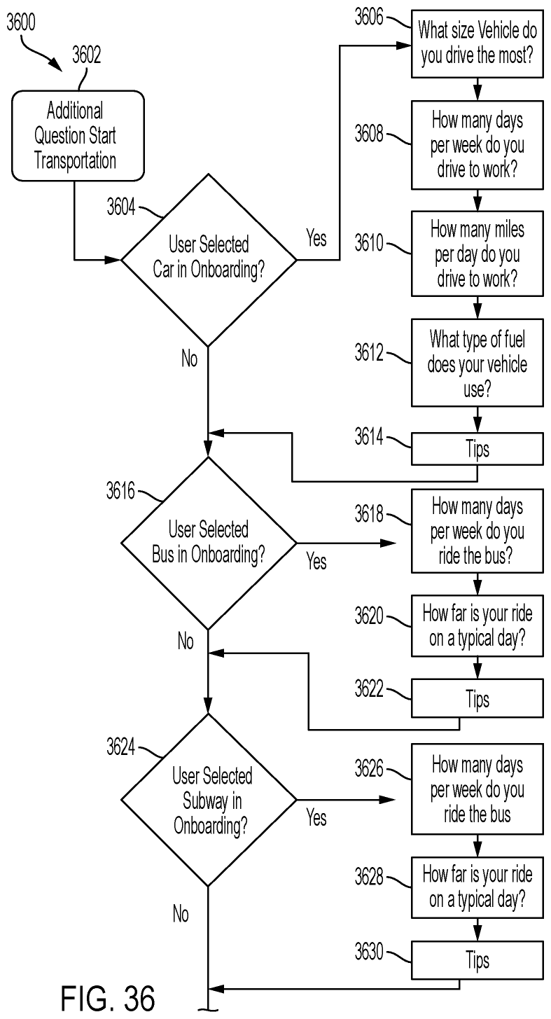

Referring now to FIGS. 36-38, a flow diagram of a process 3600 of collecting high-level entity data 206 for a transportation category for a corpus or group of entities is shown, according to an exemplary embodiment. The emissions system 102 can be configured to perform the process 3600. For example, the process 3600 can be performed by components of the emissions system 102. For example, user emissions questionnaire service 110 of the emissions system 102 can be configured to perform the process 3600. Furthermore, any computing system described herein can be configured to perform the process 3600.

In step 3602, the process 3600 can include beginning a questionnaire regarding transportation. In step 3604, the process 3600 can include determining whether a user selected a car as their transportation mode. The service 110 can determine whether the user selected the car via an element 2802 of the user interface 2800 of FIG. 28. Responsive to determining that the user selected the car, the process 3600 can proceed to steps 3606-3614. Responsive to determining that the user did not select the car, the process 3600 can proceed to step 3616.

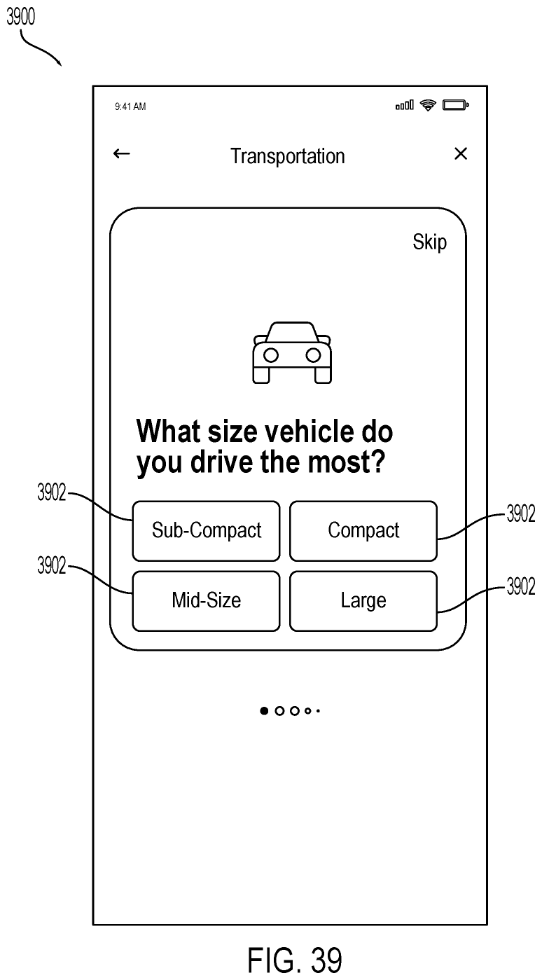

In step 3606, the process 3600 can include generating data that causes the user device 118 to display an element prompting the user to indicate the size of the vehicle that they drive. For example, the element can prompt the user to indicate the size of the vehicle that they drive most frequently to work. In some embodiments, the service 110 can cause the user device 118 to display the user interface 3900 of FIG. 39. The user interface 3900 can include a prompt asking a user what size vehicle they drive. The user interface 3900 can include elements 3902 that allow a user to respond to the prompt. Via the elements 3902, the user can select between various vehicle sizes. The sizes could be sub-compact, compact, mid-size, or large.

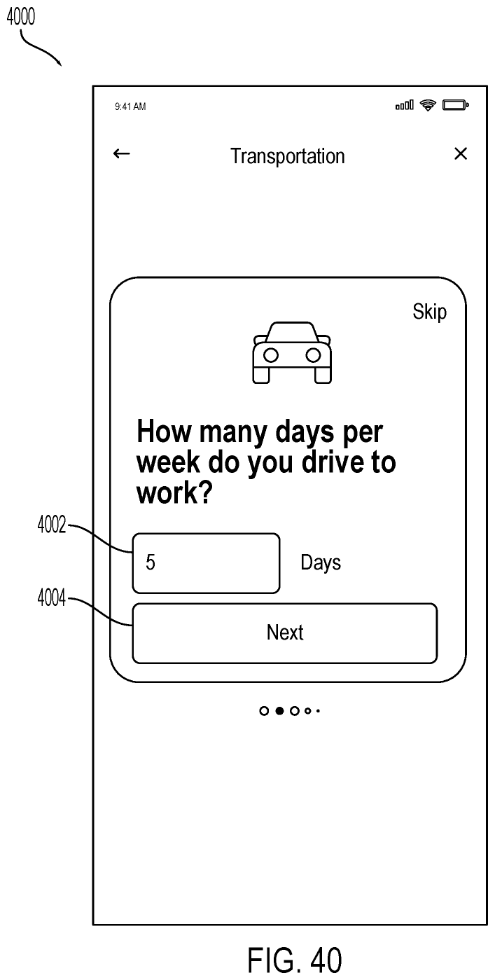

In step 3608, the process 3600 can include generating data that causes the user device 118 to display an element prompting the user to indicate how many days per week the user drives to work. For example, the element can prompt the user to indicate a number of work days that a user uses their car to drive to work. In some embodiments, the service 110 can cause the user device 118 to display the user interface 4000 of FIG. 40. The user interface 4000 can include a prompt asking a user how many days per week they drive to work. The user interface 4000 can include elements 4002 and 4004 that allow a user to respond to the prompt. Via the element 4002, the user can enter a number of days that the user drives to work. Via the element 4004, the user can confirm the input number of days and proceed to the next question.

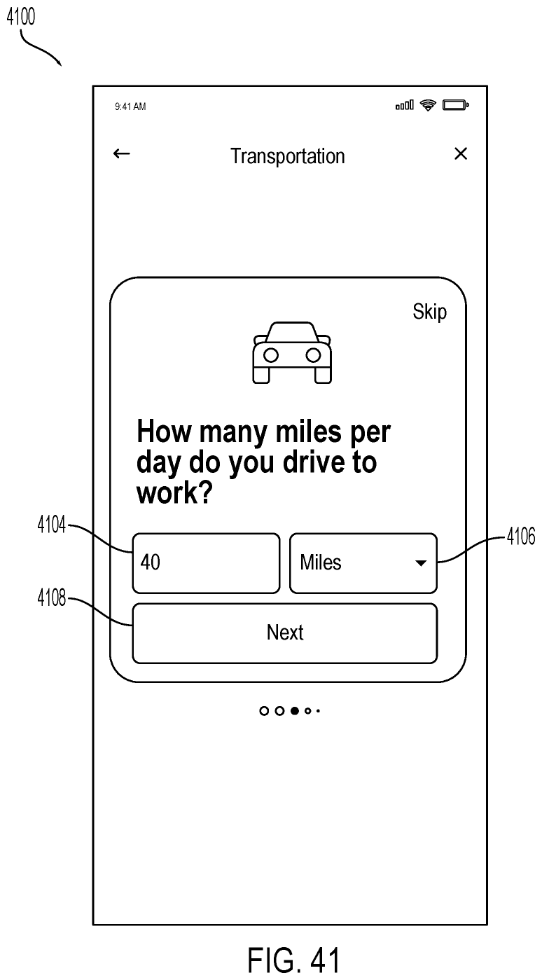

In step 3610, the process 3600 can include generating data that causes the user device 118 to display an element prompting the user to indicate how many miles it takes the user to drive to work. For example, the element can prompt the user to indicate the distance (e.g., in miles) that it takes to drive from home to work, from work to home, or for a round trip between work and home. In some embodiments, the service 110 can cause the user device 118 to display the user interface 4100 of FIG. 41. The user interface 4100 can include a prompt asking a user how many miles per day the user drives to work. The user interface 4100 can include elements 4104, 4106, and 4108 that allow a user to respond to the prompt. Via the element 4104, the user can enter the distance. Via the element 4106, the user can adjust the units input in the element 4104, e.g., switch between miles, kilometers, feet, etc. Via the element 4108, the user can confirm the input distance and proceed to the next question.

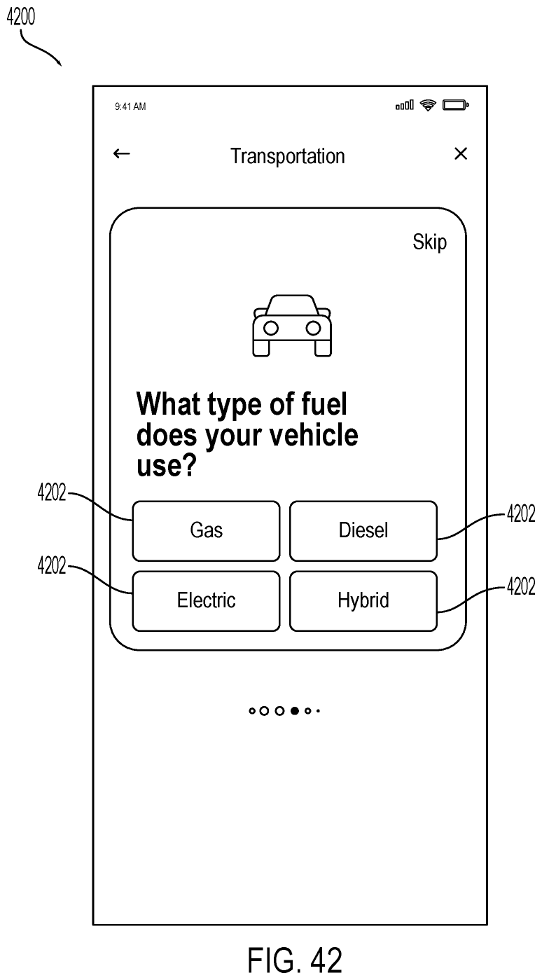

In step 3612, the process 3600 can include generating data that causes the user device 118 to display an element prompting the user to indicate what type of fuel their vehicle uses. For example, the element can prompt the user to select between different fuel types for their vehicle. In some embodiments, the service 110 can cause the user device 118 to display the user interface 4200 of FIG. 42. The user interface 4200 can include a prompt asking a user what type of fuel their vehicle uses. The user interface 4200 can include elements 4202 that allow a user to respond to the prompt. Via the elements 4202, the user can select the fuel type of their vehicle. The fuel type could be gas, diesel, electric, hybrid, hydrogen, etc. In step 3614, the process 3600 can include generating data that causes the user device 118 to display an element providing a user with tips for reducing carbon emissions from commuting in their vehicle. The tips could be car-pooling suggestions, vehicle upgrades or replacements, suggestions to work remotely, etc.

In step 3616, the process 3600 can include determining whether a user selected a bus as their transportation mode. The service 110 can determine whether the user selected the bus via an element 2802 of the user interface 2800 of FIG. 28. Responsive to determining that the user selected the bus, the process 3600 can proceed to the steps 3618-3622. Responsive to determining that the user did not select the bus, the process 3600 can proceed to step 3624.

In step 3618, the process 3600 can include generating data that causes the user device 118 to display an element prompting the user to indicate how many days per week the user rides the bus. The element can prompt the user to indicate the number of work days that the user rides the bus. The element can prompt the user to indicate the number of weekend days that the user rides the bus. In step 3620, the process 3600 can include generating data that causes the user device 118 to display an element prompting the user to indicate how far the user rides the bus on a typical day. The element can prompt the user to enter an approximate or average distance that the user rides the bus each day. The element can prompt the user to enter the distance in miles, kilometers, feet, etc. In step 3622, the process 3600 can include generating data that causes the user device 118 to display tips. The tips can be emissions reduction tips, e.g., suggestions for reducing emissions reduction. The tips can recommend bus routes, suggest alternative transportation methods such as a sub-way, a train, walking, or cycling, suggest working remotely, etc.

In step 3624, the process 3600 can include determining whether a user selected a subway as their transportation mode. The service 110 can determine whether the user selected the subway via an element 2802 of the user interface 2800 of FIG. 28. Responsive to determining that the user selected the subway, the process 3600 can proceed to the steps 3626-3630. Responsive to determining that the user did not select the subway, the process 3600 can proceed to step 3632.

In step 3626, the process 3600 can include generating data that causes the user device 118 to display an element prompting the user to indicate how many days per week the user rides the subway. In step 3628, the process 3600 can include generating data that causes the user device 118 to display an element prompting the user to indicate how far the user rides the subway on a typical day. In step 3630, the process 3600 can include generating data that causes the user device 118 to display tips for reducing carbon emissions, e.g., making suggestions to walk to work certain days of the week instead of taking the sub-way, making suggestions to work remotely, etc.

In step 3632, the process 3600 can include determining whether a user selected a bicycle as their transportation mode. The service 110 can determine whether the user selected the user via an element 2802 of the user interface 2800 of FIG. 28. Responsive to determining that the user selected the bicycle, the process 3600 can proceed to steps 3634-3638. Responsive to determining that the user did not select the bicycle, the process 3600 can proceed to step 3640. In step 3634, the process 3600 can include generating data that causes the user device 118 to display an element prompting a user to indicate how many days per week they ride their bicycle to work. In step 3636, the process 3600 can include generating data that causes the user device 118 to display an element prompting the user to indicate how far they ride a bicycle on a typical day. In step 3638, the process 3600 can include generating data that causes the user device 118 to display tips for reducing carbon emissions, e.g., making suggestions to work remotely, etc.

In step 3640, the process 3600 can include determining whether a user selected a motorcycle as their transportation mode. The service 110 can determine whether the user selected the motorcycle via an element 2802 of the user interface 2800 of FIG. 28. Responsive to determining that the user selected the motorcycle, the process can proceed to steps 3642-3646. Responsive to determining that the user did not select the motorcycle, the process can proceed to step 3648. In step 3642, the process 3600 can include generating data that causes the user device 118 to display an element prompting the user to indicate how many days per week the user rides a motorcycle to work. In step 3644, the process 3600 can include generating data that causes the user device 118 to display an element prompting the user to indicate how far they ride a motorcycle on a typical day. In step 3646, the process 3600 can include generating data that causes the user device 118 to display tips for reducing carbon emissions, e.g., walking to work, cycling to work, making suggestions to work remotely, etc.

In step 3648, the process 3600 can include determining whether a user selected a train as their transportation mode. The service 110 can determine whether the user selected the train via an element 2802 of the user interface 2800 of FIG. 28. Responsive to determining that the user selected the train, the process can proceed to steps 3650-3654. Responsive to determining that the user did not select the train, the process can proceed to step 3656. In step 3650, the process 3600 can include generating data that causes the user device 118 to display an element prompting the user to indicate how many days per week the user rides the train to work. In step 3652, the process 3600 can include generating data that causes the user device 118 to display an element prompting the user to indicate how far they ride the train to work a typical day. In step 3654, the process 3600 can include generating data that causes the user device 118 to display tips for reducing carbon emissions, e.g., making suggestions to work remotely, ride a bicycle to work, etc.

In step 3656, the process 3600 can include determining whether a user selected a ferry as their transportation mode. The service 110 can determine whether the user selected the ferry via an element 2802 of the user interface 2800 of FIG. 28. Responsive to determining that the user selected the ferry, the process can proceed to steps 3658-3662. Responsive to determining that the user did not select the ferry, the process can proceed to step 3664. In step 3658, the process 3600 can include generating data that causes the user device 118 to display an element prompting the user to indicate how many days per week the user takes the ferry to work. In step 3660, the process 3600 can include generating data that causes the user device 118 to display an element prompting the user to indicate how they ride the ferry on a typical day. In step 3662, the process 3600 can include generating data that causes the user device 118 to display tips for reducing carbon emissions, e.g., making suggestions to work remotely, etc.

In step 3664, the process 3600 can include determining whether a user selected a walking as their transportation mode. The service 110 can determine whether the user selected walking via an element 2802 of the user interface 2800 of FIG. 28. Responsive to determining that the user selected walking, the process can proceed to steps 3666-3670. Responsive to determining that the user did not select walking, the process can proceed to step 3672. In step 3666, the process 3600 can include generating data that causes the user device 118 to display an element prompting the user to indicate how many days per week the user walks to work. In step 3668, the process 3600 can include generating data that causes the user device 118 to display an element prompting the user to indicate far they walk to work on a typical day. In step 3670, the process 3600 can include generating data that causes the user device 118 to display tips for reducing carbon emissions, e.g., making suggestions to work remotely, etc.

In step 3672, the process 3600 can include determining whether a user selected carpooling as their transportation mode. The service 110 can determine whether the user selected carpooling via an element 2802 of the user interface 2800 of FIG. 28. Responsive to determining that the user selected carpooling, the process can proceed to steps 3674-3680. Responsive to determining that the user did not select carpooling, the process can proceed to step 3682. In step 3674, the process 3600 can include generating data that causes the user device 118 to display an element prompting the user to indicate how many days per week the user carpools to work. In step 3676, the process 3600 can include generating data that causes the user device 118 to display an element prompting the user to indicate how far they carpool to work on a typical day. In step 3678, the process 3600 can include generating data that causes the user device 118 to display an element prompting the user to indicate how many other individual the user carpools with. In step 3680, the process 3600 can include generating data that causes the user device 118 to display tips for reducing carbon emissions, e.g., making suggestions to work remotely, etc. In some embodiments, the service 110 determine whether a user selected ferry travel, and whether the user indicated that they bring a car on the ferry, the frequency they use a ferry, the distance they ride the ferry, whether they take their transportation device on the ferry. In some embodiments, responsive to a determination that the user indicated that they bring a car on the ferry, the service 110 may determine whether the ferry is propelled along a route via a biodiesel system, electric system, gasoline system, coal system, steam system, diesel tugboat, cable system, etc.

In some embodiments, a user may selectively modify or adjust the determination made by the service 110. For example, the service 110 may determine a transportation type, diet type, etc., based on the data, and a user may temporarily or permanently adjust the value to reflect a temporary or permanent adjustment in the behavior corresponding to the determination made by the service 110. In other words, a user may manually override one or more determinations made by the service 110.

In step 3682, the process 3600 can include determining whether a user selected vanpooling as their transportation mode. The service 110 can determine whether the user selected the vanpooling via an element 2802 of the user interface 2800 of FIG. 28. Responsive to determining that the user selected vanpooling, the process can proceed to steps 3684-3690. Responsive to determining that the user did not select the vanpooling, the process can proceed to step 3692. In step 3684, the process 3600 can include generating data that causes the user device 118 to display an element prompting the user to indicate how many days per week the user vanpools to work. In step 3686, the process 3600 can include generating data that causes the user device 118 to display an element prompting the user to indicate how far they vanpool to work on a typical day. In step 3688, the process 3600 can include generating data that causes the user device 118 to display an element prompting the user to indicate how many other individual the user vanpools with. In step 3690, the process 3600 can include generating data that causes the user device 118 to display tips for reducing carbon emissions, e.g., making suggestions to work remotely, etc.

In step 3692, the process 3600 can include generating data that causes the user device 118 to display tips for reducing carbon emissions. For example, the tips can be an aggregation of tips of the steps 3614, 3622, 3630, and 3638. The tips displayed via the user device 118 can be suggestions to switch from one selected mode of transportation to another, e.g., from driving a car to car-pooling, from riding a motorcycle to riding a bicycle, etc. In step 3694, the process 3600 can end.

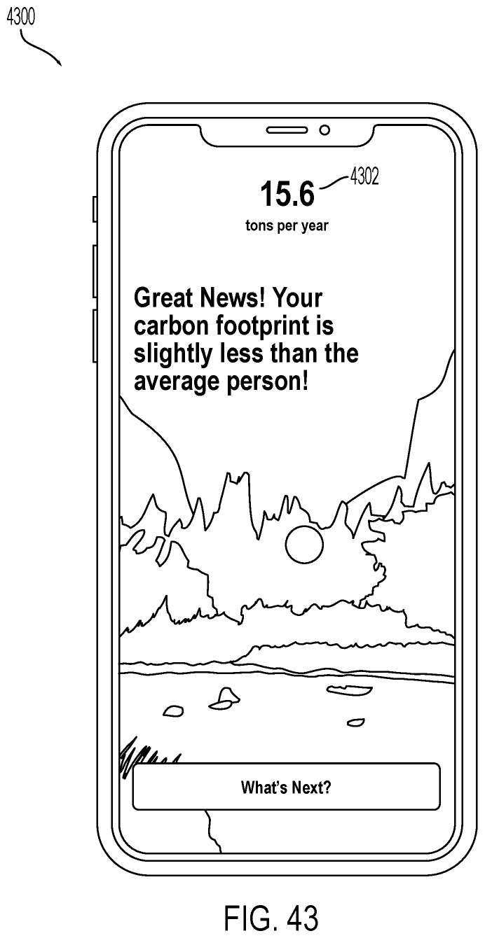

Referring now to FIG. 43, a user interface 4300 of the providing a user with their carbon footprint is shown, according to an exemplary embodiment. The user interface 4300 includes a graphic representation 4302 of the emissions indicators 228 for a user. The user interface 4300 can be displayed via the user device 118 responsive to a user completing a questionnaire. The user interface 4300 can provide the user with an indication of their carbon emissions in tons per year. In some embodiments, the emissions system 102 can compare the carbon emissions in tons per year to an average. The average can indicate average carbon emissions for an individual. The user interface 4300 can include the result of the comparing. For example, the user interface 4300 could indicate that the emissions of the user is higher than the average, that the emissions of the user is lower than the average, that the emissions is approximately the same as the average.

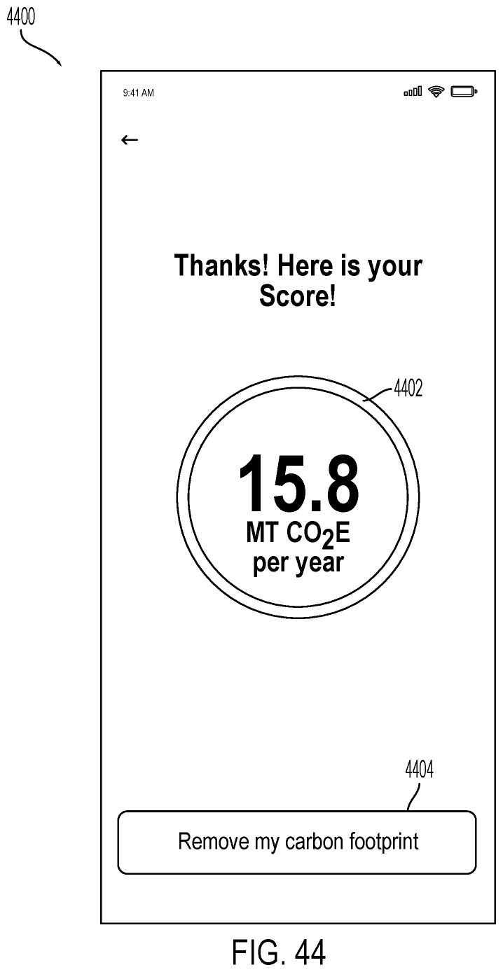

Referring now to FIG. 44, a user interface 4400 providing a user with their carbon footprint is shown, according to an exemplary embodiment. The user interface 4400 includes a graphic representation 4402 of the emissions indicators 228 for a user. The user interface 4300 can provide the user with an indication of their carbon emissions in tons per year. A user can interact with element 4404 to view recommendations for reducing their carbon emissions.

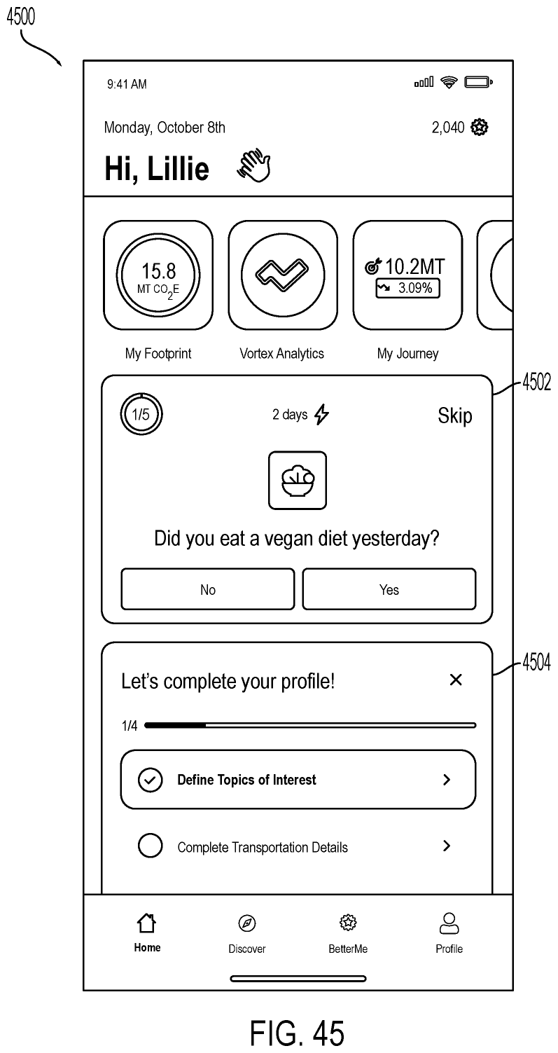

Referring now to FIG. 45, a user interface 4500 prompting a user to provide input for a habit is shown, according to an exemplary embodiment. The user interface 4500 can be a home screen of a mobile application for a user. The user interface 4500 can include an element 4502 that includes a question. The question can prompt a user to confirm whether they followed a habit. The habit can be selected by a user for the emissions system 102 to track. The user interface 4500 further includes an element 4504 prompting the user to complete a profile. The profile can include answer questions of a questionnaire by the user emissions questionnaire service 110. The profile can include indicating topics of interest for carbon offsets.

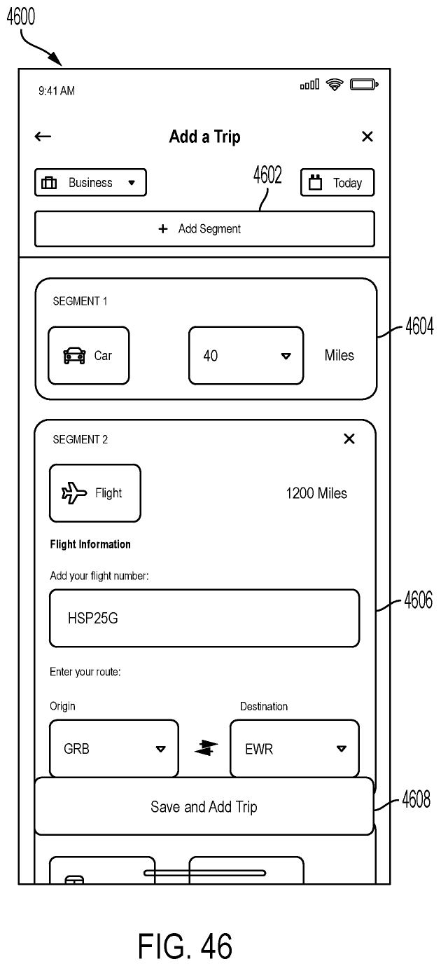

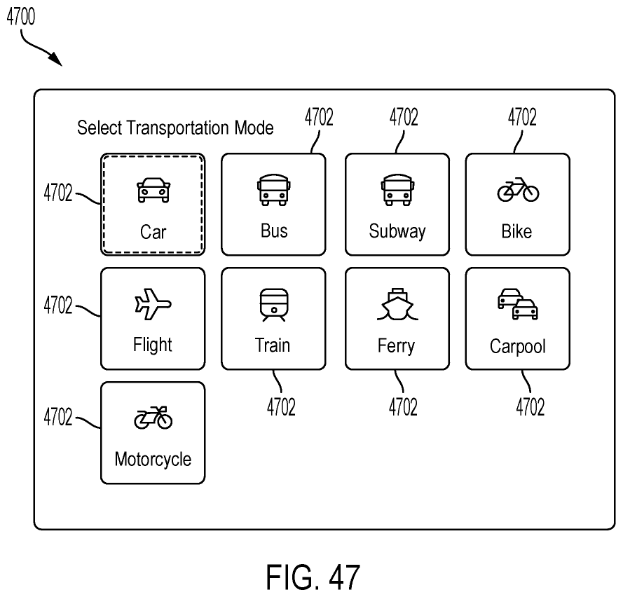

Referring now to FIG. 46, a user interface 4600 prompting a user to add a description of a trip is shown, according to an exemplary embodiment. The trip can be logged and saved in the low-level consumption data 226 by the emissions system 102. A user can interact with an element 4602 to create a segment for their route. Responsive to interacting with element 4602 one or multiple times, elements 4604 and 4606 representing different segments of a trip can be displayed. A user can indicate a vehicle for each segment via the user interface 4700 of FIG. 47. The user can select between a car, a bus, a subway, a bicycle, a flight, a train, a ferry, a carpool, or a motorcycle via elements 4702 of the user interface 4700 of FIG. 47 via elements 4702. In the element 4604, the user selected a car and the user can enter the distance that they drove in the car. In the element 4606 the user can select a flight. A user can enter a flight number of their flight and the emissions system 102 can retrieve a distance of the flight, an origin location, and a destination location. A user can interact with element 4608 to save the trip constructed in user interface 4600.

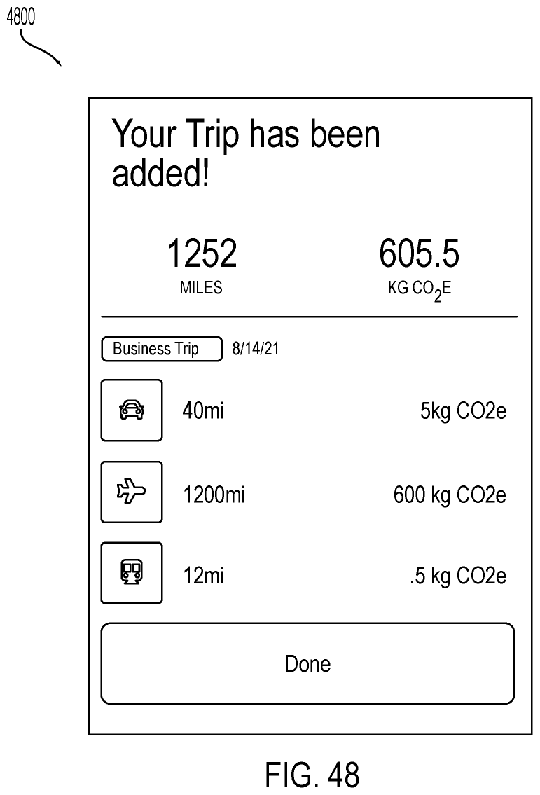

Referring now to FIG. 48 is a user interface 4800 of a summary of the trip constructed in the user interface 4700 of FIG. 46 is shown, according to an exemplary embodiment. The user interface 4800 can include a total distance traveled in the trip. The user interface 4800 can include an emissions indicator for the trip. The user interface 4800 can summarize each segment of the trip, e.g., car ride, flight, train ride, etc. and provide a distance traveled for each segment and a carbon emissions production associated with each segment.

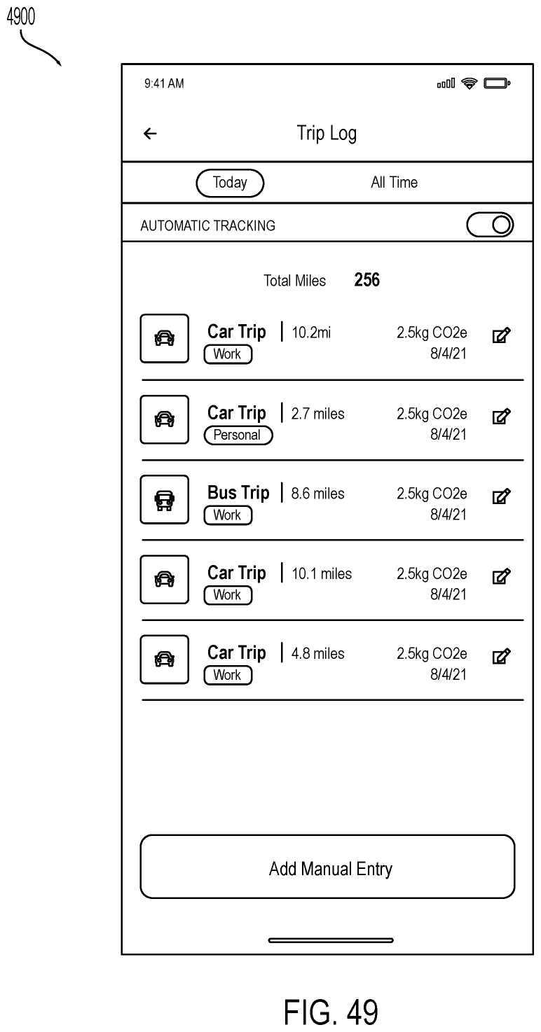

Referring now to FIG. 49, a user interface 4900 including a trip log of trips taken by the user is shown, according to an exemplary embodiment. The trip log of user interface 4900 can include all trips taken on a certain day (e.g., the day that the user is viewing the user interface 4900) or all trips recorded by the user. The user interface 4900 can allow a user to switch between viewing trips on a certain day or all trips recorded for the user. The user interface 4900 can include a total distance traveled across all of the trips. The user interface 4900 can include a representation of each trip. The representation can include a tag indicating whether the trip was a personal trip or a business trip. The representation can include a distance traveled in the trip. The representation can include an indication of the carbon emissions created by the trip.

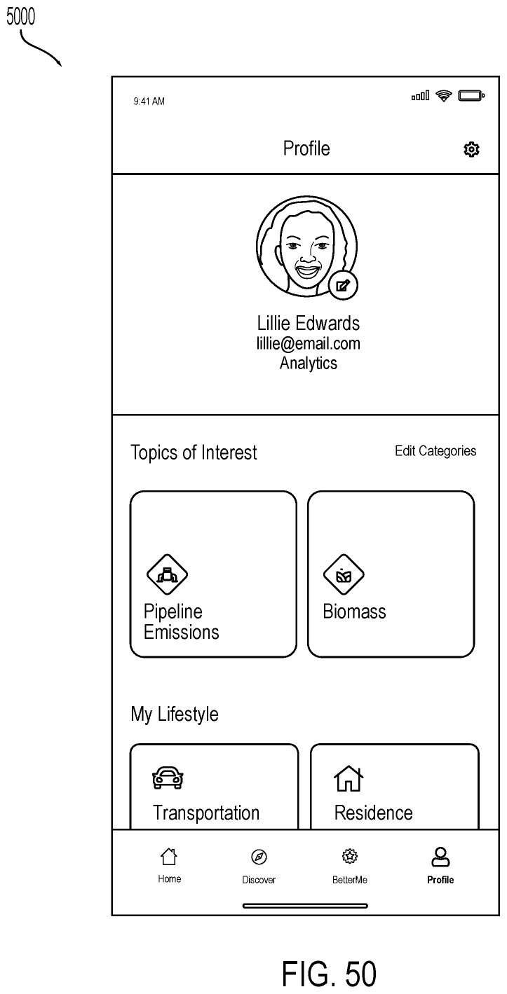

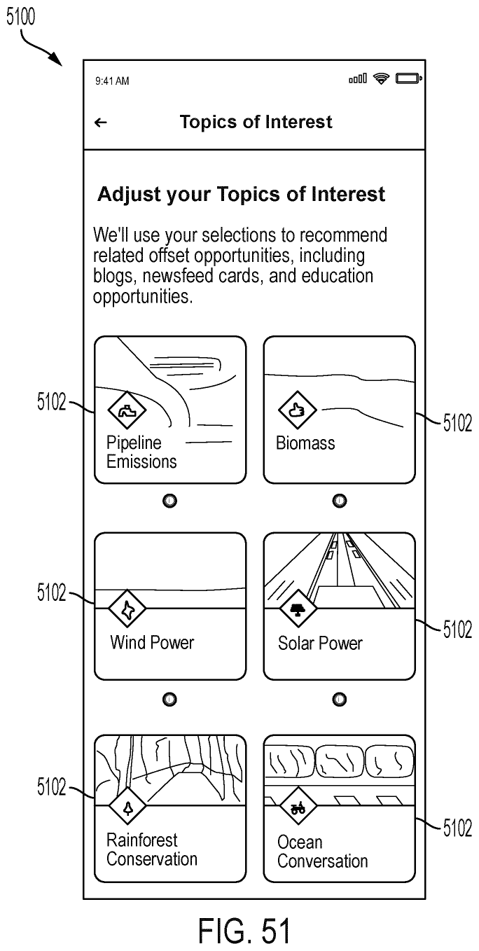

Referring now to FIG. 50, a user interface 5000 providing topics of interest and a lifestyle of a user is shown, according to an exemplary embodiment. The user interface 5000 can summarize topics for carbon emissions credits that the user is interested in. In the user interface 5000, the user has selected pipeline emissions and biomass emissions as topics of interest. For example, in the user interface 5100 of FIG. 51, a user can select various topics of interest via elements 5102.

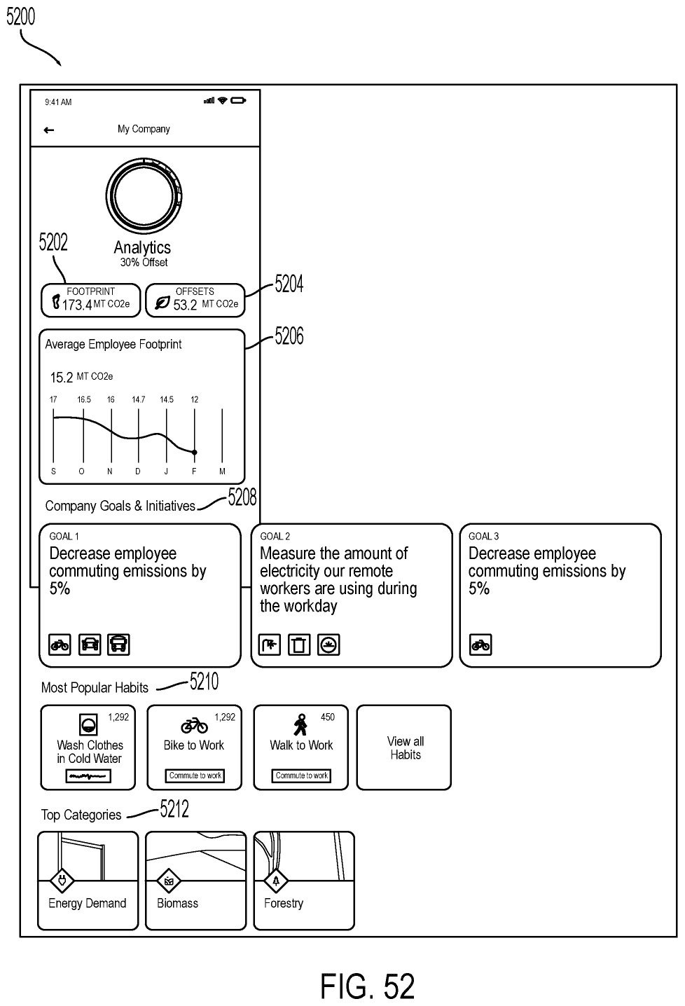

Referring now to FIG. 52, a user interface 5200 including emissions indicators a trend of a carbon footprint of a user is shown, according to an exemplary embodiment. The user interface 5200 includes analytics data for a company. The user interface 5200 can represent a carbon footprint of a company via element 5202 and offsets of the company via element 5204. The user interface 5200 includes a trend 5206. The trend 5206 can trend an average employee carbon emissions footprint over time. The user interface 5200 includes tiles 5208 that describe various goals for the company. Furthermore, the interface 5200 includes a section 5210 that indicates the habits that the employees of the company are participating in. For example, the emissions system 102 can track what habits employees of the company participate in and present a number of the habits that the employees participate in frequently, e.g., the most frequently. The user interface 5200 can indicate carbon offset categories that employees are interested in via element 5212.

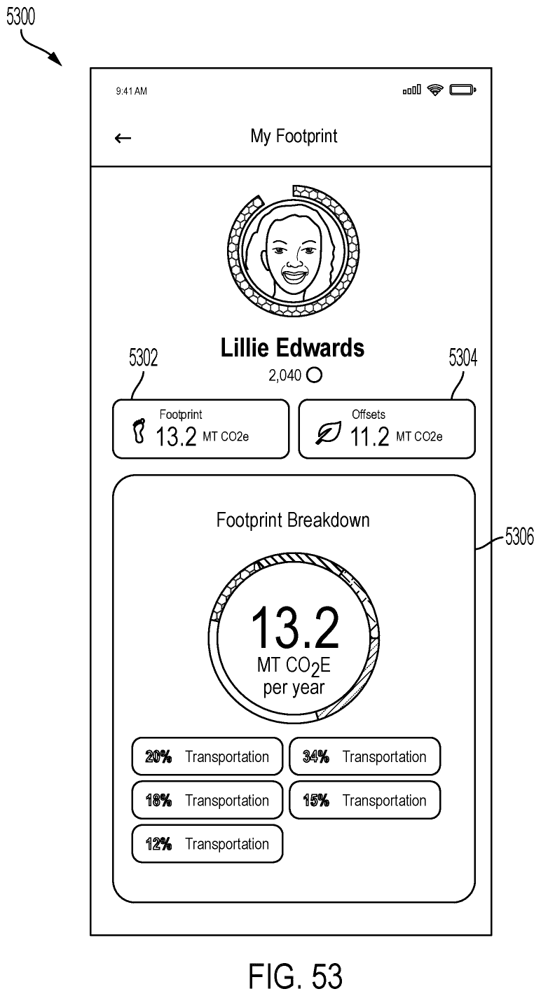

Referring now to FIG. 53, a user interface 5300 including an emissions indicator broken down into multiple categories for a user, according to an exemplary embodiment. The user interface 5300 includes a footprint 5302 that indicates a carbon footprint of the user. Furthermore, the user interface 5300 includes an offsets element 5304 that indicates offsets associated with the user. The offsets element 5304 can indicate offsets allocated to the user or offsets purchased by the user. The user interface 5300 includes a footprint breakdown 5306. The footprint breakdown 5306 can indicate the carbon emissions resulting of the user resulting from various categories. For example, the categories can include transportation, household, commuting, food and diet, and shopping.

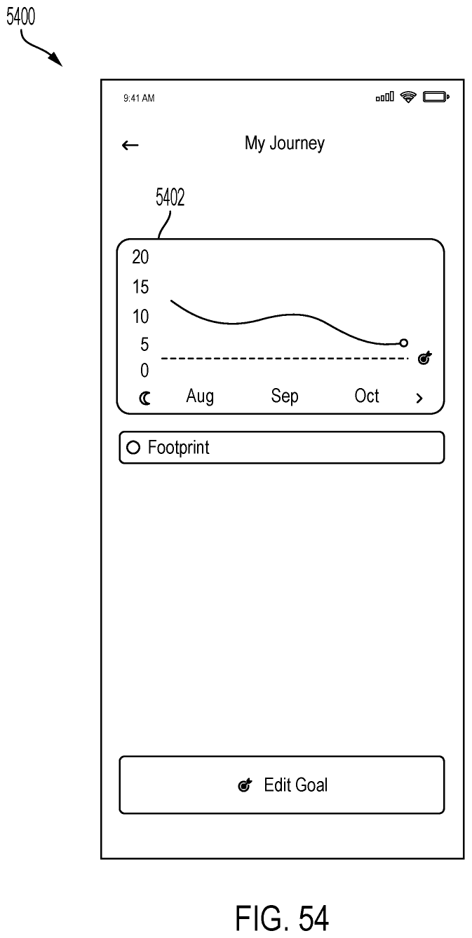

Referring now to FIG. 54, a user interface 5400 including a trend element 5402 of an emissions indicator for a user is shown, according to an exemplary embodiment. In some embodiments, the emissions system 102 (e.g., the user interface portal 218 or the mobile application 222) can retrieve emissions indicators 228 for a particular user that is logged into the user interface 5400. The emissions indicators 228 can be retrieved from the data storage 216. The emissions system 102 can plot the emissions indicators 228 for the user over time and generate a trend line across the plotted points. The emissions system 102 can plot the emissions indicators 228 or the trend line in the trend element 5402.

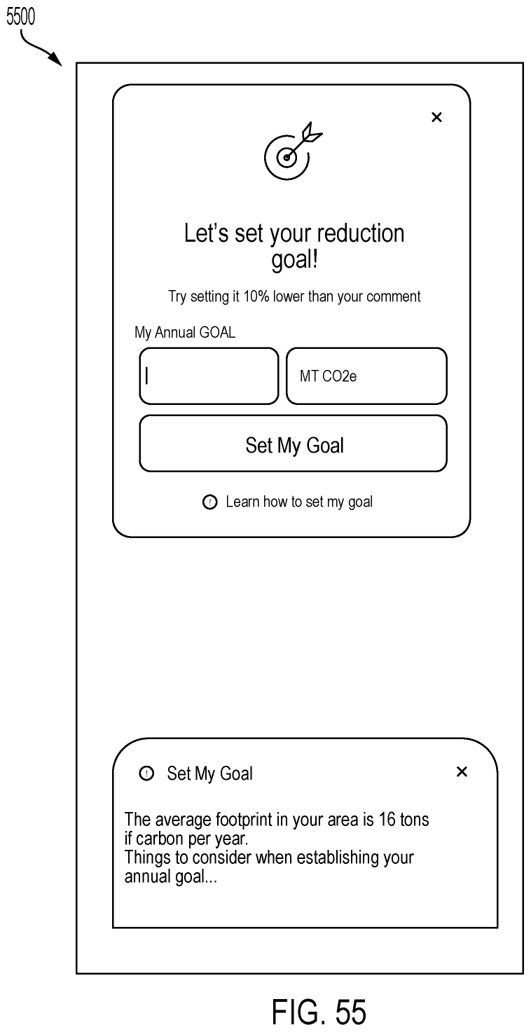

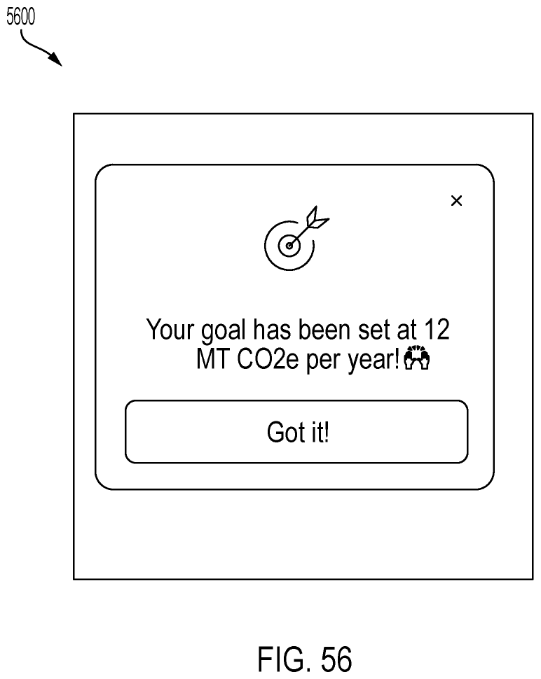

Referring now to FIG. 55, a user interface 5500 prompting a user to enter a target goal for an emissions indicator is shown, according to an exemplary embodiment. A user can enter a user level goal to reduce their own emissions production via the user interface 5500. The user can enter a company level goal to reduce the emissions production associated with a company via the user interface 5500. The user interface 5600 includes an element 5502. The element 5502 allows for a value to be entered. The value may be entered in units of metric tons of CO2e. Responsive to a user interacting with an element 5504 of the user interface 5500, the target goal can be saved. The emissions system 102 can plot the target goal as a horizontal line in various user interfaces, e.g., the user interfaces of FIG. 8-17 or FIG. 54. Responsive to a user interacting with the element 5504, the use interface 5600 of FIG. 56 can be displayed. The user interface 5600 can confirm the entered target goal and include an element 5602 confirming the entered target goal.

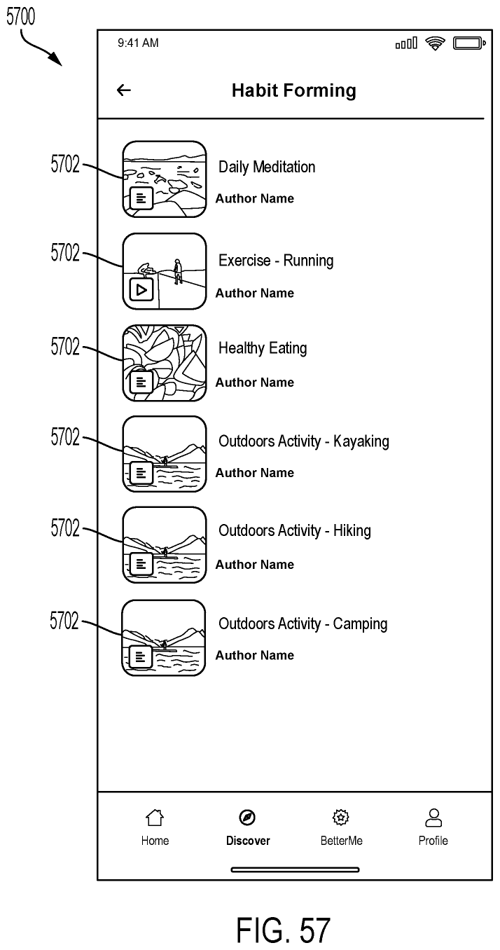

Referring now to FIG. 57, a user interface 5700 including articles regarding habits that a user can select from is shown, according to an exemplary embodiment. In the user interface 5700, various articles can be displayed via elements 5702. The user can select from various articles via the elements 5702 to read the article on their user device 118. For example, the articles could be articles about a daily meditation, exercising, cating healthy, kayaking, hiking, camping, walking to work, etc.

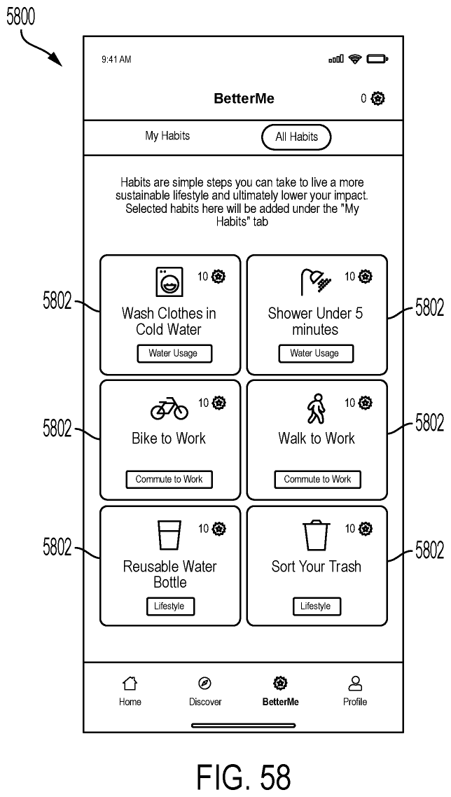

Referring now to FIG. 58, a user interface 5800 including habits that a user can select from, according to an exemplary embodiment. The user interface 5800 can display the habits via selectable elements 5802 allowing a user to select a habit for tracking. Responsive to a user interacting with a habit, the user device 118 can track the habit, e.g., ask the user questions to determine whether the user is performing activities for the habit or is not performing the activities for the habit. The selectable elements 5802 can include washing clothes in cold water, showering in under five minutes, bicycling to work, walking to work, using a reusable water bottle, sorting trash, etc.

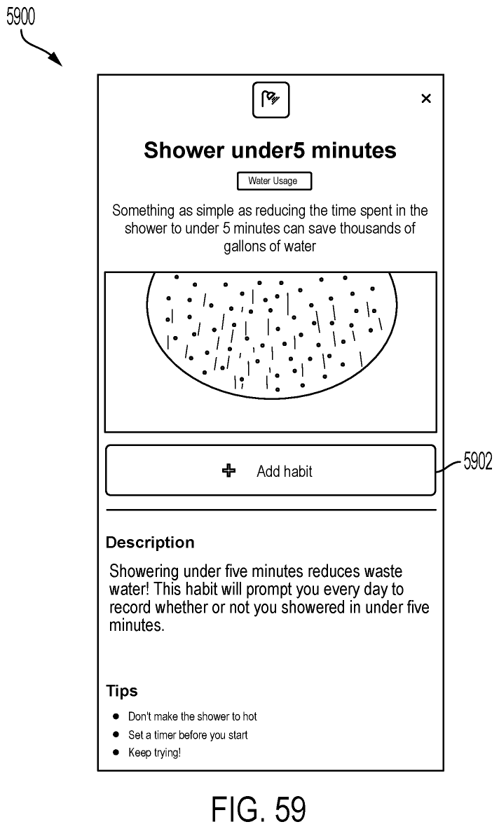

Referring now to FIG. 59, a user interface 5900 including a button 5902 for a user to add a habit, according to an exemplary embodiment. The user interface 5900 can be displayed responsive to a user selecting the shower under five minutes habit via element 5802. The user interface 5900 can provide a description of the habit and tips for adopting and succeeding with the habit. A user can interact with the button 5902 to begin tracking the habit.

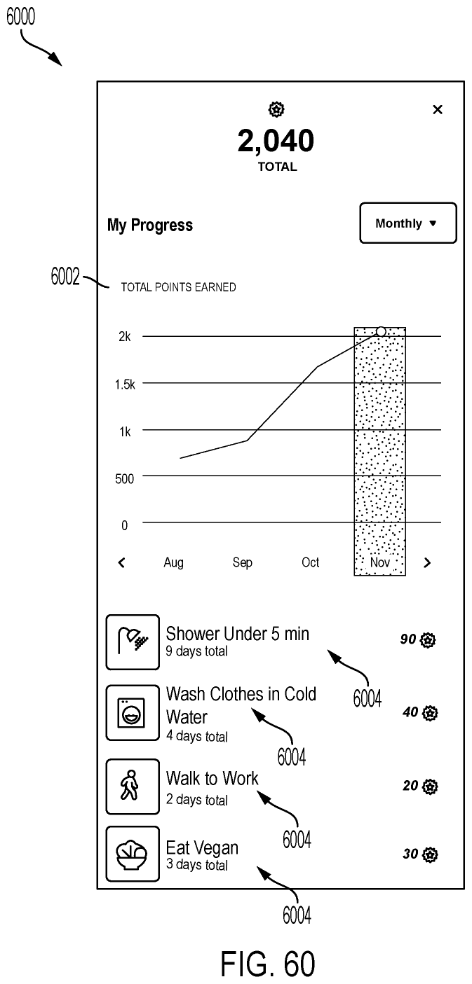

Referring now to FIG. 60, a user interface 6000 including a trend of points earned by a user is shown, according to an exemplary embodiment. The emissions system 102 can track whether the user performs the activities associated with a habit. The emissions system 102 can award the user points responsive to the user performing the activities associated with the habit. For example, the user could confirm that they took a shower in under five minutes. The emissions system 102 could award the user ten points responsive to receiving the confirmation. The emissions system 102 can store a record of points awards to the user and plot the total points for the user over time. The emissions system 102 can cause the plot to be shown in element 6002. The user interface 6000 can include a record of points earned by the user in elements 6004 of the user interface 6000. The elements 6004 can indicate the type of habit, the number of days in a row that the user has performed the habit, and the total number of points earned for each habit by the user. In some embodiments, a user can redeem the points for an award, e.g., a free drink, a certificate, a free lunch, etc.

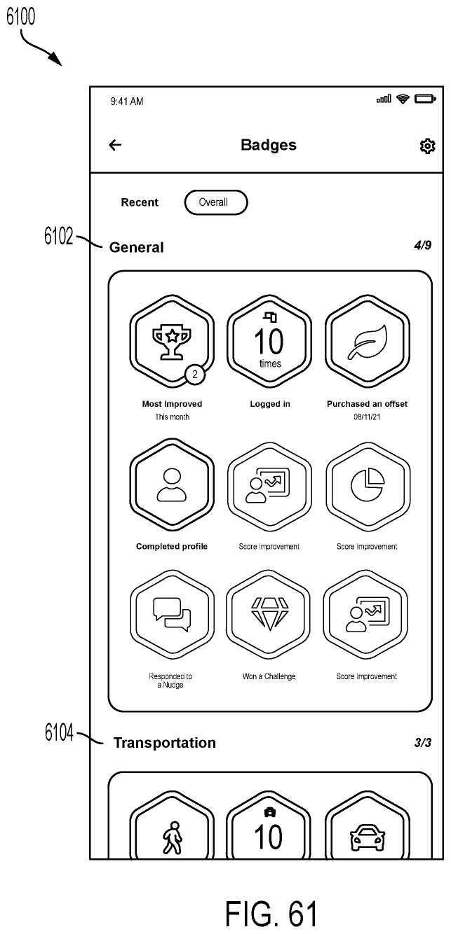

Referring now to FIG. 61, a user interface 6100 indicating badges earned by a user is shown, according to an exemplary embodiment. The user interface 6100 includes badges earned by the user. The user can perform various activities via the user device 118 and the emissions system 102 can award the user badges based on the activities. General badges can be displayed in the element 6102 of the user interface 6100. The general badges could indicate improvements, number of times logged in, purchase of an offset, completion of a profile, etc. The user interface 6100 can further include category specific badges, e.g., transportation badges displayed in the element 6104 of the user interface 6100.

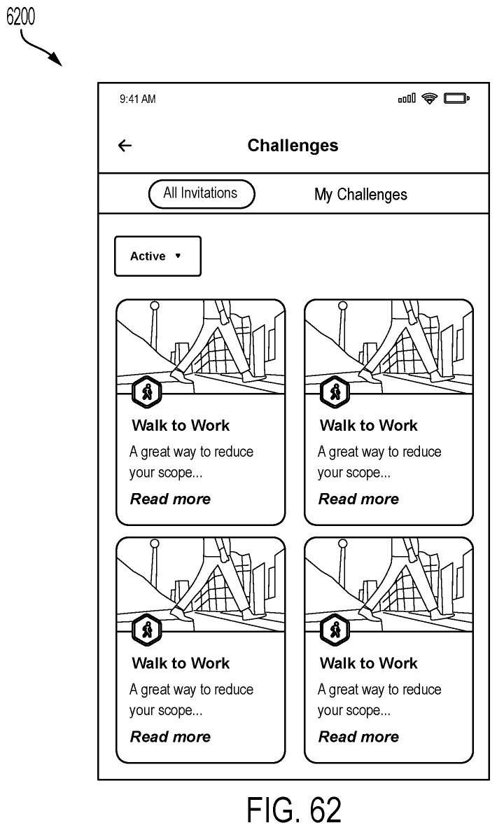

Referring now to FIG. 62, a user interface 6200 indicating challenges that a user can select and participate in is shown, according to an exemplary embodiment. The challenges can be a challenge to perform a particular activity over a period of time. For example, the challenge could be walking to work one day per week. The challenge could be carpooling two times a day. The challenge could be eating a salad for lunch every day.

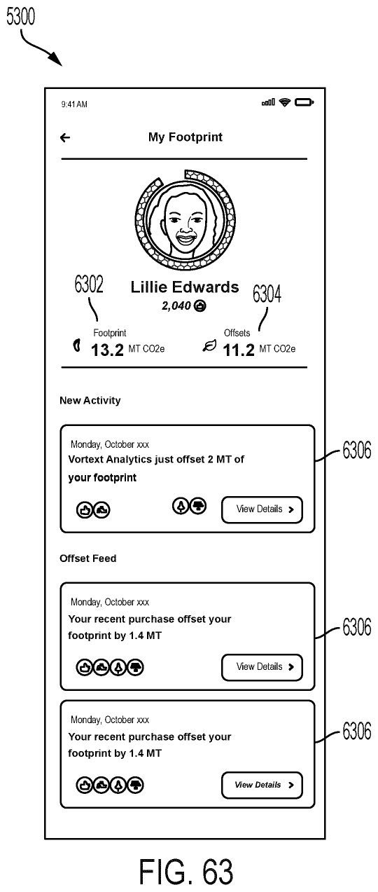

Referring now to FIG. 63, a user interface 6300 allowing a user to purchase and allocate offsets is shown, according to an exemplary embodiment. The user interface 6300 can allow for the purchase and allocation of offsets on a user level, e.g., for an individual user. The user interface 6300 can allow a user to purchase offsets for themselves and offset their own carbon emissions footprint for a specific period of time. The user interface 6300 includes an indication of a carbon footprint for the user that is logged in to the user interface 6300 in element 6302. The user interface 6300 includes an indication of offsets for the user that is logged in to the user interface 6300 in the element 6304. The user interface 6300 includes a feed of carbon offset purchases, e.g., element 6308 and element 6310. The carbon offset purchases can indicate an amount of metric tons of carbon offset purchased and can allow a user to view additional details for the carbon offset purchase.

Referring generally to FIGS. 64-66, a sustainability data (e.g., ecological sustainability data, green data, eco-friendly data, etc.) management is shown, according to various exemplary embodiments. The system and methods can manage sustainability data for sustainability tracking and enhancement, such as emissions tracking and reduction, water use tracking and reduction, single-use plastic use tracking and reduction, and sustainability activity tracking and incentivizing. A sustainability system can, in some embodiments, collect activity data of a corpus or group of entities (e.g., of a user or group of users, a family, a company, a city, a state, a country, etc.). The activity data can be used to identify sustainability metrics (e.g., emissions production, water-utilization, single-use plastic utilization, etc.) resulting from the activities of the activity data. The sustainability metrics information can be used by the sustainability system to establish a sustainability metric based on, for example: (i) an emissions footprint, e.g., carbon footprint, indicating emissions associated with a particular user or group of users; (ii) water waste, e.g., water footprint, indicating water use associated with a particular user or group of users; (iii) single-use plastics footprint, e.g., plastic footprint, indicating plastic use associated with a particular user or group of users; and/or (iv) offset activities, e.g., footprint credit, indicating participation in or knowledge of sustainable activities, practices, and habits. The data collected can be high-level data. For example, the data can represent general activities, behaviors, or preferences of the entities of the corpus or group of entities.

A sustainability system that collects granular low-level data for every entity of a corpus or group of entities and determines sustainability indicators for multiple sustainability categories based on the granular low-level data (e.g., a sustainability system that collects granular low-level data for every entity of a corpus or group of entities and determines emissions indicators for multiple emissions categories based on the granular low-level data) may encounter various problems. The granular low-level data may directly describe a particular factor, e.g., consumption (e.g., energy consumption, fuel consumption, food consumption, water consumption, etc.). For example, the corpus or group of entities may be very large, e.g., hundreds, thousands, millions, or even billions of entities. Furthermore, the granular data points or data features that could be collected for each entity of the corpus or group of entities to determine sustainability indicators (e.g., emissions indicators, water use indicators, plastic use indicators, etc.) may be even larger. These granular data points can indicate real-time or historical activities of users, specific granular descriptions of commuting routes of the users, granular descriptions of vehicle engine types or fuel efficiencies, etc. The amount of data storage needed to store the granular data points for the corpus or group of entities may be very large. Furthermore, processing and managing this large volume of data can require significant amounts of computational resources (e.g., processor and memory resources) and require significantly long processing times. These long processing times can cause computational resources to be in an operational state causing significant amounts of power to be drawn from a power source. Furthermore, entities of the corpus or group of entities may not wish to provide granular data to the sustainability system for security reasons and therefore collecting the granular data from entities may have challenges.

To solve these, and other technical challenges, the systems and methods discussed herein can manage the large volume of data for the corpus or group of entities in a manner that reduces data storage resources used, reduce processor and memory resources used, reduce an amount of power consumption needed by the computing systems that implement the systems and methods, and allow for sustainability indicators to be generated faster than conventional methods. For example, the sustainability system can collect high-level data for the corpus or group of entities instead of, or in addition to, low-level data. The high-level data can indicate general behaviors, habits, or activities of the corpus or group of entities. The sustainability system can generate sustainability indicators based on the high-level data. However, because the high-level data is less granular, an accuracy of the sustainability indicators could be reduced. In this regard, the sustainability system can implement modeling assumptions that model low-level data based on the collected high-level data. This allows the sustainability system to quickly and efficiently determine sustainability indicators (e.g., emissions indicators, water use indicators, plastic use indicators, etc.) while maintaining a high accuracy for the sustainability indicators.

The sustainability system can further solve technical challenges in the display of sustainability indicators for a large corpus or group of entities. Displaying the causes of, for example, emissions production for a corpus or group of entities may be difficult to summarize since there are a significant amount of possible emissions causes. Likewise, displaying the causes of, for example, water use and/or plastic use may be difficult to summarize because there are a significant amount of possible water use causes and plastic use causes. To solve these, and other technical problems, the sustainability system can generate sustainability indicators based on the collected high-level data and modeling assumptions in multiple categories. The sustainability system can, based on the modeling assumptions and the high-level data for each entity of the corpus or group of entities, generate a sustainability indicator for each entity in each category. The sustainability system can sort the sustainability indicators into buckets of data such that the sustainability data is organized by categorizations corresponding to, for example, sustainability data type (e.g., emissions data type, water use data type, plastic use data type, sustainable practices data type, etc.). The sustainability system can aggregate the sustainability indicators of each bucket into a single sustainability indicator for each category, and aggregate the sustainability indicators of the categories into a single sustainability indicator (e.g., a chief sustainability indicator). The sustainability indicators can, in some embodiments, be timeseries of sustainability indicators, e.g., sustainability indicators, such as emissions indicators, for multiple points in time. In this regard, the sustainability system can generate a set of sustainability indicators for each point in time for a set of points in time for each category, and for each data type. The sustainability system can generate a total sustainability indicator for the corpus or group. The total sustainability indicator can be an aggregate for sustainability indicators of each sustainability data type.

The sustainability system can generate a user interface that displays the total sustainability indicator for the corpus or group of entities. The user interface could be a trend or bar graph, a pie chart (e.g., fractional diagram), a percentage, a numerical value, or other visual representation. The sustainability system can cause the user interface to include a selectable element that allows a user to select between the sustainability data types and/or between the categories (e.g., the sub-categories of each sustainability data type). The user interface can update based on a selection of the user and drill down from the total sustainability indicator to type level sustainability indicators, down to category level emissions indicators, down to entity level emissions indicators. This user interface can allow a user to grasp, within a single interface, the breakdown of sustainability indicators for the large corpus or group of entities which would normally require multiple different types of presentation formats.

Furthermore, the sustainability system can aid a user or group of users to reduce their emissions footprint, water footprint, plastic footprint, and track the performance of the corresponding emissions reduction, water use reduction, or plastic use reduction. The sustainability system can help a user set sustainability goals, for example, carbon footprint goals, e.g., zero emissions goals or near zero emissions goals (e.g., net zero emissions goals, including offsets/investments). The sustainability system can provide projects or carbon offsets (e.g., correction factors, correction units, behavioral credits, indirect ecological behavioral benefit units, sustainable practice rewards) that allow the user or group of users to reduce their carbon footprint, water footprint, plastic footprint, and meet the carbon footprint goals, water footprint goals, and plastic footprint goals, that they have set.

Advantageously, the single sustainability score and adjusted sustainability score can facilitate an improved user interface and data management for a sustainability data for an entity or corpus or group of entities and provides an efficient, effective, and succinct high-level display of a very large quantity of low-level data that is otherwise impossible to display, fit, or otherwise present on a display device having a limited display area. For example, a screen (e.g., liquid crystal display, light emitting diode display, electrophoretic display, backlight display, etc.) having limited dimensions, for example, a screen of a wearable smart watch or other small screen device may not have a resolution, pixel density, available screen area, and/or computing resource supportive of a display of sustainability data. Advantageously, the sustainability system configured to generate sustainability indicators, a single sustainability indicator, and an adjusted sustainability indicator facilitates presentation, management, and control for a very large and very complex volume of sustainability data of an entity or a corpus or group of entities. For example, the sustainability indicators, single sustainability indicator, and adjusted sustainability indicator are configured to be presented to a user in a variety of user interface devices such as displays, wearable devices, residential computing systems, transport devices, and other devices. Unexpectedly, the sustainability indicators, single sustainability indicator, and adjusted sustainability indicator effectuate upstream impacts on the suitability data. For example, the adjusted sustainability indicator can effectuate implementation of sustainability data collection, sustainability data accuracy, and sustainability data standardization.

The systems and methods described with reference to FIGS. 64-66 relate to managing sustainability data, such as emissions data, water consumption and conservation data, single-use/disposable plastics utilization data, sustainable practices participation data, and other ecological sustainability data. The behavior of individuals and groups of individuals can increase or decrease overall carbon production, water consumption, utilization of single-use/disposable plastics, participation in sustainable practices, and the availability of ecological sustainability data. However, the volume of data points or data features that describe carbon production, water consumption, plastic utilization, and sustainable practices implementation is extremely large and difficult to manage.

Referring now to FIG. 64, a block diagram of a system 6400 including an sustainability system 6402 tracking and reducing emissions, water use, and plastic use, and increasing participation in sustainable practices, of a user or company is shown, according to an exemplary embodiment. The sustainability system 6402 can be a computer system (e.g., desktop computer, database system, server system, a cloud computing platform, etc.) that is configured to communicate with a wearable device 6414 (e.g., smart watch, fitness device, health bracelet, fitness ring, etc.), a user device 6418 (e.g., personal computing device, portable computing device, cellular telephone, pocketable computing device, etc.), a transport device 6420 (e.g., automobile computing system, motorcycle computing system, train computing system, ferry computing system, bicycle computing system, etc.), a residential computing system 6422 (e.g., work from home equipment, desktop computing system, home management system, smart home management system, HVAC system, thermostat, environmental controller, etc.), and/or a cloud platform 6426 (e.g., a network based computing system, a cloud-based computing service or system, a server system, a data processing system, a remote computing platform, a data processing platform, etc.). The user interfaces and interface elements of FIGS. 4-63 can be generated by the sustainability system 6402 and displayed on display devices (e.g., touch screen displays, light emitting diode (LED) displays, organic LED (OLED) displays, capacitive touch screens, etc.) of the wearable device 6414, user device 6418, transport device 6420, residential computing system 6422, and/or the cloud platform 6426. Furthermore, the sustainability system 6402 can receive user input from the user interfaces of FIGS. 4-63 via the wearable device 6414, user device 6418, transport device 6420, residential computing system 6422, and/or the cloud platform 6426.

The wearable device 6414 can be a smartwatch, a smart ring, smart glasses, a smart necklace, a pacemaker, etc. The wearable device 6414 can collect data associated with a user's travel, a user's heart rate, a user's blood pressure, etc. The user device 6418 can be a smartphone, a tablet, a laptop, a desktop computer, a mobile device, etc. The user device 6418 can include a display device for displaying user interfaces to a user (e.g., a LED screen, an OLED screen, etc.). The user device 6418 can include input devices for receiving user input. For example, a touch screen, a mouse, a keyboard, etc. The wearable device 6414, transport device 6420, residential computing system 6422, and cloud platform 6426 can include a similar display device and/or an input device.

A network can be used by the sustainability system 6402 to communicate with the wearable device 6414 and/or the user device 6418. The network can be a Local Area Network (LAN), a Wide Area Network (WAN), a wireless network, the Internet, a cellular network (e.g., 3G, 4G, 5G), a Bluetooth connection, a Wi-Fi network, and any other type of wired or wireless form of communication. The sustainability system 6402 can include one or more processors 6404 and one or more memory devices 6406.

The processor(s) 6404 can be a general purpose or specific purpose processor, an application specific integrated circuit (ASIC), one or more field programmable gate arrays (FPGAs), a group of processing components, or other suitable processing components. The processor(s) 6404 may be configured to execute computer code and/or instructions stored in the memories or received from other computer readable media (e.g., CDROM, network storage, a remote server, etc.).

The memory device(s) 6406 can include one or more devices (e.g., memory units, memory devices, storage devices, etc.) for storing data and/or computer code for completing and/or facilitating the various processes described in the present disclosure. The memory device(s) 6406 can include random access memory (RAM), read-only memory (ROM), hard drive storage, temporary storage, non-volatile memory, flash memory, optical memory, or any other suitable memory for storing software objects and/or computer instructions. The memory device(s) 6406 can include database components, object code components, script components, or any other type of information structure for supporting the various activities and information structures described in the present disclosure. The memory device(s) 6406 can be communicably connected to the processor(s) 6404 and can include computer code for executing (e.g., by the processors) one or more processes described herein.

The sustainability system 6402 can include a water manager 6408, a plastics manager 6410, an emissions manager 6412, and an engagement manager 6416. The water manager 6408, the plastics manager 6410, the emissions manager 6412, and the engagement manager 6416 can be stored as instructions on the memory devices 6406 and run by the processors 6404. The water manager 6408, the plastics manager 6410, the emissions manager 6412, and the engagement manager 6416 can be computer code, computing instructions, executables, functions, modules, software applications, etc. The water manager 6408, the plastics manager 6410, the emissions manager 6412, and the engagement manager 6416 can provide information to the wearable device 6414, transport device 6420, residential computing system 6422, and/or cloud platform 6426. Similarly, the wearable device 6414, transport device 6420, residential computing system 6422, and/or cloud platform 6426 can provide information to the water manager 6408, the plastics manager 6410, the emissions manager 6412, and the engagement manager 6416. The water manager 6408, the plastics manager 6410, the emissions manager 6412, and the engagement manager 6416, can receive information recorded and/or input by users of the wearable device 6414, transport device 6420, residential computing system 6422, and/or cloud platform 6426.

The water manager 6408 (e.g., water service) can be configured to record water usage information of a company, generate water usage indicators, and generate user interfaces including the water usage indicators for the company. In some embodiments, the water manager 6408 can generate user interfaces for any other type of group of individuals, e.g., a company, a school, a college, a university, a family, a state, a city, a country, etc.

The water manager 6408 can include a user water usage questionnaire service configured to provide a user with a series of questions to determine a water footprint of a user, e.g., via the wearable device 6414 and/or the user device 6418. The water questionnaire service can generate the water footprint based on the responses received from the user. The user water usage questionnaire service of the water manager 6408 can generate user interfaces regarding the water usage information. The user interfaces can be displayed on, for example, the wearable device 6414 and/or the user device 6418. The water manager 6408 can be configured to record water usage information specific to a user and generate water usage user interfaces for the user. The water manager 6408 can receive tracking data (e.g., global positioning system data) and/or user input from the wearable device 6414, transport device 6420, residential computing system 6422, and/or cloud platform 6426 and generate water usage user interfaces based on the recorded data.

The plastics manager 6410 (e.g., plastics service) can be configured to record plastic usage information of a company, generate plastic usage indicators, and generate user interfaces including the plastic usage indicators for the company. In some embodiments, the plastics manager 6410 can generate user interfaces for any other type of group of individuals, e.g., a company, a school, a college, a university, a family, a state, a city, a country, etc.

The plastics manager 6410 can include a user plastic usage questionnaire service configured to provide a user with a series of questions to determine a plastic footprint of a user, e.g., via the wearable device 6414 and/or the user device 6418. The emissions questionnaire service can generate the plastic footprint based on the responses received from the user. The user plastic usage questionnaire service of the plastics manager 6410 can generate user interfaces regarding the plastic usage information. The user interfaces can be displayed on the wearable device 6414 and/or the user device 6418. The plastics manager 6410 can be configured to record plastic usage information specific to a user and generate plastic usage user interfaces for the user. The plastics manager 6410 can receive tracking data (e.g., global positioning system data) and/or user input from the wearable device 6414, transport device 6420, residential computing system 6422, and/or cloud platform 6426 and generate plastic usage user interfaces based on the recorded data.

The emissions manager 6412 can be configured to record emissions information of a company, generate emissions indicators, and generate user interfaces including the emissions indicators for the company. In some embodiments, the emissions manager 6412 can generate user interfaces for any other type of group of individuals, e.g., a company, a school, a college, a university, a family, a state, a city, a country, etc. In some embodiments, the emissions manager 6412 includes some or all of the features of the emissions service 108, user emissions questionnaire service 110, and user emissions service 112. In some embodiments, the emissions service 108 includes some or all of the features described with respect to the emissions manager 6412.

The emissions manager 6412 can include a user emissions questionnaire service configured to provide a user with a series of questions to determine a carbon footprint of a user, e.g., via the wearable device 6414 and/or the user device 6418. The emissions questionnaire service can generate the carbon footprint based on the responses received from the user. The user emissions questionnaire service of the emissions manager 6412 can generate the user interfaces of FIGS. 27-42. The user interfaces of FIGS. 27-42 can be displayed on the wearable device 6414 and/or the user device 6418. The emissions manager 6412 can be configured to record emission information specific to a user and generate emissions user interfaces for the user. The emissions manager 6412 can receive tracking data (e.g., global positioning system data) and/or user input from the wearable device 6414, transport device 6420, residential computing system 6422, and/or cloud platform 6426 and generate the emissions user interfaces based on the recorded data.

The engagement manager 6416 can be configured to record sustainable practices engagement information of a company, generate engagement indicators, and generate user interfaces including the engagement indicators for the company. In some embodiments, the engagement manager 6416 can generate user interfaces for any other type of group of individuals, e.g., a company, a school, a college, a university, a family, a state, a city, a country, etc.

The engagement manager 6416 can include a user engagement questionnaire service configured to provide a user with a series of questions to determine engagement in one or more sustainable practices that counteract, lessen, or mitigate one or more factors contributing to at least one of a carbon footprint of a user, a water footprint of a user, or a plastics footprint of a user, e.g., via the wearable device 6414 and/or the user device 6418. The engagement questionnaire service can generate an engagement metric based on the responses received from the user and/or based on a measure of user interaction with the sustainability system 6402 (e.g., inputs, data source connections, frequency of use, quality of inputs, consistency of inputs, time logged into a profile or portal, quantity or quality of attempted sustainable activities, number of views of one or more user interfaces, etc.). The user engagement questionnaire service of the engagement manager 6416 can generate the user interfaces. The user interfaces can be displayed on, for example, the wearable device 6414 and/or the user device 6418. The engagement manager 6416 can be configured to record engagement information specific to a user and generate engagement user interfaces for the user. The engagement manager 6416 can receive tracking data (e.g., global positioning system data) and/or user input from the wearable device 6414, transport device 6420, residential computing system 6422, and/or cloud platform 6426 and generate the emissions user interfaces based on the recorded data.

In some embodiments, the sustainability system 6402 includes a habits manager 6430, a habits database 6432, a home improvement manager 6434, a home improvement database 6436, a residential data manager 6438, a residential data database 6440, a footprint manager 6442, a footprint database 6444, a team events manager 6446, a team events database 6448, a drought data manager 6450, a drought database 6452, and a location manager 6454. The habits manager 6430, the habits database 6432, the home improvement manager 6434, the home improvement database 6436, the residential data manager 6438, the residential data database 6440, the footprint manager 6442, the footprint database 6444, the team events manager 6446, the team events database 6448, the drought data manager 6450, the drought database 6452, and/or a location manager 6454 can be stored as instructions on the memory devices 6406 and run by the processors 6404. The habits manager 6430, the habits database 6432, the home improvement manager 6434, the home improvement database 6436, the residential data manager 6438, the residential data database 6440, the footprint manager 6442, the footprint database 6444, the team events manager 6446, the team events database 6448, the drought data manager 6450, the drought database 6452, and/or a location manager 6454 can provide information to the wearable device 6414, transport device 6420, residential computing system 6422, and/or cloud platform 6426. Similarly, the wearable device 6414, transport device 6420, residential computing system 6422, and/or cloud platform 6426 can provide information to the habits manager 6430, the habits database 6432, the home improvement manager 6434, the home improvement database 6436, the residential data manager 6438, the residential data database 6440, the footprint manager 6442, the footprint database 6444, the team events manager 6446, the team events database 6448, the drought data manager 6450, the drought database 6452, and/or a location manager 6454. The habits manager 6430, the habits database 6432, the home improvement manager 6434, the home improvement database 6436, the residential data manager 6438, the residential data database 6440, the footprint manager 6442, the footprint database 6444, the team events manager 6446, the team events database 6448, the drought data manager 6450, the drought database 6452, and/or a location manager 6454, can receive information recorded and/or input by users of the wearable device 6414, transport device 6420, residential computing system 6422, and/or cloud platform 6426.

In some embodiments, the habits database 6432 may store and/or maintain data regarding activities of a company, user(s), group of users, etc. The habits manager 6430 may collect, distribute, adjust, categorize, modify, and/or convert some or all of the data stored in the habits database 6432. For example, the habits manager 6430 may generate the user interface shown in FIG. 45 and data corresponding to an input received based on the user interface may be stored in the habits database 6432. For example, the habits database may include data regarding habits corresponding to prompts such as “Wash your clothes with cold water,” “Turn off the water when brushing your teeth,” “Take a 5 minute shower,” “Grow a vegetable garden or join a local community garden!”, “Compost your food waste,” “Use a Reusable water bottle,” “Use reusable shopping bags,” “Use reusable storage containers for leftover food,” “Use a reusable coffee cup when buying coffee from a café,” “Use a reusable straw,” “Sort your trash (i.e. recycle),” “Buy Local Produce from a farmers market or local choices at a grocery store),” “Buy Produce from Local Farms,” “Check Pantry Before Shopping (consumer food waste),” “Air dry your clothes,” “Close/open shades,” “Eat Less Beef,” “Eat No Beef,” “Eat Less Meat,” “Eat No Meat/seafood,” “Eat Less Dairy,” “Eat No Dairy,” “Bike to Work,” “Walk to Work,” “Take bus to work,” “Take train to work,” and/or “Take subway/light rail to work.” Each habit within the habits database 6432 may have one or more data attributes such as a static, dynamic, calculated, or predetermined, offset value for one or more of the sustainability data types for satisfying a criteria indicative of doing a habit (e.g., based on an input that indicates the user exhibits the habit). For example, each habit may be associated with metrics such as frequency, emissions reduction per habit occurrence, plastic reduction per habit occurrence, water reduction per habit occurrence, and a metric of the relative difficulty of the habit (e.g., habit points, a nonzero integer value, etc.).

In some embodiments, the home improvement database 6436 may store and/or maintain home improvement data regarding activities of a company, user(s), group of users, etc. The home improvement manager 6434 may collect, distribute, adjust, categorize, modify, and/or convert some or all of the data stored in the home improvement database 6436. For example, the home improvement database 6436 may include data regarding home improvements corresponding to prompts such as “Install a smart thermostat,” “Improve insulation and air-scaling in attic, crawl spaces, walls, and windows,” “Upgrade your windows to energy star certified windows,” “Upgrade to Energy Star Appliances,” “Implement Solar Energy Methods,” and/or “Implement a new renewable energy method.” Each improvement within the home improvement database 6436 may have one or more data attributes such as a static, dynamic, calculated, or predetermined, offset value for one or more of the sustainability data types for satisfying a criteria indicative of an improvement (e.g., based on an input indicating their residence exhibits the improvement). For example, each improvement may be associated with a metric such an emissions reduction per improvement occurrence.

In some embodiments, the residential data database 6440 may store and/or maintain data regarding activities of a company, user(s), group of users, etc. The residential data manager 6438 may collect, distribute, adjust, categorize, modify, and/or convert some or all of the data stored in the residential data database 6440. For example, the residential data database 6440 may include residential data objects (e.g., containers, classes, buckets, etc.) regarding information such as, a location-based climate categorization, a dwelling type, residential occupants (e.g., number of occupants living in a home or building), size of the residence (e.g., square footage, number of floors, etc.), heating system (e.g., electric heating system, natural gas heating system, etc.), and/or appliance information (e.g., water heater type, stove fuel type, gas stove, electric stove, etc.).

In some embodiments, the footprint database 6444 may store and/or maintain data regarding activities of a company, user(s), group of users, etc. The footprint manager 6442 may collect, distribute, adjust, categorize, modify, and/or convert some or all of the data stored in the footprint database 6444. For example, the footprint database 6444 may include a conversion table for converting between, for example: a diet type (e.g., omnivore, vegetarian, etc.) and an emissions footprint quantity; a car size and/or fuel type (e.g., Motorcycle Gas, Sub-Compact Gas, Sub-Compact Diesel, Sub-Compact Hybrid, Sub-Compact Electric, Compact Gas, Compact Diesel, Compact Hybrid, Compact Electric, Mid-Size Gas, Mid-Size Diesel, Mid-Size Hybrid, Mid-Size Electric, Large Gas, Large Diesel, Large Hybrid, Large Electric, Large Van Gas, etc.) and a corresponding emissions footprint quantity (e.g., on a per unit fuel basis, on a per mile traveled basis); a transportation method (e.g., bus, train, subway, walk, bicycle, etc.) and a corresponding emission footprint value, a shopping metric and a corresponding emission footprint quantity; and/or an appliance type (e.g., desktop, laptop, monitor, etc.) and a corresponding emission footprint quantity.

In some embodiments, the team events database 6448 may store and/or maintain data regarding activities of a company, user(s), group of users, etc. The team events manager 6446 may collect, distribute, adjust, categorize, modify, and/or convert some or all of the data stored in the team events database 6448. For example, the team events database 6448 may include multiple team events available to the company or a subset of the company. For example, the team events stored in the team events database 6448 may include one or more criteria for selection, team event rules (e.g., contest rules, qualifiers, etc.) and team event durations (e.g., contest durations), and team event rewards (e.g., points awarded to the winner(s), etc.). For example, a team event may include an event having a team event duration of 5 weeks, a team event reward of 500 units, and is based on satisfying one or more criteria (e.g., achieve a threshold number of habit occurrences in the shortest duration of time, or, have the highest number of habit occurrences during the team event duration, etc.).

In some embodiments, the drought database 6452 may store and/or maintain data regarding droughts (e.g., droughts attributed to a lack of rainfall or other causes). The drought data manager 6450 may collect, distribute, adjust, categorize, modify, and/or convert some or all of the data stored in the drought database 6452. For example, the drought data stored in the drought database 6452 can include a plurality of locations and an associated drought metric (e.g., a drought index value). In some embodiments, the drought data manager 6450 is configured to convert a drought index value into a value or correction factor for adjusting the water footprint and/or related offsets (e.g., offset emission quantities associated with a habit stored within the habits database 6432).

In some embodiments, the habits database 6432, home improvement database 6436, residential data database 6440, footprint database 6444, team events database 6448, or drought database 6452 are at least partially network based or updated (e.g., periodically or continuously) based on an updated dataset. For example, the drought data manager 6450 may communicate with a network-based (e.g., internet-based) public or proprietary data management system (e.g., via interaction with an application programing interface) or other interface of a system maintaining a source dataset in order to refresh, update, merge, or sync the data stored in the drought database 6452 with the dataset.

In some embodiments, the habits database 6432, home improvement database 6436, residential data database 6440, footprint database 6444, team events database 6448, and/or drought database 6452 are at least partially network based and/or updated (e.g., periodically or continuously) based on an updated dataset over a network.

In some embodiments, sustainability system 6402 includes a scoring engine 6460, a scoring database 6462, and/or a ranking engine 6464. The scoring engine 6460, scoring database 6462, and ranking engine 6464 can be stored as instructions on the memory devices 6406 and run by the processors 6404. The scoring engine 6460, scoring database 6462, and ranking engine 6464 can provide information to the wearable device 6414, transport device 6420, residential computing system 6422, and/or cloud platform 6426. Similarly, the wearable device 6414, transport device 6420, residential computing system 6422, and/or cloud platform 6426 can provide information to the scoring engine 6460, scoring database 6462, and ranking engine 6464. The scoring engine 6460, scoring database 6462, and ranking engine 6464 can receive information recorded and/or input by the users of the wearable device 6414, transport device 6420, residential computing system 6422, and/or cloud platform 6426.

In some embodiments, the scoring engine 6460 is configured receive one or more sustainability indicators and output an aggregated and/or adjusted (e.g., standardized) sustainability indicator (e.g., a standardized sustainability score). For example, the scoring engine 6460 may aggregate sustainability indications from the water manager 6408, plastics manager 6410, emissions manager 6412, engagement manager 6416, and/or location information from the location manager 6454 and determine a sustainability indication (e.g., a sustainability score). In some embodiments, the sustainability score is a function of a water use footprint indication, a plastics use footprint indication, an emissions footprint indication, an engagement indication, and a location indication. In some embodiments, the range of sustainability scores output by the scoring engine 6460 is bounded (e.g., kept within one or more threshold values). In some embodiments, the range of sustainability scores varies by location (e.g., by state, by region, by county, etc.). In some embodiments, the scoring engine 6460 is configured to query the scoring database 6462 for a sustainability score limit by using location data as a query key. In some embodiments, the scoring engine 6460 may present the sustainability score via a user interface of one or more of the wearable device 6414, user device 6418, transport device 6420, residential computing system 6422, and/or the cloud platform 6426.

In some embodiments, the ranking engine 6466 is configured receive one or more sustainability scores, generate ranking information for each of the one or more sustainability scores, and output ranking information regarding the one or more sustainability scores. For example, the ranking engine 6466 may be configured to categorize, list, or rank the one or more sustainability scores output by the scoring engine 6460. In some embodiments, the ranking engine 6466 is configured to rank and/or categorize the sustainability score. In some embodiments, the ranking engine 6466 is configured to categorize the sustainability score and one or more factors of the sustainability score. For example, the ranking engine 6466 may generate ranking information for the water use footprint indication (e.g., water footprint score), the plastics footprint indication (e.g., plastics footprint score), and engagement indication (e.g., engagement score). For example, the ranking engine 6466 may categorize the sustainability score by comparing the sustainability score to a set of sustainability scores. For example, the ranking engine 6466 may categorize the sustainability score by comparing the sustainability score to one or more statistical measures of the set of sustainability scores. As another example, the ranking engine 6466 may categorize the sustainability score by comparing the sustainability score to the average score of the set of sustainability scores, and/or by determining standard deviation, and/or a percentile. In some embodiments, the ranking engine 6466 may present the ranking data via a user interface of one or more of the wearable device 6414, user device 6418, transport device 6420, residential computing system 6422, and/or the cloud platform 6426.

In some embodiments, the sustainability system 6402, or various components of the sustainability system 6402, can generate data that causes the wearable device 6414, transport device 6420, residential computing system 6422, and/or cloud platform 6426 to display the interfaces described with references at FIGS. 4-63.

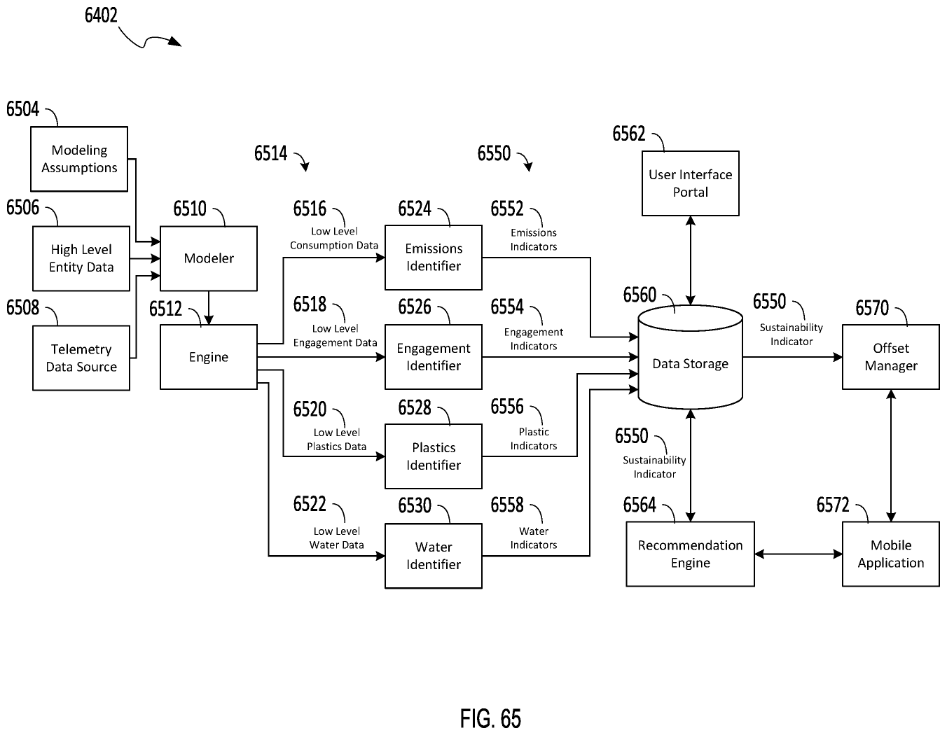

Referring now to FIG. 65, the sustainability system 6402 generating sustainability indicators 6550 from high-level entity data 6506 based on modeling assumptions 6504 is shown, according to an exemplary embodiment. The sustainability system 6402 includes a modeler 6510. The modeler 6510 can model high-level entity data 6506 with modeling assumptions 6504 to generate low-level sustainability data 6514 via an engine 6512. In some embodiments, the low-level sustainability data 6514 includes low-level consumption data 6516, low-level engagement data 6518, low-level plastics data 6520, and low-level water data 6522. The modeling assumptions 6504 can indicate low-level sustainability data 6514 that results from certain high-level entity data 6506. The modeling assumptions 6504 can be global modeling assumptions or customer specific assumptions. For example, the high-level entity data 6506 could describe general characteristics or behaviors of a an entity (e.g., a user, a group of users, a family, etc.), for example, commuting characteristics, residential heating, cooling, or electrical consumption, eating tendencies, etc. In some embodiments, one or more of the characteristics or behaviors of an entity can have a first characteristic corresponding to working from home, and a second characteristic corresponding to not working from home (e.g., commuting to an office). For example, the commuting characteristics, residential heating, cooling, electrical consumption, cating tendencies, etc., can have a first a work from home commuting characteristic may be different than a non-work from home commuting characteristic. The high-level entity data 6506 can be non-specific, e.g., the high-level entity data 6506 could indicate an cating preference (e.g., meat, vegan, vegetarian, pescatarian, etc.). Similarly, the high-level entity data 6506 could indicate characteristics of a vehicle of the user or commute of the user, e.g., a size (e.g., small, medium, or large) of the vehicle and a fuel type of the vehicle (e.g., gas, electric, hydrogen, etc.).

The modeling assumptions 6504 can model the low-level consumption data 6516 with the high-level entity data 6506. For example, the modeling assumptions 6504 can indicate expected consumption levels for a vehicle of a particular size (e.g., small, medium, or large). The modeling assumptions 6504 can indicate expected food consumption levels of eating habits (e.g., meat, vegan, vegetarian, pescatarian, etc.). The modeling assumptions 6504 can indicate expected low-level consumption data 6516 of shopping habits, e.g., amount of merchandise purchased that result from in-person shopping, online shopping, etc. The modeling assumptions 6504 can indicate expected low-level consumption data 6516 that results from certain types of HVAC equipment for certain sizes of a home, e.g., certain run times, energy consumptions, fuel consumptions, etc. The modeling assumptions 6504 can be region specific, in some embodiments. For example, different geographic regions may have different weather patterns and residential homes in different geographic regions can consume various amounts of energy based on their location, e.g., extreme hot or cold climates can cause HVAC equipment to consume more energy than mild or temperate climates. In some embodiments, the modeling assumptions 204 can indicate low-level consumption data 226 of a work from home setup. For example, the modeling assumptions 204 may indicate an expected low-level consumption data 226, based on an indication regarding the frequency of working from home (e.g., days/week, days/month, etc.), a work from home duration (e.g., hours/day, etc.), the number of computers (e.g., desktop computers, laptop computers) utilized while working from home, the number of external monitors (e.g., external displays, screens, graphical display devices) utilized while working from home, and other remote work quantifiers. In some embodiments, the modeling assumptions 204 may indicate an expected low-level consumption data 226 of additional home heating and cooling emissions, workstation electronics that are added onto existing residential footprint, etc. In some embodiments, the modeling assumptions 204 may be based on temporary or lasting statuses of societal or regional health emergencies and/or government orders (e.g., stay-at-home orders). For example, different geographic regions may have different restrictions on commuting and social engagements, which can cause the amount of energy consumed due to working from home or by a building to vary. For example, additional heating and cooling emissions may be based on increases or decreases in residential energy consumption. For example, the modeling assumptions 204 may produce low-level consumption data 226 based on data associated with pre-pandemic circumstances, ongoing-pandemic circumstances, or post-pandemic circumstances.

In some embodiments, shopping habits are based on an indication regarding the size of a household, a household income, an average household spending, an average household spending per category (e.g., online shopping, groceries, etc.), household spending on recycled or pre-owned items. In some embodiments, a user can specify their annual average expenditure in a number of shopping categories, which are then multiplied by emission conversion factors. In some embodiments, the user is asked to estimate how many items in their estimates are thrifted or reused from previous owners. In some embodiments, their emissions in the corresponding category will be reduced by the percentage/option they select. In some embodiments, the emissions corresponding to the shopping category is offset based on a determination that one or more purchases correspond to thrifted goods.

The modeler 6510 can receive telemetry data from a telemetry data source 6508. The telemetry data source 6508 can be data storage element (e.g., a database) that collects data of devices. The devices could be a vehicle telematics system, airline flight data, a wearable, a smart thermostat, etc. The telemetry data source 6508 could be an Internet of Things (IoT) event hub. The telemetry data source 6508 could establish a communication connection with an edge device and collect telemetry data from the edge device via the communication connection. The communication connection could be established via a network, e.g., the Internet, a cellular network, MQ Telemetry Transport (MQTT), etc. The network could be the network described with reference to FIG. 64. The devices could be smartphones (e.g., the user device 6418), vehicle systems (e.g., the transport device 6420), health tracking devices (e.g., the wearable device 6414), a smart home device (e.g., a residential computing system 6422), etc. In addition to the high-level entity data 6506, the modeler 6510 can model the low-level sustainability data 6514 based on the telemetry data of the telemetry data source 6508. While the high-level entity data 6506 might indicate that a user commutes on average five times a week in a compact vehicle, the telemetry data could be telemetry data received from a telematics system of the vehicle that indicates specific fuel efficiencies, distances traveled, etc. In some embodiments, the telemetry data is telemetry data received from an expense report, a travel itinerary, a records from a customer loyalty platform such as a retailers loyalty membership or a grocery store membership.

In some embodiments, a user can provide low-level sustainability data 6514 to the sustainability system 6402 via the user device 6418 via a questionnaire. The questionnaire can collect one, tens, or hundreds of attributes that describe a sustainability profile (e.g., a consumption profile, a water use profile, a plastic use profile, an engagement profile, etc.) of the user. Via the modeling assumptions 6504, the modeler 6510 and the engine 6512 can generate the low-level sustainability data 6514 for the user based on the profile built for the user. The modeler 6510 can identify attribute values that are appropriate for each user. The attribute values can be modeling assumptions 6504. The modeler 6510 can analyze the profile built for an individual and select the modeling assumptions 6504 most appropriate for the individual. For example, if the individual rides the bus to work and cats meat, the modeler 6510 can select modeling assumptions 6504 that model consumption for riding the bus for a commuting category and eating meat for an eating category.

In some embodiments, the modeling assumptions 6504 can be modified for individual entities of a corpus or group of entities. For example, if a user knows the average annual temperature, the average summer temperature, or the average winter temperature for their geographic region, the user could provide this information to the sustainability system 6402 via the user device 6418. The sustainability system 6402 could set the modeling assumptions 6504 for energy consumption to heat or cool the home of the user based on the average temperatures provided by the user. These specific details entered by one user could be used by the modeler 6510 for another user. For example, if a first user provides temperature data for a geographic region of the user, the modeler 6510 could identify that a second user is in the same geographic region. The modeler 6510 could select the modeling assumptions 6504 for the second user to be the same as the modeling assumptions 6504 determined to be used for the first user based on the temperature data provided by the first user for the geographic region. Similarly, the user could provide an average monthly bill for energy for their home to the sustainability system 6402.

In some embodiments, for a corpus or group of entities, the telemetry data source 6508 can sort and organize telemetry data for various entities of the corpus or group of entities. For example, the telemetry data source 6508 can store an indication of each entity of the corpus or group of entities and store relationships between each entity and the telemetry devices of each entity. In this regard, the telemetry data source 6508 can sort, filter, or tag data based on the relationships between the entities and the edge devices.

The modeler 6510 can, in some embodiments, execute machine learning and/or an artificial intelligence algorithm to tune the modeling assumptions 6504. For example, because the telemetry data of the telemetry data source 6508 is granular and specific to the activities of an entity, the low-level sustainability data 6514 that is generated from the telemetry data can be highly accurate. The modeler 6510 can execute the machine learning and/or artificial intelligence algorithm based on the telemetry data to learn modeling assumptions 6504. This allows the sustainability system 6402 to collect a small amount of telemetry data for a small portion of entities of the corpus or group of entities and utilize the learned modeling assumptions 6504 to make accurate determinations of the low-level sustainability data 6514 for entities of the corpus or group of entities that do not have telemetry data. In this regard, data storage reductions, processing resource reductions, processing speed improvements can be realized. For example, instead of storing and processing telemetry data for an entire corpus or group of entities, the sustainability system 6402 may only store and process telemetry data for a small portion of the corpus or group of entities. Instead of storing telemetry data for the other entities of the corpus or group of entities (which would require a large amount of storage resources) or perform a lengthy and resource intensive processing of the telemetry for the other entities, the modeler 6510 can model the low-level sustainability data 6514 with the high-level entity data 6506 and the learned modeling assumptions 6504.

For example, the telemetry can be collected from sensors within equipment that gather actual consumption data related to a carbon emissions calculation or score. For example, the system can receive the communication from an embedded sensor within a device and act upon the information received to determine if the reading is outside of the normal range for that user. For example, telemetry data can be collected for trips or roundtrips of users to determine actual carbon emissions data.

The engine 6512 can generate the low-level sustainability data 6514 based on the output of the modeler 6510. The low-level consumption data 6516 can be consumption values, the low-level engagement data 6518 can be engagement values, the low-level plastics data 6520 can be plastic usage values, the low-level water data 6522 can be water usage values, all of which having values in one or multiple categories (e.g., as sub-categories of each data type). For example, for the low-level consumption data 6516, the categories could be commuting to work, commuting home from work, residential heating, residential cooling, residential electric consumption, food consumption, additional residential energy consumption attributable to working remotely (e.g., computing devices energy consumption, communications network system energy consumption, desktop computer energy consumption, computer monitor energy consumption, heating, ventilating and air conditioning energy consumption, lighting energy consumption, etc. The low-level sustainability data 6514 could be generated by the engine 6512 for one or multiple times. For example, the low-level sustainability data 6514 could be generated to indicate the consumption value of each entity of a corpus or group of entities in each category on a daily, weekly, bi-weekly, monthly, or yearly basis. For example, the low-level consumption data 6516 could indicate an amount of fuel consumed to commute to work on a particular day, a number of bus rides taken, a number of train rides taken, a length of time that a vehicle charged, an amount of energy consumed to heat or cool a building, an amount of meat, fish, vegetables, or grains consumed, etc.

The emissions identifier 6524 can generate the emission indicator 6552 based on the low-level consumption data 6516. The emissions identifier 6524 can generate the emissions indicator 6552 by determining an amount of emissions, e.g., carbon dioxide (CO2) or carbon dioxide equivalent (CO2e) that results from each particular consumption value of the low-level consumption data 6516. The emissions identifier 6524 can generate an emissions indicator 6552 for each entity of a corpus or group of entities. The emissions identifier 6524 can sort the emissions indicators 6552 into buckets based on the category of the emissions indicators 6552. For example, a commuting related emissions indicators 6552 for the corpus or group of entities could be sorted into a commuting bucket. All shopping related emission indicators 6552 can be sorted into a shopping bucket. In some embodiments, the emissions identifier 6524 is configured to sort the emissions indicators 6552 into a residential bucket, a dietary bucket, a transportation bucket, and a shopping bucket. In some embodiments, the residential bucket includes emissions attributed to working from home. For example, the residential bucket can include emissions attributed to workstation electronics (e.g., computer monitors, laptops, and desktop computers), heating, cooling, ventilating, and air conditioning energy use, lighting energy use, and creature comfort energy use (e.g., speaker systems, massage chairs, etc.).

In some embodiments, the emissions manager 6412 determines a value regarding work from home energy usage attributed to a workstation. For example, energy consumption for at-home workers can be calculated by determining the total kWh consumed by the at-home workers. For example, energy consumption for at-home workers can include energy consumption of workstation electronic appliances, additional lighting usage, and additional home heating and cooling. In some embodiments, work for home energy consumption is a function of the workstation utilized implemented in a work-from-home setup. For example, energy consumption for at-home workers can be calculated according to the equation illustrated below:

$${E}_{W S} = [ ( {\dot{E}}_{monitor} \times {n}_{monitor} ) + {E}_{laptop} + {E}_{desktop} ] \times {n}_{time}$$

where “E_{ws}” is the energy consumed by a workstation (e.g., in kilowatt-hours), “Eₘₒₙᵢₜₒᵣ” is the energy consumed by a workstation (Newton's notation, i.e., dot notation, indicating differentiation with respect to time), “nₘₒₙᵢₜₒᵣ” is the quantity of monitors, “Eₗₐₚₜₒₚ” is the energy consumed by a laptop, “E_{desktop}” is the energy consumed by a desktop, and “nₜᵢₘₑ” is a duration of time during which the workstation is utilized. In some embodiments, time-varying values of energy consumption of the workstation is retrieved from the workstation. In some embodiments, a predetermined value and/or static value is used to estimate the workstation's energy usage.

In some embodiments, the emissions manager 6412 determines a value regarding work from home energy usage attributed to lighting. For example, when people work from home, there is generally an increase in home lighting energy consumption. In some embodiments, the lumens required to light an average home office space is calculated or retrieved and then matched to an LED kWh value using a linear regression equation for LED watts vs lumens. In some embodiments, the work from home energy value can be calculated according to the equation illustrated below:

$${E}_{lighting} = {C}_{W F M} \times {n}_{h o u r s}$$

where “E_{lighting}” is the energy consumed by lighting (e.g., in kilowatt-hours), “C_{WFM}” is a scalar representing energy consumption per unit time, and “nₜᵢₘₑ” is a duration of time during which the lighting is utilized (e.g., the work-from-home duration). In some embodiments, time-varying values of energy consumption of the lighting is retrieved from the residential computing system 6422. In some embodiments, a predetermined value and/or static value is used to estimate the lighting energy usage. For example, the scalar, “C_{WFM}” may be or be based on an average energy use per unit time of a large set of similar or different entities.

In some embodiments, the emissions manager 6412 determines a weather-dependent value regarding work from home energy usage attributed to a workstation and/or lighting. For example, the weather dependent energy consumption can be calculated by subtracting the baseline non-weather dependent consumption values from the daily average totals in each month. These values can then be standardized for differences in weather using heating and cooling degree days. The average percent change between these the two periods can be calculated for winter months and summer months in order to calculate the percent change in electricity consumption for home heating and cooling, respectively. Across the US, summer months usually have a low number of heating degree days, and winter months have a low number of cooling degree days, which means the total weather-based consumption in those months can be attributed to either heating or cooling. Summer and winter months can be selected on a state-by-state basis to incorporate differences in climate. Several states had significant decreases in residential electricity sales data during covid as a result of increased vacancy, decreased tourism, or other covid related factors. In some embodiments, the weather dependent energy consumption for work from home can be calculated according to the equation illustrated below:

$${E}_{W F H} = [ {E}_{c o o l i n g} \times {\%}_{c o o l i n g} ] + [ {E}_{heating} \times {\%}_{heating} ]$$

where “E_{WFM}” is the heating and cooling energy consumption, “E_{cooling}” is a baseline energy consumed for cooling (e.g., an average energy consumed), “%_{cooling}” is a weather-based cooling energy adjustment, “E_{heating}” is a baseline energy consumed for heating (e.g., an average energy consumed), “%_{heating}” is a weather based heating energy adjustment.

In some embodiments, the emissions manager 6412 determines a value regarding a total energy use for working from home. For example, the total energy use may be according to the equation illustrated below:

$${E}_{WFH , Tot} = {E}_{W F H} + {E}_{lighting} + {E}_{W S}$$

where “E_{WFM,Tot}” is the total work from home energy consumption, “E_{WFM}” is the heating and cooling energy consumption, “E_{lighting}” is the lighting energy consumption, and “E_{workstation}” is the workstation energy consumption.

In some embodiments, the emissions identifier 6524 aggregates the emissions indicators 6552 in each of the buckets to generate an emissions indicator for each category. For example, for a corpus or group of entities, the emission identifier 6524 could aggregate (e.g., sum, average, weight, etc.) the emissions indicators of each category into a single category emissions indicator 6552. Furthermore, the emissions identifier 6524 can aggregate (e.g., sum, average, weight, etc.) the emissions indicators 6552 of each category into a total emissions indicator 6552 for the corpus or group of entities. The individual emissions indicators 6552 for each category, the category level emissions indicators 6552, and the total emissions indicator can be time correlated data (e.g., timeseries data). For example, each emissions indicator 6552 could be a series of emissions values for points in time, e.g., for days, weeks, months, years. The emissions identifier 6524 can store trends of the emissions indicator 6552 and update each trend as new emissions indicators 6552 are generated.

In some embodiments, the emissions identifier 6524 determines whether a user selected ferry travel, and whether the user indicated that they bring a car on the ferry, the frequency they use a ferry, the distance they ride the ferry, whether they take their transportation device on the ferry. In some embodiments, responsive to a determination that the user indicated that they bring a car on the ferry, the emissions identifier 6524 may determine whether the ferry is propelled along a route via a biodiesel system, electric system, gasoline system, coal system, steam system, diesel tugboat, cable system, etc.

In some embodiments, a user may selectively modify or adjust the determination made by the emissions identifier 6524. For example, the emissions identifier 6524 may determine a transportation type, transportation distance, commute distance, etc., based on low-level data or telemetry data, and a user may temporarily or permanently adjust the value to reflect a temporary or permanent adjustment corresponding to the determination made by emissions identifier 6524. In other words, a user may manually override one or more determinations made by the emissions identifier 6524.

The emissions identifier 6524 can determine lifecycle emissions, in some embodiments. The emissions indicators 6552 can include lifecycle emissions indicators. Lifecycle emissions can attribute carbon emissions back to the source of the original energy that is being consumed in a downstream activity. For example, the emissions identifier 6524 can determine carbon emission from the generation of electric power at a plant flowing into a residential home. If the power plant sources energy from 50% nuclear and 50% coal, the emissions identifier 6524 can determine emissions indicators that accurately reflect not only the emission from the use of appliances in a home, but the emission associated with the actual generation of power via coal and nuclear production.

The engagement identifier 6526 can generate the engagement indicator 6554 based on the low-level engagement data 6518. The engagement identifier 6526 can generate the engagement indicator 6554 by determining an amount of engagement, e.g., user onboarding, user participation, user interaction with the sustainability system interfaces, etc. that results from each particular engagement value of the low-level engagement data 6518. The engagement identifier 6526 can generate an engagement indicator 6554 for each entity of a corpus or group of entities. The engagement identifier 6526 can sort the engagement indicators 6554 into buckets based on the category of the engagement indicators 6554. For example, an article-reading related indicator 6554 for the corpus or group of entities could be sorted into an article-reading bucket. All login related engagement indicators 6554 can be sorted into a logins bucket.

In some embodiments, the engagement indicator 6554 accounts for a user's engagement with the sustainability system, and determines a value representing their willingness to learn more about sustainability and environmentally friendly habits/practices (e.g., by viewing sustainability system content such as articles, events, games, etc.). In some embodiments, the user receives a point logging in to an account. In some embodiments, there is a limit on the number of points a user can receive for logging into an account over a period of time. In some embodiments, the engagement indicator 6554 accounts for a time, duration, frequency, communication, and or promotional activity (e.g., sharing an internet link with an entity having a smaller engagement indicator than another entity).

In some embodiments, the engagement identifier 6526 aggregates the engagement indicators 6554 in each of the buckets to generate an engagement indicator for each category. For example, for a corpus or group of entities, the engagement identifier 6526 could aggregate (e.g., sum, average, weight, etc.) the engagement indicators 6554 of each category into a single category engagement indicator 6554. Furthermore, the engagement identifier 6526 can aggregate (e.g., sum, average, weight, etc.) the engagement indicators 6554 of each category into a total engagement indicator 6554 for the corpus or group of entities. The individual engagement indicators 6554 for each category, the category level engagement indicators 6554, and the total engagement indicator can be time correlated data (e.g., timeseries data). For example, each engagement indicator 6554 could be a series of engagement values for points in time, e.g., for days, weeks, months, years. The engagement identifier 6526 can store trends of the engagement and update each trend as new engagement indicators 6554 are generated.

The plastics identifier 6528 can generate the plastic usage indicator 6556 based on the low-level plastics data 6520. The plastics identifier 6528 can generate the plastic usage indicator 6556 by determining an amount of plastic usage, e.g., single-use plastics usage, that results from each particular value of the low-level plastics data 6520. The plastics identifier 6528 can generate a plastic usage indicator 6556 for each entity of a corpus or group of entities. The plastics identifier 6528 can sort the plastic usage indicators 6556 into buckets based on the category of the plastic usage indicators 6556. For example, a food related plastic usage indicators 6556 for the corpus or group of entities could be sorted into a food plastics bucket. All shopping related plastic usage indicators 6556 can be sorted into a shopping plastics bucket. In some embodiments, the plastics identifier 6528 is configured to output the plastic usage indicator 6556 as indicator based on a total weight of single-use plastics based on the low-level plastics data 6520.

For example, the plastic usage indicator 6556 can account for the amount of plastic, paper, or other material saved by switching single-use products to reusable products (i.e., plastic water bottles to reusable water bottle) and recycling. For example, for each unit or a quantity of material saved, e.g., by following a habit stored in the habits database 6432, the quantity of material is converted to a normalized unit or assigned a score (e.g., a point).

In some embodiments, the plastics identifier 6528 aggregates the plastic usage indicators 6556 in each of the buckets to generate a plastic usage indicator for each category. For example, for a corpus or group of entities, the plastics identifier 6528 could aggregate (e.g., sum, average, weight, etc.) the plastic usage indicators of each category into a single category plastic usage indicator 6556. Furthermore, the plastics identifier 6528 can aggregate (e.g., sum, average, weight, etc.) the plastic usage indicators 6556 of each category into a total plastic usage indicator 6556 for the corpus or group of entities (e.g., a plastic footprint score). The individual plastic usage indicators 6556 for each category, the category level plastic usage indicators 6556, and the total plastic usage indicator can be time correlated data (e.g., timeseries data). For example, each plastic usage indicator 6556 could be a series of plastic usage values for points in time, e.g., for days, weeks, months, years. The plastics identifier 6528 can store trends of plastic usage indicators 6556 and update each trend as new plastic usage indicators 6556 are generated.

The water identifier 6530 can generate the water usage indicator 6558 based on the low-level water usage data 6522. The water identifier 6530 can generate the water usage indicator 6558 by determining an amount of water usage, e.g., direct water usage and/or indirect water usage, that results from each particular value of the low-level water usage data 6522. The water identifier 6530 can generate a water usage indicator 6558 for each entity of a corpus or group of entities. The water identifier 6530 can sort the water usage indicators 6558 into buckets based on the category of the water usage indicators 6558. For example, food related water usage indicators 6558 for the corpus or group of entities could be sorted into a food water bucket. All cleaning related water usage indicators 6558 can be sorted into a cleaning water bucket. All hygiene related water usage indicators 6558 can be sorted into a hygiene water bucket. In some embodiments, the water identifier 6530 is configured to output the water usage indicator 6558 as an indicator based on a total volume of water saved based on the low-level water usage data 6522. In some embodiments, the water usage indicators 6558 is based one or more habits stored in the habits database 6432.

The water usage indicator 6558 accounts for the amount of water saved by the user based on the habits they follow related to water conservation. However, the total weekly point value will be weighted based on a regional drought factor, such as the average daily drought severity and coverage index (DSCI) for the region.

In some embodiments, the water identifier 6530 aggregates the water usage indicators 6558 in each of the buckets to generate a water usage indicator for each category. For example, for a corpus or group of entities, the water identifier 6530 could aggregate (e.g., sum, average, weight, etc.) the water usage indicators of each category into a single category water usage indicator 6558. Furthermore, the water identifier 6530 can aggregate (e.g., sum, average, weight, etc.) the water usage indicators 6558 of each category into a total water usage indicator 6558 for the corpus or group of entities (e.g., a water footprint score). The individual water usage indicators 6558 for each category, the category level water usage indicators 6558, and the total water usage indicator can be time correlated data (e.g., timeseries data). For example, each water usage indicator 6558 could be a series of water usage values for points in time, e.g., for days, weeks, months, years. The water identifier 6530 can store trends of water usage indicators 6558 and update each trend as new water usage indicators 6558 are generated.

In some embodiments, the sustainability system 6402 aggregates the emissions indicators 6552, engagement indicators 6554, plastic usage indicators 6556, and water usage indicators 6558 to generate a sustainability indicator. For example, for a corpus or group of entities, the sustainability system 6402 could aggregate (e.g., sum, average, weight, etc.) the emissions indicators 6552, engagement indicators 6554, plastic usage indicators 6556, and water usage indicators 6558 into a single sustainability indicator 6550 (e.g., a sustainability score). The individual sustainability indicators 6550 for each category of each indicator type (e.g., the emissions indicators 6552, engagement indicators 6554, plastic usage indicators 6556, and water usage indicators 6558), the category level sustainability indicators 6550, and the total sustainability indicators, can be time correlated data (e.g., timeseries data). For example, each sustainability indicator could be a series of sustainability values for points in time, e.g., for days, weeks, months, years. The sustainability system 6402 can store trends of sustainability indicators 6550 (e.g., in data storage 6560, scoring database 6462) and update each trend as new sustainability indicators 6550 are generated.

A user interface portal 6562 can allow a user to access and view the sustainability indicators 6550. The user interface portal 6562 can generate user interfaces, e.g., the user interfaces of FIGS. 4-64. The user interface portal 6562 can populate various user interface elements of the user interfaces of FIGS. 4-64 based on the sustainability indicators 6550 (e.g., emissions indicators 6552) stored in the data storage 6560. Furthermore, recommendations generated by the recommendation engine 6564 can be displayed in the user interfaces of the FIGS. 4-64. The user interface portal 6562 can retrieve the recommendations from the data storage 6560 stored in the data storage 6560 via the recommendation engine 6564. The user interface portal 6562 can populate user interface elements (e.g., the user interfaces of FIGS. 4-64) with the recommendations.

The sustainability system 6402 can include a recommendation engine 6564. The recommendation engine 6564 can generate recommendations for improving the sustainability indicators 6550. For example, the recommendation engine 6564 can generate recommendations on a company level. The recommendation engine 6564 can generate the recommendations on the company level based on category level sustainability indicators 6550 or total sustainability indicators 6550 for the corpus or group of entities. The recommendation engine 6564 can generate recommendations for individual entities of the corpus or group of entities. For example, the recommendation engine 6564 can generate a recommendation for a particular user based on one or more of the sustainability indicators 6550 for each user. The recommendation engine 6564 can generate category-based recommendations for the entire corpus or group of entities e.g., based on category level sustainability indicators 6550. The recommendation engine 6564 can generate category-based recommendations for particular entities based on the sustainability indicators 6550 for the particular entities in particular categories.

The recommendations can be recommendations to adjust commuting, e.g., a suggestion to take a bus more frequently, invest in a more fuel-efficient vehicle, work from home more frequently, etc. The recommendations could be recommendations to change water usage, e.g., take shorter showers. The recommendations could be recommendations to change eating habits, e.g., cat less meat, cat more vegetables, etc.

The sustainability system 6402 includes an offset manager 6570. The offset manager 6570 can acquire offset items that offset the sustainability indicators 6550. The offset manager 6570 can receive a section, by a user, to acquire a particular offset and communicate with an external system that manages the offset to acquire the offset. In some embodiments, the offset manager 6570 receives votes or indications of interest of various types of offsets from a user via a mobile application 6572. The offset manager 6570 can aggregate the votes or indications of interest to determine which offsets have the most votes or indications of interest. The offset manager 6570 could identify which categories have a number of votes or indications of interest greater than a particular amount. The offset manager 6570 can acquire an offset responsive to determining that the offset has the most votes or indications of interest. The offset manager 6570 can acquire the offset responsive to determining that the offset has a number of votes or indications of interest greater than a particular amount.

The mobile application 6572 can be a mobile application run on a user device such as the user device 6418 or the wearable device 6414. The mobile application can include user interfaces, for example, the user interfaces of FIGS. 4-63. The mobile application 6572 can generate user interfaces, e.g., the user interfaces of FIGS. 4-63. The mobile application 6572 can populate various user interface elements of the user interfaces of FIGS. 4-63 based on the sustainability indicators 6550 stored in the data storage 6560. Furthermore, recommendations generated by the recommendation engine 6564 can be displayed in the user interfaces of the FIGS. 4-63. The mobile application 6572 can retrieve the recommendations from the data storage 6560 stored in the data storage 6560 via the recommendation engine 6564. The mobile application 6572 can populate the user interface elements of FIGS. 4-63 with the recommendations.

The recommendations can gamify emissions reduction for individuals. The individuals can compete to reduce their emissions levels and increase sustainable behaviors and usage. The recommendations can be part of an engagement platform.

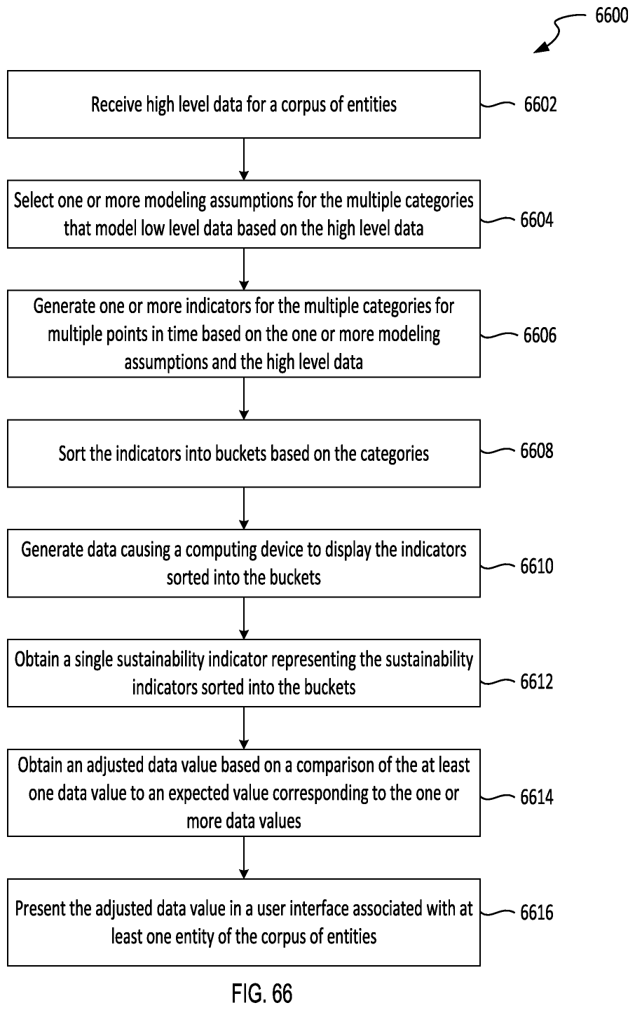

Referring now to FIG. 66, a process 6600 of generating the sustainability indicators from the high-level data based on the modeling assumptions is shown, according to an embodiment. The sustainability system 6402 can be configured to perform the process 6600. For example, the process 6600 can be performed by components of the sustainability system 6402. For example, the modeler 6510, the engine 6512, the emissions identifier 6524, etc. of the sustainability system 6402 can be configured to perform the process 6600. Furthermore, any computing system described herein can be configured to perform the process 6600.

In step 6602, the process 6600 can include receiving, by one or more processing circuits, high-level data for multiple categories for a corpus or group of entities. For example, the sustainability system 6402 can receive the high-level entity data 6506 for the corpus or group of entities. The corpus or group of entities could be users of a group, e.g., employees of a company, members of a family, citizens of a city, state, or country, occupants of a building, etc. The high-level data can indicate high-level behaviors, characteristics, preferences, or a profile of consumption for the entities of the corpus or group of entities in various categories (e.g., commuting, food, shopping, business travel, additional consumption from remote work, remote work behaviors, work from home setups, work from home frequency, work from home durations, etc.). For example, the high-level data could indicate typical commute distance, typical commute day per week, average size of a vehicle driven, utilization of busses, trains, shopping habits, food habits, residential information, plastic usage information, user engagement with sustainable practices, user engagement with recommendations regarding sustainability, etc. As another example, the high-level data could indicate typical work from home frequency (e.g., days per week, days per month, days per year, work from home occurrences per unit time, etc.), work from home duration (e.g., hours per day, hours per week, hours per month, etc.), work from home hardware and energy consumption (e.g., energy consumptions attributed to desktop computer use, laptop computer use, external monitor use, home office lighting usage, home office air conditioning usage, home office internet usage, etc.).

In some embodiments, the user can be presented with options to select or provide an input regarding one or more of the following prompts: “how many days per week do you typically work from home?”, “how many hours do you work on a typical work from home day?”, “how many desktop computers do you use?”, “how many laptops do you use?”, and/or “how many external monitors do you use?”. In some embodiments, a user may provide a numerical input, select a numerical input, or otherwise provide a quantity, quantifier, and/or qualifier regarding one or more of the aforementioned example prompts. For example, energy consumption for at-home workers may be calculated by determining the total kWh consumed by, for example, workstation electronic appliances, additional lighting usage, and additional home heating and cooling. The user can be presented with options to select or provide an input regarding measures relating to energy consumption for at-home workers may be calculated by determining the total kWh consumed by, for example, workstation electronic appliances, additional lighting usage, and additional home heating and cooling.

In step 6604, the process 6600 can include selecting, by one or more processing circuits, one or more modeling assumptions for the multiple categories that model low-level data based on the high-level data. The high-level data can be the high-level data received in the step 6602. The sustainability system 6402 can select one or multiple of the modeling assumptions 6504. The modeling assumptions 6504 can model the low-level sustainability data 6514 based on the high-level entity data 6506. For example, the modeling assumptions 6504 could indicate energy consumption for heating or cooling a building for certain ranges of square feet, geographic locations, equipment types, etc. The high-level entity data 6506 could indicate an approximate residence size, geographic location of the residence (e.g., state, city, region, etc.), and/or an indication of a type of equipment (e.g., air conditioning unit and furnace, heat pump system, etc.). Furthermore, the modeling assumptions 6504 could indicate the amount of meat, vegetables, or dairy products consumed based on different food consumption behaviors (e.g., meat eater, vegan, vegetarian, pescatarian, etc.) of an entity indicated by the high-level entity data 6506.

In step 6606, the process 6600 can include generating, by one or more processing circuits, sustainability indicators for the multiple sustainability data types for the multiple categories for multiple points in time based on the one or more modeling assumptions and the high-level data. The engine 6512 can generate the low-level sustainability data 6514 based on the modeling assumptions 6504 and the high-level entity data 6506. The engine 6512 can further generate the low-level sustainability data 6514 based on telemetry data of the telemetry data source 6508. The engine 6512 can provide the low-level consumption data 6516 to the emissions identifier 6524 and the emissions identifier 6524 can generate the emissions indicators 6552 based on the low-level consumption data 6516. The engine 6512 can provide the low-level engagement data 6518 to the engagement identifier 6526 and the engagement identifier 6526 can generate the engagement indicators 6554 based on the low-level engagement data 6518. The engine 6512 can provide the low-level plastic usage data 6520 to the plastics identifier 6528 and the plastics identifier 6528 can generate the plastic usage indicators 6556 based on the low-level plastics usage data 6520. The engine 6512 can provide the low-level water usage data 6522 to the water identifier 6530 and the water identifier 6530 can generate the water usage indicators 6558 based on the low-level water usage data 6522.

In step 6608, the process 6600 can include sorting the sustainability indicators into buckets based on the categories. For example, the emissions identifier 6524 can generate an emissions indicator 6552 for each entity for a corpus or group of entities in each category. The emissions identifier 6524 can sort the emissions indicators 6552 into buckets. The buckets can be data groupings or regions of the data storage 6560 for storing emissions indicators 6552 of each category. The emissions identifier 6524 can sort the emissions indicators based on category such that each bucket includes all of the emissions indicators of the corpus or group of entities for each category for the emissions data type of the sustainability data type. The emissions identifier 6524 can store the sorted data in the data storage 6560.

In step 6610, the process 6600 can include generating data causing a computing device to display the sustainability indicators sorted into the buckets for one or more sustainability data types. The sustainability system 6402 can generate data that causes user interfaces to be displayed on computing devices such as the wearable device 6414 or the user device 6418. The user interfaces can be the user interfaces of FIGS. 4-63.

In step 6612, the process 6600 can include obtaining a single sustainability indicator representing the sustainability indicators of the sustainability data types. For example, the scoring engine 6460 can obtain a single sustainability indicator 6550 by aggregating the emissions indicators 6552, the engagement indicators 6554, the plastic usage indicators 6556, and the water usage indicators 6558. The single sustainability indicator 6550 may be the superposition of the emissions indicator 6552, engagement indicator 6554, plastic usage indicator 6556, and water usage indicator 6558. For example, the single sustainability indicator may be a function as illustrated in the equation below:

$$S = F - ( E - O ) + C$$

where, “S” is the single sustainability score, “F” is an average or standard value of an emissions indicator for a standard (e.g., average) user, “E” is a user's emissions indicator quantity (e.g., the value of emissions indicator 6552), “O” is an offset value based on the user's habit data (e.g., the habit data stored in the habits database 6432), the user's home improvement data (e.g., the home improvement data stored in the home improvement database 6436), and the user's offset purchases. “C” is a predictive indicator (e.g., a future climate impact indicator) that is based on a predictive model using the trajectory of the sustainability indicator 6550, the low-level engagement data, the modeling assumptions 6504, high-level entity data 6506, and/or the telemetry data of the telemetry data source 6508.

In step 6614, the process 6600 can include obtaining an adjusted data value based on a comparison of the at least one data value to an expected value corresponding to the one or more data values. In some embodiments, the single sustainability indicator is adjusted (e.g., by the scoring engine 6460) based on large-scale factors such as weather conditions, ambient climate, political attitudes toward resource conservation, and societal changes. The adjusted single sustainability indicator, e.g., the standardized sustainability score, can aid in ensuring equality among users from a variety of locales and socioeconomic backgrounds. For example, a user in a dry or desert region may experience water shortages or droughts more frequently than a user in a tropical region, and accordingly, the sustainability system 6402 is configured to account for the relatively higher emphasis on water conservation in areas experiencing a water shortage or drought and reflects the disparity via a standardized sustainability score. In some embodiments, the standardized sustainability score is a function as illustrated in the equation below:

$${S}^{*} = P + W + S + I$$

where “S*” is the standardized sustainability score, “P” is a value corresponding to the plastic usage indicator 6556, “S” is the single sustainability score, and “I” is a value corresponding to the engagement indicator 6554. In some embodiments, the sustainability system 6402 may rank the single sustainability indicator and provide recommendations (e.g., via the recommendation engine 6564) on ways a user can improve their individual standardized sustainability score and/or their group(s) standardized sustainability score.

In step 6616, the process 6600 can include presenting an adjusted data in a user interface associated with at least one entity of the corpus or group of entities. The sustainability system 6402 can generate data that causes user interfaces to be displayed on computing devices such as the wearable device 6414 or the user device 6418. The user interfaces can be the user interfaces of FIGS. 4-63. In some embodiments, the recommendation engine 6564 may, based on a determination that one or more sustainability scores are above or below one or more threshold values, provide an alert via at least one of the wearable device 6414, user device 6418, transport device 6420, and/or the residential computing system 6422. For example, if the recommendation engine 6564 detects a running faucet, running toilet, water line rupture, etc., that, for example, may have been inadvertent due to inattentiveness, a medical emergency, a broken plumbing system, etc., the recommendation engine 6564 may cause the sustainability system 6402 to display a suggestion for taking an action to prevent, troubleshoot, or diagnose the change in the water usage indication.

For example, the recommendation engine 6564 may suggest actuating a valve to pause the water flow. In some embodiments, the recommendation engine 6564 can automatically take an action (e.g., actuate a valve, etc.) to work around the detected change. In some embodiments, the recommendation engine 6564 can implement, control, or configure equipment of buildings, cars, or other devices to improve a sustainability indicator of a user. For example, the recommendation engine 6564 can generate a control parameter, a control schedule, a control signal, a data packet, a data message, or a command and transmit the information via a network to an actuator to cause the actuator to control a condition. For example, the command may be a command to update a temperature setpoint of a thermostat that controls a temperature of a building (e.g., a building corresponding to the residential computing system 6422). The command can update the temperature setpoint to a value that reduces energy consumption. The command can be a command to configure a transit system of a vehicle (e.g., a car or bus) to take a route that consumes less energy.

The recommendation engine 6564 can generate notifications, e.g., smart notifications, that notify a user when their actual consumption (e.g., the single emissions indicator) deviates by a predefined amount. For example, if the single emissions indicator deviates outside a predefined range for a user, a notification can be generated and pushed to a user device of the user.

Accordingly, as described herein, the sustainability system 6402 is configured to cause a variety of devices to perform various actions aimed at improving various sustainability indicators of a user. For example, the recommendation engine 6564 may cause one or more devices (e.g., wearable device 114, user device 118, wearable device 6414, user device 6418, transport device 6420, residential computing system 6422) to provide a variety of information and/or options to a user (e.g., via the user interface portal 6562) to allow the user to improve the sustainability indicators. The information and/or options can include, for example, the various sustainability indicators, options for carbon offsets, changes that user can make (e.g., in habits or manual updates to device setpoints or functionalities) to improve the sustainability indicators, and/or any other information, options, or functionalities described herein. In some instances, the recommendation engine 6565 may cause one or more devices (e.g., equipment of buildings, cars, or other devices) to take various actions (e.g., automatically via one or more command signals), such as, for example, adjusting or modifying various optional parameters of the devices (e.g., set points, operational schedules) and/or performing any other actions discussed herein configured to improve the sustainability indicators.

Advantageously, the single sustainability score and adjusted sustainability score can facilitate an improved user interface and data management for a sustainability data for an entity or corpus or group of entities and provides an efficient, effective, and succinct high-level display of a very large quantity of low-level data that is otherwise impossible to display, fit, or otherwise present on a display device having a limited display arca. For example, a screen (e.g., liquid crystal display, light emitting diode display, electrophoretic display, backlight display, etc.) having limited dimensions, for example, a screen of a wearable smart watch or other small screen device may not have a resolution, pixel density, available screen area, and/or computing resource supportive of a display of sustainability data. Advantageously, the sustainability system configured to generate sustainability indicators, a single sustainability indicator, and an adjusted sustainability indicator facilitates presentation, management, and control for a very large and very complex volume of sustainability data of an entity or a corpus or group of entities. For example, the sustainability indicators, single sustainability indicator, and adjusted sustainability indicator are configured to be presented to a user in a variety of user interface devices such as displays, wearable devices, residential computing systems, transport devices, and other devices. Unexpectedly, the sustainability indicators, single sustainability indicator, and adjusted sustainability indicator effectuate upstream impacts on the suitability data. For example, the adjusted sustainability indicator can effectuate implementation of sustainability data collection, sustainability data accuracy, and sustainability data standardization.

The shopping data can be sorted into multiple categories of items purchased and an emissions indicator can be generated for each category. The categories can include a home maintenance, home improvements, or home services category. The categories can include a cleaning and house keepings category. The categories can include a major appliances category. The categories can include a small kitchen appliances, cookware, dinnerware, or heating/cooling equipment category. The categories can include an electronic devices and miscellaneous home equipment and supplies category. The categories can include a clothing and jewelry category. The categories can include a personal care products and medical supplies category. The categories can include an entertainment category. The categories can include a pets and pet care category. The categories can include a reading (e.g., paper books, newspapers, etc.) category.

A user can provide their annual spend on different shopping categories for a period of time (e.g., quarter, month, year). A user can adjust a slider to estimate their annual spend. A system can allow a user to provide their annual average expenditure the shopping categories, which can multiplied by emission conversion factors that convert the dollar amounts into kg CO2e. In order to help the user accurately determine their expenditure estimations, the system can use average expenditure values for shoppers.

The system can include an application programming interface (API) that integrates with human resources, financial management systems, expense systems, etc. other platforms supporting emissions calculations to facilitate system to system communication of inputs to calculations and the return of emission values for each consumption record.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular building or portion of a building. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A system, comprising:
one or more processors and one or more memory devices storing instructions thereon that, when executed by the one or more processors, cause the one or more processors to:
receive high-level sustainability data associated with an entity;
generate a plurality of sustainability indicators for a plurality of categories for the entity based on the high-level sustainability data and one or more modeling assumptions associated with the entity;
aggregate the plurality of sustainability indicators into a single sustainability indicator;
generate a graphical user interface including the single sustainability indicator; and
cause one or more devices to perform an action to improve the single sustainability indicator.

2. The system of claim 1, wherein causing the one or more devices to perform the action to improve the single sustainability indicator comprises:
updating at least one setting of the one or more devices to lower an energy consumption of the one or more devices.

3. The system of claim 1, wherein the instructions cause the one or more processors to:
collect telemetry data from a plurality of devices associated with the entity; and
generate at least one of the plurality of sustainability indicators based at least in part on the telemetry data.

4. The system of claim 3, wherein the telemetry data is collected from at least one of a vehicle telematics system, a wearable device, an airline system, or a residential computing system.

5. The system of claim 1, wherein the instructions cause the one or more processors to:
retrieve, from the one or more devices, an indication of a geographic region that a building of the entity is located in;
retrieve, from the one or more devices, a region-based modeling assumption based on the indication of the geographic region; and
generate at least one sustainability indicator based on the region-based modeling assumption.

6. The system of claim 1, wherein the instructions cause the one or more processors to:
retrieve, from the one or more devices, data indicating an activity performed by the entity that reduces carbon emissions production of the entity;
retrieve, from the one or more devices, an offset value based on the activity performed by the entity; and
offset the single sustainability indicator based on the offset value.

7. The system of claim 1, wherein the instructions cause the one or more processors to:
retrieve, from the one or more devices, a sustainability indicator limit based on an indication of a geographic location of the entity; and
generate the single sustainability indicator based on a comparison of the aggregated plurality of sustainability indicators with the sustainability indicator limit.

8. The system of claim 1, wherein the instructions cause the one or more processors to:
record a plurality of values of the single sustainability indicator over time to generate a trajectory of the single sustainability indicator;
generate a prediction of a value of the single sustainability indicator at a future time based on the trajectory; and
generate a predictive indicator based at least in part on the prediction of the value and one or more offset values based on an indication of a geographic location of the entity.

9. The system of claim 1, wherein the instructions cause the one or more processors to:
offset the single sustainability indicator based on one or more values associated with a location of the entity; and
display, via a user interface, the offset sustainability indicator on at least one device associated with the entity.

10. The system of claim 1, wherein the one or more modeling assumptions are for modeling low-level sustainability data and the instructions cause the one or more processors to:
select the one or more modeling assumptions for modeling low-level sustainability data based on high-level sustainability data of multiple entities including the entity.

11. The system of claim 1, wherein the instructions cause the one or more processors to display the graphical user interface on a display of at least one device associated with the entity.

12. The system of claim 1, wherein the instructions cause the one or more processors to:
receive a selection of at least one selectable offset item;
offset the single sustainability indicator based on the selection; and
display the offset sustainability indicator on a display of at least one device associated with the entity.

13. The system of claim 1, wherein the plurality of sustainability indicators include at least one of:
an emissions indicator, an engagement indicator, a plastic use indicator, or a water use indicator.

14. A method, comprising:
receiving, by one or more processing circuits, high-level sustainability data associated with an entity;
generating, by the one or more processing circuits, a plurality of sustainability indicators for a plurality of categories for the entity based on the high-level sustainability data and one or more modeling assumptions associated with the entity;
aggregating, by the one or more processing circuits, the plurality of sustainability indicators into a single sustainability indicator;
generating, by the one or more processing circuits, a graphical user interface including the single sustainability indicator; and
causing, by the one or more processing circuits, one or more devices to perform an action to improve the single sustainability indicator.

15. The method of claim 14, wherein causing the one or more devices to perform the action to improve the single sustainability indicator comprises:
controlling the one or more devices to lower an energy consumption of the one or more devices.

16. The method of claim 14, comprising:
collecting, by the one or more processing circuits, telemetry data from a plurality of devices associated with the entity; and
generating, by the one or more processing circuits, at least one of the plurality of sustainability indicators based at least in part on the telemetry data.

17. The method of claim 14, comprising:
offsetting, by the one or more processing circuits, the single sustainability indicator based on one or more values associated with a location of the entity; and
displaying, by the one or more processing circuits, the offset sustainability indicator on a display of at least one device associated with the entity.

18. The method of claim 14, wherein the one or more modeling assumptions are for modeling low-level sustainability data and the method further comprises:
selecting, by the one or more processing circuits, the one or more modeling assumptions for modeling low-level sustainability data based on high-level sustainability data of multiple entities including the entity.

19. One or more memory devices storing instructions thereon, when executed by one or more processors, cause the one or more processors to:
select one or more modeling assumptions for modeling low-level sustainability data based on high-level sustainability data of multiple entities;
receive high-level sustainability data associated with an entity;
generate a plurality of sustainability indicators for a plurality of categories for the entity based on the high-level sustainability data and the one or more modeling assumptions;
aggregate the plurality of sustainability indicators into a single sustainability indicator;
generate a graphical user interface including the single sustainability indicator; and
cause one or more devices to perform an action to improve the single sustainability indicator.

20. The one or more memory devices of claim 19, wherein the instructions cause the one or more processors to:
receive a selection of at least one selectable offset item;
offset the single sustainability indicator based on the selection; and
display the offset sustainability indicator on a display of at least one device associated with the entity.
